(19) United States
(12) Patent Application Publication
(10) Pub. No.: US 2022/0273015 A1
(43) Pub. Date: Sep. 1, 2022

(54) FORMULATIONS AND USES THEREOF

(71) Applicant: Joyce H. Ma, Redding, CA (US)

(72) Inventor: Joyce H. Ma, Redding, CA (US)

(21) Appl. No.: 17/679,176

(22) Filed: Feb. 24, 2022

Related U.S. Application Data
(60) Provisional application No. 63/154,408, filed on Feb. 26, 2021.

(51) Int. Cl. A23L 33/115; A23L 33/105; A23L 33/135

(52) U.S. Cl. CPC A23L 33/115; A23L 33/105; A23L 33/135

(57) ABSTRACT

Nutritional supplements and formulations containing bioactive substances found in plants are described. Uses of nutritional supplements and formulations are also described.

This application claims the benefit of U.S. Provisional Application No. 63/154,408, filed on Feb. 26, 2021, hereby incorporated by reference.

### BACKGROUND OF THE INVENTION

Healthy cell membranes serve as a barrier to the environment outside of the cell. They also serve as a hub, filtering and interpreting signals from the cell's surroundings and translating external signals into a cellular response by directing changes in gene expression. Healthy cell membranes also send, receive, and coordinate signals to and from other cells, and can elicit responses in cells close by, or even in cells at the opposite end of the body.

Cells do not typically function in isolation, but rather a group of specialized cells form a tissue, and a group of tissues form a specific organ with a specific function. For example, the kidney functions to filter waste, and the heart functions to pump blood. Specialized cells called nephrons grouped together form the filtration system of the kidneys, while specialized cells called cardiomyocytes grouped together serve to contract rhythmically to produce a heartbeat and to push blood through the blood vessels.

Intermeshed within the specialized cells that form every organ are adult tissue stem cells (also known as tissue progenitor cells) which possess the capability of generating more specialized cells when they are damaged. For example, muscle stem cells are called into action by signaling molecules released via exosomes from injured muscle cells after a day of lifting heavy weights—so that injured muscle cells are repaired and new muscle cells are made overnight while the athlete is resting, creating a stronger muscle the next day. Tissue specific progenitors allow us to continue generating new hair, skin, nails, and to repair injured body parts.

Stem cells are cells which 1) possess the ability to generate other types of cells (proliferation); and 2) to proliferate or make more copies of themselves (differentiation). Progenitor cells are tissue-specific stem cells which are limited to the production of cells within a particular organ—for example, neural stem cells may give rise to cells that form the brain, but no longer possess the capability of generating cells of other organs.

Stem cells are built for survival. For example, they possess multi-drug resistance channels which recognize and pump out chemicals which would otherwise jeopardize their function and survival. Stem cells are equipped to survive—appropriate since they generate the rest of the organism. The adult organism depends upon adult tissue-specific stem cells, also called progenitors, to repair injured or worn-out tissues and organs.

When healthy, the stem cells, and tissue-specific progenitors appropriately generate new cells for maintenance and repair purposes. All of this occurs at the subcellular level.

The signaling from one cell to the other is achieved by creating little micro-packets of instructions and information in the form of exosomes—tiny nanosized membrane vesicles released from a cell bearing lipids, nucleic acids (including microRNAs), proteins, and travel protected by their lipid bilayer membrane, which can be taken up by neighboring cells or even cells far from the cell of origin.

Once absorbed by a receiving cell, the exosome releases the signaling lipids, nucleic acids, proteins into the interior of the target cell, where they may direct the target cell's nucleus “brain” to perform specific functions. A nutritional deficiency or a nutritional imbalance, especially of cellular membrane components may disrupt this signaling.

Both a person's genes (the DNA they inherited from their parents) and the environment (summed up by the totality of their life decisions as described below) directs each cell how to respond, and what signals to send out to the other cells. How a person eats, sleeps, walks, lives, breathes, exercises, as well as the sunlight, and the quality of the water, nutrition, chemicals, foods, and exposure to chemicals absorbed through the skin or taken into the person as food alters the expression of specific genes within the DNA.

Disrupted sleep is a critical stressor which impairs the body's ability to repair and restore itself. How much light, the type of wavelength of light, and duration of light exposure at the wrong time in a circadian rhythm can cause a domino-effect of hormone changes which directly impact the body's ability to auto-regulate. Lifestyle choices are often not taken seriously, yet are the direct drivers of health and disease.

Genetic insults fall in multiple categories, including radiation which causes breaks in the DNA; viruses which under certain circumstances may integrate into, and under other conditions excise themselves from, the DNA, leaving behind disrupted genetic function. Genetic material such as DNA, RNA, and microRNAs are susceptible to damage from free radicals generated as byproducts of metabolism. They may also be damaged by chemicals, for example from consuming acrylamide in burnt and charred foods, or from work exposure to man-made chemicals.

Humans, and animals have multiple mechanisms in place to address damage to genetic materials. In a healthy human, these mechanisms are not overwhelmed when exposed to minimal daily genetic insults. Most potentially harmful genetic insults are addressed immediately in a healthy subject, and do not result in lasting or significant injury.

However, as insults accumulate over a lifetime, or during a period of concentrated exposure, or biochemical, endocrine, emotional, or physical stress then repair mechanisms may not be able to keep up with the rate of genetic damage. This may lead to a state of disease which the body may actively attempt to correct.

However, repeated and consecutive genetic damage which exceed the repair mechanisms within stem cells result in formation of cancer stem cells (CSCs), which give rise to tumors and cancers.

Accumulation of further genetic insults result in acquisition of additional properties such as chemotaxis, which enhance the survivability of the CSCs since they can migrate to more hospitable environments.

The modern Western diet filled with processed foods rich in ω6 rather than ω3 fats (in combination with other factors of modern life such as the ubiquitous use of plastics, pesticides, synthetic food additives) may alter membrane compositions and lead to changes in physical parameters of a cell membrane such as membrane fluidity, permeability, and may interfere with the ability of intramembrane proteins and structures to interact (Phillips R., Membranes by the Numbers arxiv.org 6 Mar. 2017). These changes may contribute to imbalances of proportions of lipids and phospholipids in cell membranes. Without proper proportions of membrane components, all cells, but especially stem cells and tissue-specific progenitors function suboptimally, leading to the development of many chronic diseases, especially in subjects with genetic predispositions for diseases.

Disturbances in cell membrane function and the stem cells and tissue-specific progenitors functioning may manifest as inflammation, dysregulated growth and proliferation (leading to diseases such as cancer, keloids, or psoriasis, among others); as a disrupted skin barrier (leading, for example, to eczema or a non-healing wound); as hormone dysregulation such as, for example, in diabetes, hyperlipidemia, and metabolic syndrome; as poor immune function; or as disrupted neuronal signaling such as, for example, in multiple sclerosis and Alzheimer's Disease.

When stem cells and tissue-specific progenitors sustain damage to their genetic material, specifically in genes which control the rate of cellular division and proliferation then the stem cell can divide and proliferate in a dysregulated manner, leading to a disease (e.g., cancer).

Improper nutrition over prolonged periods of time may create nutritional deficiencies or imbalances that manifest itself in a change in a microbiome of a person and an animal and create an environment that induces inflammation, oxidative stress, impairs the signaling between individual cells, a dysfunction of a stem cell niche, resulting, e.g., in abnormal proliferation of cells and development of various diseases.

Thus, what humans consume daily is of utmost importance in preserving health. Everything humans eat may provide a signal to the cell for health by providing proper nutrition and allow healthy cell membrane signaling. Alternatively, what human eat may directly damage cells or impair their ability to function. Collectively, this may impair the function of tissues and organs and may lead to a disease.

### SUMMARY OF THE INVENTION

It is an object of the invention to provide a nutritional supplement comprising a composition that supports proper nutrition and/or corrects imbalances in the micronutrition of a human or an animal.

It is another object of the invention to provide a nutritional supplement comprising a composition that is capable of providing an environment for altering inflammatory signaling in a human or an animal.

It is also an object of the invention to provide a nutritional supplement comprising a composition that is capable of providing an environment for altering signaling between abnormally proliferating cells in a human or an animal.

It is a further object of the invention to provide a nutritional supplement or composition that is capable of providing an environment for inducing apoptosis of abnormally proliferating cells in a human or an animal.

It is an additional object of the invention to provide a nutritional supplement comprising a composition comprising a plant material.

It is yet another object of the invention to provide a nutritional supplement comprising a composition comprising oils derived from fruit, pith, peels, seeds, stems, leaves, roots, bark, aerial parts, and flowers of a plant.

It also an object of the present invention to provide a nutritional supplement comprising a composition comprising substances found in or derived from a lipophilic fraction of plant materials.

It also an object of the present invention to provide a nutritional supplement comprising a composition comprising substances found in or derived from an aqueous fraction of plant materials.

It is an object of the invention to provide a nutritional supplement comprising a composition comprising substances with anti-bacterial properties.

It is an additional object of the invention to provide a nutritional supplement comprising a composition comprising substances with anti-viral properties.

It is an object of the invention to provide a nutritional supplement comprising a composition comprising substances with anti-fungal properties.

It is an additional object of the invention to provide a nutritional supplement comprising a composition comprising substances with anti-parasitic properties.

It is an additional object of the invention to provide a nutritional supplement comprising a composition comprising a fermented substance.

It is an additional object of the invention to provide a nutritional supplement comprising a composition comprising a cytoprotective substance.

It is an additional object of the invention to provide a nutritional supplement comprising a composition comprising a chemopreventive substance.

It is an object of the invention to provide a nutritional supplement comprising a composition capable of modulation a microbiome of a human or an animal.

It is an object of the invention to provide a nutritional supplement comprising a composition capable of reaching a stem niche and allow for reprograming the cancer stem cells to either a state of health, or to promote orderly programmed cell death or “apoptosis” in cancer stem cells, cancer progenitor cells, and tumor cells.

It is a further object of the invention to provide a nutritional supplement that is capable of providing an environment for shutting down the residual aberrant cellular signaling by neutralizing exosomes already released by cancer stem cells.

It is an additional object of the invention to provide a nutritional supplement capable of correcting an imbalance in a cell membrane composition.

It is a further object of the present invention to provide a nutritional supplement capable of correcting a disturbance in a cell membrane function.

It is a further object of the present invention to provide a nutritional supplement or composition capable of correcting an imbalance in a stem cell niche.

It is an additional object of the present invention to provide a nutritional supplement or composition capable of improving absorption of substances applied to the skin.

It is also an object of the present invention to provide a nutritional supplement capable of providing an environment that treats a disease by modulating cell membrane composition and/or function.

It also an object of the present invention to provide a composition that is capable of inducing production of pluripotent stem cells.

It is an additional object of the invention to provide a composition that can reprogram differentiated skin cells into a pluripotent stem cell state.

It is a further object of the invention to provide a composition that is capable of altering gene expression without the use of a viral vector.

It is also an object of the invention to provide a composition that is capable of penetrating and delivering active ingredient(s) into the injured area beyond the outermost layer of epidermis.

It is also an object of the invention to provide a composition that is capable of penetrating and delivering active ingredient(s) distal from the site of injury or distal from target tissues beyond the outermost layer of the epidermis to purposely facilitate a delayed response.

In furtherance of the above objects and others, the present invention provides nutritional supplements, compositions and formulations. The majority or all of the components in the nutritional supplements, compositions and formulations are derived from or mimic bioactive substances found in or derived from various plants, including, e.g., fruits, vegetables and herbs. In some of the embodiments, bioactive substances found in a lipophilic fraction of plants comprise more than about 50% of the nutritional supplement, composition of formulation by volume or weight, depending on whether the nutritional supplement, composition or formulation is in a solid or a liquid form. In other embodiments, bioactive substances found in the lipophilic fraction of plants comprise less than about 50% of the nutritional supplement, composition and formulation by volume or weight, depending on whether the nutritional supplement, composition and formulation is in a solid or a liquid form. The components of the nutritional supplements, compositions, and formulations act together and provide an effect(s) which is not achievable by administration of the individual components of the nutritional supplement, compositions, and formulations in the absence of other components of the nutritional supplements, supplements, and formulations.

The components and the amounts of the components in the nutritional supplement, are chosen such that the nutritional supplement, when administered to a human or an animal, corrects a nutritional deficiency and/or a nutritional imbalance and/or provides an environment for one or more of the following: a modulation of a signaling cascade of an inflammatory response and/or a modulation of a hormone pathway and/or modulation of a stem cell niche; a modulation of microbiome; a modulation of stem cell niche(s); a modulation of epigenetic markers which alter gene expression; an improvement in immune function, a reduction of inflammation; an induction of apoptosis, a modulation of an immune system function in the human or animal.

In certain embodiments, a nutritional supplement comprises a composition comprising: (i) a high oleic sunflower seed oil or (ii) a mixture of the high oleic sunflower oil and an oil selected from a group consisting of coconut oil, macadamia nut oil, emu oil, and mixtures of two or more of the foregoing, wherein the composition comprises from about 30% to about 100% of the nutritional supplement by weight and is a frozen composition, a lipophilic composition, an aqueous composition, a lyophilized composition, or a powder composition. In some of these embodiments, the nutritional supplement further comprises a mixture of essential oils dispersed in the composition. The mixture of essential oils may, e.g., comprise myrrh essential oil, frankincense essential oil or a mixture of myrrh essential oil and frankincense essential oil. The mixture of essential oils may, e.g., be included in an effective amount to modulate a signaling cascade of an inflammatory response and/or modulate a signaling of a hormone pathway and/or modulates a stem cell niche and/or induce apoptosis. In some of these embodiments, the composition may further comprise a plant material. The plant material may, e.g., be included in an effective amount to modulate a signaling cascade of an inflammatory response and/or modulate a signaling of a hormone pathway and/or modulates a stem cell niche and/or induce apoptosis. In some of these embodiments, the plant material is a garlic clove. In some of the embodiments, the garlic clove maybe fermented. In some of the embodiments, fatty acids of a type and in an amount that is substantially identical to a fatty acid composition of a cell membrane (e.g., a human cell).

In certain embodiments, a nutritional supplement comprises: a base composition and one or more additional component(s) dispersed in the base composition such that the nutritional supplement has a fatty acid composition that is substantially similar to that of a membrane of a cell, an organelle or an exosome; and the one or more additional component(s) are in effective amount(s) and ratio(s) to correct a nutritional deficiency and/or an imbalance, and thereby provide an environment for one or more of the following: a modulation of a signaling cascade of an inflammatory response and/or a modulation of a hormone pathways and/or a modulation of a stem cell niche; a modulation of epigenetic markers which alter gene expression; an improvement in immune function; a modulation of microbiome; a reduction of inflammation; an induction of apoptosis, a modulation of an immune system function in the human or animal.

The base composition may include a lipid and comprise from about 30% to about 100% or about 40% to about 99% of the composition by weight or volume, depending on whether the composition is a solid or a liquid. A lipid in the base composition may, e.g., be an oil or a mixture oils, or another substance comprising fatty acids. The one or more oils of the base composition may, e.g., be selected from a group consisting of emu oil, coconut oil, macadamia nut oil, high oleic sunflower seed oil, olive oil, and mixtures comprising two, three, four or five of the foregoing oils. The lipid comprises fatty acids of a type and in relative amounts that render the formulation capable of one or more of the following: crossing, integrating, modulating, regulating, or restoring the membrane's function(s) and/or a function(s) of a cell, an organelle, or an exosome; and facilitation of a delivery of the composition to a desired location. In some embodiments, the base composition comprises a mixture of emu oil, coconut oil and macadamia nut oil. In some embodiments, the base composition comprises a mixture of high oleic sunflower seed oil, coconut oil and macadamia nut oil. Emu oil may, e.g., comprise from 0% to about 99% of the base composition by volume. Coconut oil may comprise medium chain triglycerides derived from coconut oil and comprise from 0% to 95% of the base composition by volume. High oleic sunflower seed oil may, e.g., comprise from 0% to about 90% of the base composition by volume. Macadamia nut oil may, e.g., comprise from 0% to 25% of the base composition by volume. Olive oil may, e.g., comprise from about 0% to about 80% of the base composition by volume. In some embodiments, the base composition consists of medium chain triglycerides derived from coconut oil. However, other oils and lipids can also be used in the compositions of the invention as long as they are combined in amounts that provide a base composition that has a fatty acid composition that is substantially similar as that of a membrane of a cell, an organelle or an exosome (or, in certain embodiments, a fatty acid composition that contains more oleic acid than that of a membrane of a cell, an organelle or an exosome), and renders the composition capable of crossing, integration, modulation, regulation, or restoration of membrane's function(s) and/or a function(s) of a cell and/or organelle and/or an exosome, and delivery of the formulation to a desired location.

The components and the amounts of the components in the nutritional supplement may be specifically chosen to address nutritional needs and/or correct nutritional deficiencies and/or imbalances in humans and animals suffering from various diseases, including but not limited to the following, e.g., metabolic syndrome, inflammation, insulin insensitivity, Diabetes Mellitus (Types 1 and 2), diabetic neuropathy, sleep debt, insomnia, bone regeneration, hyperlipidemia, cancer, obesity, osteoporosis, osteopenia, etc. In certain embodiments, the nutritional supplements of the invention may correct a nutritional imbalance or a nutritional deficiency and thereby modulate or change a microbiome, a stem cell niche(s), epigenetic markers, or immune function and/or reduce inflammation and/or induce apoptosis in these humans and animals.

In certain embodiments, the chosen components and their relative amounts may provide an in-vivo environment that facilitates a reduction and/or disappearance of a symptom(s) of the underlying diseas(es) and/or improved wellbeing in the human or animal.

In certain embodiments, the components, and the amounts of the components in the nutritional supplements may be specifically chosen to utilize a multi-pronged approach to address and provide a nutritional support for a multifactorial stem cell disease (e.g., cancer) and create an environment that impairs transmission of signals from one cell to another and/or facilitates apoptosis of a cell (e.g., an abnormally dividing or growing cell). In certain embodiments, a diverse array of bioactive substances provided by the methods of fermentation of the present invention may have a higher chance of providing an environment for reprogramming, redirecting, repairing, eliminating, or altering the cancer stem cell niche while preventing tumor resistance than the individual components of the nutritional supplement.

In certain embodiments, the components, and the amounts of the components in the nutritional supplement are specifically chosen to upregulate stemness markers Sox-2, Nanog, Oct4, Klf4, and c-Myc.

In certain embodiments, the components, and the amounts of the components in the nutritional supplements are specifically chosen to supply a component(s) to correct a nutritional deficiency or a nutritional imbalance in a cell membrane composition.

The nutritional supplement may also be formulated to provide an environment for reducing transmission of signals in and between the cells, e.g., to reduce signaling for pain, inflammation, excess oxidation, abnormal proliferation, etc.

The nutritional supplement may further be formulated to provide an environment for increasing healthy stem cell response to injury while limiting abnormal proliferation, division and/or other unhealthy responses of cells.

The nutritional supplement may also be formulated to interfere with functions of cell membranes of microbes, viruses, fungi, insects, and parasites thereby resulting in a destruction or inactivation of microbes, viruses, fungi, insects, and parasites or an inability of microbes, viruses, fungi, insects, and parasites to infect or inhabit their host(s).

Thus, in certain embodiments, the nutritional supplement may contain an effective amount of a composition comprising the formulation of the invention to reduce severity or alleviate a symptom of a disease, associated with an injury, damage or dysfunction of a cellular membrane or an organelle in a mammal, a nutritional deficiency, or a nutritional imbalance.

The disease associated with a nutritional deficiency, a nutritional imbalance, a dysfunction, injury of damage of a cellular membrane function may, e.g., be pain, eczema, psoriasis, erythema, a burn, a cut, a bruise, a boil, a scar, a keloid, a non-healing wound, acne, rosacea, an allergy, an arthritis, an arthralgia, cancer, a neuropathy, a metabolic syndrome, an infection, a canker sore, an ulcer, Ulcerative Colitis (UC), a mucositis, diverticulitis, celiac disease, a colitis, Crohn's Disease (CD), Irritable Bowel Syndrome (IBS), Inflammatory Bowel Disease (IBD) atherosclerosis, Alzheimer's Disease (AD), Parkinson's Disease (PD), gout, solar lentigo, senile lentigines, skin atrophy, Lichen Sclerosis (LS), Lichen Planus (LP), asthma, Chronic Obstructive Pulmonary Disease (COPD), angina, Coronary Artery Disease (CAD), hypertension (HTN), hyperlipidemia (HLD), Diabetes Mellitus (DM), metabolic syndrome, insulin resistance, a neuropathy, PMS, anxiety, depression, nightmares, insomnia, neuralgia, sciatica, mastitis, conjunctivitis, a convulsive disorder, alcohol withdrawal, abnormal muscle tension, xerosis, fibromyalgia, alopecia, Erectile Dysfunction (ED), Restless Legs Syndrome (RDS), Multiple Sclerosis (MS), Polycystic Ovarian Syndrome (PCOS), Parkinson's Disease, Premature Adrenarche, chronic sleep deficit, osteopenia, osteoporosis, anemia of chronic disease, urticaria, hemorrhoids, Chronic Fatigue Syndrome (CFS), leukoplakia, vaginal atrophy, edema, heavy lymph load, sunburn, hyperpigmented skin due to aging or prior trauma, or a muscle spasm. The symptom of the disease may, e.g., be pain, inflammation, skin irritation, rash, a lesion, a wrinkle, hyperpigmentation, a keloid, a scar, pruritus, itching, indigestion, diarrhea, a cramp, cough, a bronchospasm, a discoloration, abnormal division of cells, and combinations or two or more of the foregoing.

In certain embodiments, the nutritional supplement may comprise an amount of a formulation effective to disrupt cellular membrane function (e.g., of a virus, bacteria, fungi, insect, or parasite) and/or modulate a cellular membrane function to activate healthy response from a cell, its subcellular organelles, or a group of cells (as, e.g., in a tissue).

In certain embodiments, the nutritional supplement may comprise an effective amount of the formulation to restore proper amounts of missing cell membrane components to facilitate healthy cell signaling.

The nutritional supplements of the invention may allow, e.g., for 1) delivery of therapeutic materials directly into tissues and cells and/or 2) delivery of raw materials (e.g., proteins, minerals, vitamins, amino acids, therapeutics, etc.) necessary to rebuild tissues into the inter- and intracellular space, to rebuild tissues and/or restore a cell membrane's function or the function of membranes of subcellular organelles.

The nutritional supplements of the invention may be administered orally, topically, via an injection, or inhalation. For oral administration, the nutritional supplements may, e.g., be in the form of a liquid composition, a frozen composition, a lyophilized composition, a powder composition, a tablet, or encapsulated. For topical administration, the nutritional supplements may be formulated into a paste, a cream, an ointment, a lotion, a gel, a solution, or a poultice. For administration via injection, the nutritional supplements are sterile. For inhalation, the nutritional supplements and formulation, may be in a form of a mist, a spray, dry powder, or diffusible droplets.

In certain embodiments, a nutritional supplement of the invention may comprise bioactive substances found in lipophilic fractions of plants.

In certain embodiments, a nutritional supplement comprises a composition comprising, by weight or volume, about 10% to about 95% High Oleic Sunflower Seed Oil, about 1% to about 40% Macadamia Nut Oil, about 0.001% to 10% Coconut Oil. The composition may, e.g., be used to help absorption of other components of the nutritional supplement.

In certain embodiments, a nutritional supplement comprises a frozen composition comprising (i) a high oleic sunflower seed oil or a mixture of high oleic olive oil combined with coconut oil or macadamia nut oil, (ii) a mixture of emu oil and high oleic sunflower seed oil, (iii) a mixture of emu oil, high oleic olive oil and coconut oil, or (iv) a mixture of emu oil, high oleic olive oil and macadamia nut oil, the frozen composition comprising from about 30% to about 100% of the nutritional supplement by weight. In certain embodiments, the frozen composition comprises a mixture comprising, in % by weight, from about 3% to about 7% macadamia nut oil, from about 0.5% to about 1% coconut oil and from about 90% to about 99% emu oil. The frozen composition may also comprise a mixture comprising, in % by weight, from about 0.03% to about 0.07% macadamia nut oil, from about 0.005% to about 0.009% coconut oil and from about 90% to about 99% Emu oil. In certain embodiments, the frozen composition comprises a mixture comprising, in % by weight, from about 3% to about 7% macadamia nut oil, from about 0.5% to about 1% coconut oil and from about 90% to about 99% high oleic sunflower seed oil. In certain embodiments, a formulation comprises a mixture comprising, in % by weight, from about 0.03% to about 0.07% macadamia nut oil, from about 0.005% to about 0.009% coconut oil and from about 90% to about 99% high oleic sunflower seed oil. High oleic sunflower seed oil, coconut oil, macadamia nut oil, emu oil, and mixtures of any of the foregoing when used in accordance with the invention, may correct deficiencies and imbalances in cell membranes composition and function, and may allow other components of the nutritional supplement or formulation to incorporate into or penetrate past a cell membrane or a membrane of a cellular organelle.

In some of the embodiments, a nutritional supplement may comprise a frozen composition comprising (a) a base composition comprising (i) a high oleic sunflower seed oil or a mixture of high oleic olive oil combined with coconut oil or macadamia nut oil, (ii) a mixture of emu oil and high oleic sunflower seed oil, (iii) a mixture of emu oil, high oleic olive oil and coconut oil, or (iv) a mixture of emu oil, high oleic olive oil and macadamia nut oil; and (b) a mixture of essential oils; wherein the mixture of essential oils are dispersed in the base composition; and the base composition comprises from about 30% to about 99% of the formulation by weight.

In additional embodiments, a nutritional supplement may comprise a frozen composition comprising (a) a base composition comprising (i) a high oleic sunflower seed oil or a mixture of high oleic olive oil combined with coconut oil or macadamia nut oil, (ii) a mixture of emu oil and high oleic sunflower seed oil, (iii) a mixture of emu oil, high oleic olive oil and coconut oil, or (iv) a mixture of emu oil, high oleic olive oil and macadamia nut oil; (b) a mixture of essential oils and (c) one or more additional components; wherein the mixture of essential oils and additional components are dispersed in the base composition; and the base composition comprises from about 30% to about 99% of the formulation by weight.

In some embodiments, a nutritional supplement may comprise a liquid comprising (a) a base composition comprising (i) a high oleic sunflower seed oil or a mixture of high oleic olive oil combined with coconut oil or macadamia nut oil, (ii) a mixture of emu oil and high oleic sunflower seed oil, (iii) a mixture of emu oil, high oleic olive oil and coconut oil, or (iv) a mixture of emu oil, high oleic olive oil and macadamia nut oil; (b) a plant material; and (c) a mixture of essential oils comprising myrrh essential oil, frankincense essential oil or a mixture of myrrh essential oil and frankincense essential oil; wherein the plant material and the mixture of essential oils are dispersed in the base composition; and the base composition comprises from about 30% to about 99% of the liquid by volume.

A nutritional supplement may also comprise a liquid composition comprising: (a) a base composition comprising a high oleic sunflower seed oil or a mixture of the high oleic sunflower oil and an oil selected from a group consisting of coconut oil, macadamia nut oil, emu oil, and mixtures of two or more of the foregoing; (b) a plant material; and (c) a mixture of essential oils comprising myrrh essential oil, frankincense essential oil or a mixture of myrrh essential oil and frankincense essential oil; wherein the plant material and the mixture of essential oils are dispersed in the base composition; and the base composition comprises from about 30% to about 99% of the liquid composition by volume. In some of these embodiments, the base composition comprises fatty acids of a type and in an amount that is substantially identical to a fatty acid composition of a cell membrane of a human cell. The liquid composition may, e.g., be included in an effective amount to modulate a signaling cascade of an inflammatory response and/or modulate a signaling of a hormone pathway and/or modulates a stem cell niche and/or induce apoptosis. The liquid composition may, e.g., comprise bioactive substances found in a plant selected from a group consisting of mangosteens, pomegranates, rambutans, longan fruit, lychee fruit, aloe, papaya, blackberries, cherries, raspberries, blueberries, marioberries, citrus fruits, bitter melons, dragonfruits, seaweed, soy beans, broccoli sprouts, cabbages, apples, pears, and beets.

In some of the embodiments a nutritional supplement may comprise: (i) a base composition comprising a lipid comprising fatty acids, (ii) a biofermented substance, and (iii) one or more additional component(s) selected from a group consisting of a phospholipid, a ceramide, a sphingolipid, cholesterol, a fatty acid, an oil, a vitamin, a mineral, an amino acid, a therapeutic agent, a bioactive ingredient, an exosome, food grade diatomaceous earth/biosilicates, or a combination of two or more of any of the foregoing, wherein the biofermented product is dispersed in the base composition, the fatty acids in the base composition are of a type and in amounts that render a fatty acid composition of the base composition substantially identical to a fatty acid composition of a cell membrane or a cell organelle or a sebum or an exosome of a mammalian cell, and the base composition comprises from about 30% to about 99% of the formulation by volume. In some of these embodiments, the base composition may comprise one or more of the following: emu oil; high oleic sunflower seed oil; olive oil; a mixture of essential oils of German chamomile, Roman chamomile, and Moroccan chamomile, the mixture comprising from about 5% to about 30% of the nutritional supplement by volume; a mixture comprising essential oils of clove, cinnamon, rosemary, Eucalyptus, lemon, ravintsara, and cinnamon dispersed in the base composition, wherein essential oil of clove comprises from about 0.1% to 30% of the nutritional supplement or formulation by volume, essential oil of cinnamon comprises from about 0.1% to 30% of the nutritional supplement or formulation by volume, essential oil of rosemary comprises from about 0.1% to 30% of the nutritional supplement or formulation by volume, essential oil of Eucalyptus comprises from about 0.1% to 30% of the nutritional supplement or formulation by volume, essential oil of lemon comprises from about 0.1% to 30% of the nutritional supplement or formulation by volume, essential oil of ravintsara comprises from about 0.1% to 20% of the nutritional supplement or formulation by volume, essential oil of cinnamon leaf comprises from about 0.05% to about 20% of the nutritional supplement or formulation by volume.

The base composition of the invention facilitates an absorption and/or delivery of the plant, the biofermented substance, the mixture of essentials oils and the additional component(s), when present, across cell membranes to a desired location. Once at the desired location, the plant and the mixture of essential oils corrects a nutritional deficiency and/or imbalance and/or creates an environment suitable for the provision of the intended effect.

In certain embodiments, a nutritional supplement may comprise a composition comprising a seed, a peel, a bark, a leaf, a pith, a stem, a root, a fruit of a plant, and mixtures of two or more of foregoing. In some of these embodiments, the plant may be selected from a group consisting of papaya, mangosteen, rambutans, longans, lychees, lemon, grapefruit, oranges, tangerines, pomegranates, tamarind, apple, bitter melon, soybeans, lotus root, and mixtures of two or more of the foregoing, wherein the nutritional supplement comprises an effective amount of the composition to modulate a signaling cascade of an inflammatory response; and the composition is a frozen composition, a lyophilized composition, a powder composition, or a liquid composition. In some of the embodiments, the nutritional supplement may comprise the seed and the peel of the plant. In some of the embodiments, the fruit is an aril of the plant (e.g., an aril of a pomegranate). In some of the embodiments, the composition is fermented. The composition may further comprise one or more of additional component(s) selected from a group consisting of molds, fungi, bacteria, yeasts, flowers, flower buds, honey, bee pollen, propolis, nuts, seeds, fruit, leaves, vegetables, bark, aloe vera, rambutans, bitter melons, chrysanthemum greens, dragon fruit, longan, fresh ginger root or ginger powder, fresh licorice or Glycyrrhiza glabra powder, vitamins, minerals, lipids, aqueous extracts from plants, and amino acids. Additional components may be comprised of plant, animal, or organic material not listed herein, for example cordyceps fungi derived from a parasite.

A nutritional supplement of the invention may also comprise a lyophilized composition comprising bioactive substances found in aqueous fractions of plants. The lyophilized composition may, e.g., comprise a plant material in an effective amount to correct a nutritional deficiency or a nutritional imbalance in a human or an animal. The plant material may, e.g., include a seed, a peel, a pith, a stem, a bark, a leaf, a fruit of a plant, or a mixture of two or more of the foregoing. The seed of a plant may, e.g., be selected from a group consisting of papaya seeds, mangosteen seeds, lemon seeds, grapefruit seeds, lime seeds, tangerine seeds, pomelo seeds, orange seeds, pomegranate seeds, tamarind seeds, apple seeds, dragonfruit seeds, longan seeds, lychee seeds, rambutan seeds, kiwi seeds, fig seeds, grape seeds, tamarind seeds and mixtures of two or more of the foregoing. The peels of a plant may, e.g., be selected from a group consisting of mangosteen peels, pomegranate peels, lemon peels, orange peels, grapefruit peels, mangosteen peels, apple peels. The arils may, e.g., be pomegranate arils. The lyophilized composition may further comprise one or more of the following additional components: chrysanthemum flowers, honey, bee pollen, taro leaf, lotus leaf, aloe vera, rambutans, bitter melons, chrysanthemum greens, dragon fruit, longan fruit, lychee fruit, notoginseng flower buds, kuding leaves, magnolia leaves, ginger powder, licorice or Glycyrrhiza glabra powder, amino acids, fatty acids, concentrated plant bioactive compounds, Vitamin A, Vitamin C, Vitamin D3, Vitamin E, Vitamin K, Vitamin B1, Vitamin B2 Vitamin B3, Vitamin B5, Vitamin B6, Vitamin B9, Vitamin B12, Biotin, Iron, Zinc, Selenium, Manganese, Chromium, Molybdenum.

A nutritional supplement of the invention may further comprise a liquid composition comprising bioactive substances found in aqueous fractions of plants. The liquid composition may, e.g., comprise blended seeds and/or arils and/or peels of a plant in an effective amount to correct a nutritional deficiency or a nutritional imbalance in a human or an animal. The seed of a plant may, e.g., be selected from a group consisting of papaya seeds, mangosteen seeds, lemon seeds, grapefruit seeds, orange seeds, pomegranate seeds, tamarind seeds, apple seeds, and mixtures of two or more of the foregoing. The peels of a plant may, e.g., be selected from a group consisting of mangosteen peels, pomegranate peels, lemon peels, orange peels, grapefruit peels, mangosteen peels, apple peels. The arils may, e.g., be pomegranate arils. The liquid composition may further comprise one or more of the following additional components: chrysanthemum flowers, honey, taro leaf, lotus leaf, aloe vera, rambutans, bitter melons, chrysanthemum greens, dragon fruit, longan, notoginseng flower buds, kuding leaves, magnolia leaves, ginger powder, licorice or Glycyrrhiza glabra powder, Food Grade Diatomaceous Earth/biosilicates, any of multiple herbs, plants, animal products or organic material previously found to be useful as a supplement or medicine, Vitamin A, Vitamin C, Vitamin D3, Vitamin E, Vitamin K, Vitamin B1, Vitamin B2, Vitamin B3, Vitamin B5, Vitamin B6, Vitamin B9, Vitamin B12, Biotin, Iron, Zinc, Selenium, Manganese, Chromium, Molybdenum.

A nutritional supplement may also comprise an inhalation formulation comprising bioactive substances found in aqueous fractions of plants. The liquid composition may, e.g., comprise blended seeds and/or arils and/or peels of a plant in an effective amount to correct a nutritional deficiency or a nutritional imbalance in a human or an animal. The seed of a plant may, e.g., be selected from a group consisting of papaya seeds, mangosteen seeds, lemon seeds, grapefruit seeds, orange seeds, pomegranate seeds, tamarind seeds, apple seeds, and mixtures of two or more of the foregoing. The peels of a plant may, e.g., be selected from a group consisting of mangosteen peels, pomegranate peels, lemon peels, orange peels, grapefruit peels, apple peels. The arils may, e.g., be pomegranate arils. The liquid composition may further comprise one or more of the following additional components: chrysanthemum flowers, honey, taro leaf, lotus leaf, aloe vera, rambutans, bitter melons, chrysanthemum greens, dragon fruit, longan, notoginseng flower buds, kuding leaves, magnolia leaves, ginger powder, licorice or Glycyrrhiza glabra powder, Food Grade Diatomaceous Earth/biosilicates, any of multiple herbs, plants, animal products or organic material previously found to be useful as a supplement or medicine, Vitamin A, Vitamin C, Vitamin D3, Vitamin E, Vitamin K, Vitamin B1, Vitamin B2, Vitamin B3, Vitamin B5, Vitamin B6, Vitamin B9, Vitamin B12, Biotin, Iron, Zinc, Selenium, Manganese, Chromium, and Molybdenum.

A nutritional supplement of the invention a liquid composition comprising bioactive substances found in aqueous fractions of plants may specifically comprise a lyophilized composition comprising 0.01% to 20% ginger root powder and Glycyrrhiza glabra powder in a 1:1 ratio in an effective amount to correct a nutritional deficiency or a nutritional imbalance in a human or an animal.

In certain embodiments, a nutritional supplement may comprise a fermented composition comprising bioactive substances found in aqueous fractions of plants. The fermented composition may, e.g., a plant material (e.g., blended seeds and/or arils and/or peels of a plant) in an effective amount to correct a nutritional deficiency or a nutritional imbalance in a human or an animal. The seed of a plant may, e.g., be selected from a group consisting of papaya seeds, mangosteen seeds, citrus seeds (e.g., lemon seeds, grapefruit seeds, orange seeds), pomegranate seeds, tamarind seeds, apple seeds, and mixtures of two or more of the foregoing. The peels of a plant may, e.g., be selected from a group consisting of mangosteen peels, pomegranate peels, lemon peels, orange peels, grapefruit peels, apple peels. The arils may, e.g., be pomegranate arils. The fermented composition may further comprise one or more of the following additional components: microbes molds, fungi, bacteria and yeasts; chrysanthemum flowers, honey, taro leaf, lotus leaf, aloe vera, rambutans, bitter melons, chrysanthemum greens, dragon fruits, longan, notoginseng flower buds, kuding leaves, magnolia leaves, ginger powder, licorice or Glycyrrhiza glabra powder, Food Grade Diatomaceous Earth/biosilicates, any of multiple herbs, plants, animal products or organic material previously found to be useful as a supplement or medicine, soy milk, broccoli sprouts, Vitamin A, Vitamin C, Vitamin D3, Vitamin E, Vitamin K, Vitamin B1, Vitamin B2, Vitamin B3, Vitamin B5, Vitamin B6, Folate, Vitamin B12, Biotin, Iron, Zinc, Selenium, Manganese, Chromium, Molybdenum, bee pollen, wormwood powder, guavas, cabbage, cellulose, Red Dulse flakes, quercetin dehydrate, pomegranate extract, ellagic acid, beet, beet powder, resveratrol, sugar, pectin enzymes, Artemisia annua, and prunella vulgaris.

In certain embodiments, the fermented composition comprises bioactive substances found in mangosteens, pomegranates, rambutans, aloe, papaya seeds, blackberries, cherries blueberries, citrus fruits, bitter melons, dragonfruits, cabbage (e.g., red cabbage) and beets. In some of these embodiments, the fermented composition further comprises (i) molds, fungi, bacteria and yeasts and/or (ii) water. The fermented composition may however be lyophilized and be free from water. The molds, fungi, bacteria, and yeasts in the fermented formulation are, e.g., indispensable for fermentation.

In certain embodiments, the fermented composition comprises bioactive substances found in mangosteens and pomegranates. In some of these embodiments, the fermented composition further comprises (i) molds, fungi, bacteria, and yeasts and/or (ii) water.

In certain embodiments, the fermented composition comprises bioactive substances found in rambutans, aloe, papaya seeds, blackberries, cherries blueberries, any of the citrus fruits and bitter melons. In some of these embodiments, the fermented composition further comprises (i) molds, fungi, bacteria, and yeasts and/or (ii) water.

In certain embodiments, the fermented composition comprises bioactive substances found in dragonfruits, red cabbage and beets. In some of these embodiments, the fermented composition further comprises (i) molds, fungi, bacteria, and yeasts and/or (ii) water.

In certain embodiments, the invention is directed to a nutritional supplement comprising a formulation comprising a composition comprising, by weight, about 20% to about 80% Tranexamic Acid, about 10% to about 95% High Oleic Sunflower Seed Oil, about 0.001% to about 40% Macadamia Nut Oil, about 0.001% to 10% Coconut Oil, about 0.01% to about 5% Ginger, and about 0.01% to about 5% Glycyrrhiza glabra. The formulation may be a topical formulation or an oral formulation. In some of these embodiments, the nutritional supplement may be used to provide nutritional support for humans with excessive bleeding or with tremors and rigidity.

In certain embodiments, the invention is directed to a nutritional supplement comprising a formulation comprising a composition comprising, by weight, about 10% to about 60% Fenugreek Powder, about 10% to about 40% White Peony Root Powder, about 10% to about 40% Matcha Green Tea Powder, about 1% to about 10% Glycyrrhiza glabra Powder, and about 1% to about 10% Ginger Root Powder. In some of these embodiments, the nutritional supplement to improve libido, energy, digestion, reduce malodorous body odor in both male and females, and increase breast size in non-lactating females.

The nutritional supplements and compositions of the invention may be used in various combinations with each other to address a particular deficiency or achieve a desired effect. For example, nutritional supplements and compositions comprising a high oleic sunflower seed oil, coconut oil, macadamia nut oil, and mixtures thereof maybe used in combination nutritional supplements and compositions comprising bioactive substances found in aqueous fractions of plants (e.g., blended seeds and/or arils and/or peels of a plants). Nutritional supplements and compositions comprising bioactive substances found in aqueous fractions of plants may be administered before, after, concurrently or intermittently with the nutritional supplements comprising a high oleic sunflower seed oil, coconut oil, macadamia nut oil, and mixtures thereof. In certain embodiments, the use of these two types of nutritional supplements and compositions allows for an achievement of a synergistic effect.

The nutritional supplements and compositions of the invention may be used to tread a disorder selected from a group consisting of pain, eczema, psoriasis, erythema, a burn, a cut, a bruise, a boil, a scar, a keloid, a non-healing wound, acne, rosacea, an allergy, an arthritis, an arthralgia, cancer, a neuropathy, a metabolic syndrome, an infection, a canker sore, an ulcer, Ulcerative Colitis (UC), a mucositis, diverticulitis, celiac disease, a colitis, Crohn's Disease (CD), Irritable Bowel Syndrome (IBS), Inflammatory Bowel Disease (IBD) atherosclerosis, Alzheimer's Disease (AD), Parkinson's Disease (PD), gout, solar lentigo, senile lentigines, skin atrophy, Lichen Sclerosis (LS), Lichen Planus (LP), asthma, Chronic Obstructive Pulmonary Disease (COPD), angina, Coronary Artery Disease (CAD), hypertension (HTN), hyperlipidemia (HLD), Diabetes Mellitus (DM), metabolic syndrome, insulin resistance, a neuropathy, PMS, Premature Adrenarche, anxiety, depression, nightmares, insomnia, neuralgia, sciatica, mastitis, conjunctivitis, a convulsive disorder, alcohol withdrawal, abnormal muscle tension, xerosis, fibromyalgia, alopecia, Erectile Dysfunction (ED), Restless Legs Syndrome (RDS), Multiple Sclerosis (MS), abnormal sleep debt, osteopenia, osteoporosis, anemia of chronic disease, urticaria, hemorrhoids, Chronic Fatigue Syndrome (CFS), leukoplakia, vaginal atrophy, polycystic ovarian syndrome (PCOS), edema, heavy lymph load, sunburn, hyperpigmented skin, and a muscle spasm. A method of treatment comprises administering a nutritional supplement or composition of the invention to a human or an animal in need of treatment. In the preferred embodiments, the administration of the nutritional supplement or composition of the invention provides a reduction and/or disappearance of a symptom(s) of the underlying diseas(es) and/or a feeling of an improved wellbeing in the human or animal being treated. The invention specifically encompasses treatment of metabolic syndrome, inflammation, insulin insensitivity, Diabetes Mellitus (Types 1 and 2), diabetic neuropathy, sleep debt, insomnia, cancer, osteoporosis, osteopenia, bone regeneration, hyperlipidemia, and obesity.

### BRIEF DESCRIPTION OF THE DRAWINGS

FIG. 1. A ligand (a chemical messenger from outside of the cell) binds when receptors find their counterpart, generating signals that reach into the cell to direct the cell's command center, the nucleus to act (for example, directing the cell to grow out of control).

FIG. 2. Multiple chronic diseases are associated with abnormal cell lipid composition.

FIG. 3. Exogenously supplied phospholipids, sphingolipids, and fatty acids can incorporate into existing cell membranes, and be used to create new cells.

FIG. 4. Exogenously supplied phospholipids, sphingolipids, and fatty acids incorporate into cell membranes, raising the threshold required for cell signaling.

FIG. 5. Exogenously supplied phospholipids, sphingolipids, and fatty acids confer therapeutic compounds with the ability to cross the normally hydrophobic cell membranes. Once inside the cell they can direct the command center of the cell (the nucleus) to calm inflammation, to shut down cancer genes, etc.

FIG. 6. Loading of diatoms with minerals, amino acids, vitamins, and bioactive compounds, then coating them with substances that confer penetrability of human skin as well as cell membranes.

FIG. 7. Time release of therapeutic substances into the skin, as well as past the cell membrane. Delivery of these raw materials facilitate cellular and tissue repair.

FIG. 8. Schematic of A Diatom Releasing Multiple Active Ingredients Over >2 Weeks.

FIG. 9. Additive Effects of Long-Term Fraction (Biosilicates Loaded with Active Ingredients).

FIG. 10. Pluripotency Can Be Induced by Stimulation of 4 Transcription Factors in a Terminally Differentiated Cell to Give Rise to Multiple Other Cell Types. (Obtained from http://2.bp.blogspot.com/-j9cpH1VCTFU/TiVeGabbeoI/AAAAAAAAAkI/W4c86aZASIY/s640/ipscs.jpg)

FIG. 11. Totipotent Stem Cells from Embryos Give Rise to Pluripotent Stem Cells Capable of Generating Multiple Cell Types (obtained from https://lh5.googleusercontent.com/-jZ3YrRhTVRU/TXhVpt4GvxI/AAAAAAAAAB4/pJoGVRefPwk/s1600/pluripotent-stem-cells.jpg)

FIG. 12. Reprogramming of Somatic Cells to A Pluripotent Stem Cell Using 4 Transcription Factors (Yamanaka Transcription Factors).

### DEFINITIONS

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context. The use of any and all examples, or exemplary language (e.g., “such as”), is intended merely for illustration and does not pose a limitation on the scope of the invention unless otherwise claimed. No language in the specification should be construed as indicating any non-claimed element as essential to the practice of the invention.

The terms “a” and “an” do not denote a limitation of quantity, but rather denote the presence of at least one of the referenced item(s).

The term “about” in the present specification means a value within 20% (±20%) of the value recited immediately after the term “about,” including the value equal to the upper limit (i.e., +20%) and the value equal to the lower limit (i.e., −20%) of this range. For example, the phrase “about 100” encompasses any numeric value that is between 80 and 120, including 80 and 120.

The term “biofermentation substance” as used herein means a product of biofermentation.

An abbreviation “EO” as used herein means “essential oil.”

The term “a frozen composition” as used herein means that that the composition at temperatures below 0° C., but at least partially liquefies within 8 hours of being exposed to a temperature of 25° C.

The term “a lyophilized composition” as used herein is synonymous with a term “a freeze-dried composition” means that the water was removed from the composition by a low temperature dehydration process (i.e., lyophilization or freeze drying), while the bioactive substances were retained. A low temperature dehydration process involves freezing a substance, lowering pressure, and then removing the ice by sublimation. A “lyophilized composition” is different from the substance that was lyophilized in terms of structure, composition, and physical properties.

The term “a powder composition” as used herein means that the composition comprises a plurality of particles.

The terms “substantially similar” and “substantially identical” with reference to a fatty acid composition of a formulation as used herein means that the formulation contains fatty acids of the type and in the amounts that allow the formulation to cross and/or integrate into a membrane or organelle of a cell or modulate a function of an exosome. The terms “substantially similar” and “substantially identical” encompasses fatty acid compositions that are identical to that of a membrane of a cell or an organelle; and the fatty acid compositions that are not identical to that of a membrane of a cell or an organelle but still allow the formulation to cross and/or integrate into a membrane of a cell or an organelle and/or modulate a function of an exosome. A fatty acid composition that is “substantially similar” or “substantially identical” to that of a membrane of a cell or organelle as used in the present specification is different from and does not encompass the fatty acid composition of emu oil, as it, e.g., comprises a higher amount of oleic acid times than emu oil (e.g., at least 1.5 to 2 times higher) than the emu oil.

The term “an organelle” refers to a lipid-bilayer enclosed subcellular differentiated structure within a cell which performs a specific function. An organelle is usually visible under the microscope as a distinct structure or object. Examples would include ribosomes, mitochondria, vacuoles, etc.

The term “exosome” as used in the present specification means a membrane bound extracellular vesicle.

The term “an essential oil” as used in the present specification means a volatile oil or mixture of volatile oils and other substances obtained by chemical extraction from a plant which typically has a characteristic odor or flavor of the plant from which it is obtained. Essential oils may be obtained from just one part of the plant (for example, essential oil of ginger root, vs essential oil of bay leaves). Essential oils may be different depending on the solvent used to extract the bioactive compounds—for example, CO2 extraction vs aqueous extraction vs alcohol extraction may yield different mixtures or proportions of bioactive compounds from the same plant.

The term “short chain fatty acid” or “short chain triglyceride” as used in the present specification means that the fatty acid or triglyceride contains less than 6 carbons.

The term “medium chain fatty acid” or “medium chain triglyceride” as used in the present specification means that the fatty acid or triglyceride comprises between 6 and 12 carbons.

The term “long-chain fatty acid” or “long chain triglyceride” means that the fatty acid or triglyceride contains more than 12 carbons.

The term “medium chain triglycerides” or “MCT oil” as used in the present specification means that the fraction of coconut oil comprised only of fatty acids within which have between 6-12 carbons, including caproic acid (C6), caprylic acid (C8), capric acid (C10), and lauric acid (C12). These MCTs are liquid at room temperature, do not require a carrier molecule to be metabolized, and when used in accordance with the present invention, can readily cross both the cellular membrane as well as that of the mitochondria where it can be directly metabolized. Some of these fatty acids have other properties and provide an additional benefit(s) (for example, lauric acid has antibacterial properties, and could, e.g., be used in the acne formulation according to the invention, to inhibit P. acne bacterium).

The term “Vegan Liquid Skin” as used in the present formulation refers to an embodiment of a base composition comprising a high oleic sunflower seed oil or a mixture of high oleic olive oil combined with coconut oil or macadamia nut oil or coconut oil or macadamia nut oil, the base composition comprising fatty acids of a type and in amounts that render a fatty acid composition of the base composition substantially identical to a fatty acid composition of a cell membrane or a cell organelle or a sebum or an exosome of a mammalian cell.

The term “Liquid Skin” as used in the present specification refers to an embodiment of a base composition comprising (a) emu oil and (b) a high oleic sunflower seed oil or a mixture of high oleic olive oil combined with coconut oil or macadamia nut oil or coconut oil or macadamia nut oil, the base composition comprising fatty acids of a type and in amounts that render a fatty acid composition of the base composition substantially identical to a fatty acid composition of a cell membrane or a cell organelle or a sebum or an exosome of a mammalian cell.

The term “high oleic acid sunflower seed oil” as used in the present specification means sunflower oil comprising at minimum 80% oleic acid.

The term “sunflower seed oil” means sunflower oil comprising about 20% oleic acid.

The term “a plant material” as used herein includes a seed, a root, a stem, a leaf, a bark, a pith, a flower, a fruit, a pollen, a fruiting body, an aeriel parts of a plant, and parts of any of the foregoing.

The term “by weight or volume” as used in the present specification means that if the composition is a solid then the recited percentages are by weight and if the composition is a liquid, then the recited percentages are by volume.

### DETAILED DESCRIPTION

Plants possess intricate design, and the study of modern medicine arose from materia medica and materia plantae—the study of herbs. Specific plants have specific functions which benefit and strengthen function of specific organs.

Plant materials have a well-established record of improving human health when consumed. It is from plants that humans derive most of their micronutrition; while macronutrients (in particular protein) is found in greater abundance by consumption of animal products, except for a few protein-rich legumes that possess a complete protein profile.

Fruit and seeds of plants contain compact nutrition required to nourish new life for the plant. For example, the fleshy part of the apple decomposes in an animal gut leaving the seeds intact to be excreted with dung, which is fertilizer for the intact seed embedded within it. The process of decay involves fermentation which allows the seed to germinate and give new life in the form of a seedling.

Plants, fruit, and herbs being sessile organisms do not have the luxury of physically running away from their predators, which include herbivores, insects, viruses, molds, and parasites. Instead, plants, fruit, and herbs produce and rely on an array of bioactive compounds to survive. These bioactive plant compounds protect plants, fruits and herbs against insects, viruses, molds, and parasites.

The ingestion or application of these bioactive plant compounds have salubrious effects on human health when taken in the right dose and combination in accordance with the present invention may be beneficial and used to provide nutritional support to humans and animals leaving with diseases.

The nutritional supplements and formulations of the invention take into consideration the fact that humans and animals are colonized by a dynamic microbiome which directly influences the metabolism and immune function of humans and animals. While the human body has been estimated to be composed of 15-37 trillion cells, the bacterial microbiome colonizing one human is composed of over a staggering 100 trillion bacterial cells than human cells (PMID 16497592).

The microbiome generates antimicrobial peptides called bactericidins which protect bacteria from other bacteria. This keeps the human and animal host from being overrun with one strain of bacteria, which may have pathological effects. Thus, the microbiome also serves to outcompete pathologic bacterial species and thus it keeps them in check. Alterations in the microbiome have been associated with specific diseases with a metabolic and immune component—for example, Type I diabetes and colorectal cancer (PMID 32422014).

The microbiome of humans and animals plays a large role in the nonspecific immunity of humans and animals via multiple mechanisms. For example, the microbiome in the gut regulates immune defense by sending signals which help in maturation of important immune system tissues—germ-free mice have underdeveloped gut-associated lymphoid tissues, including Peyer's patches, isolated lymphoid follicles, and mesenteric lymph nodes (PMID 19343057). Interestingly, the microbiome within the gut makes mRNA signals which lead to expression of signals required to consistently generate virus-specific immune cells and antibodies to fight off flu. Thus modulation of the microbiome via plant bioactive compounds is one means by which the human immune system may be modulated.

Human daily food choices directly determine the health of our microbiome, which in turn directly affects immune function and our metabolism.

What humans eat also changes their metabolism.

Microbiome composition directly affects the efficiency by which humans metabolize macronutrients, specifically carbohydrates (PMCID: PMC6107068). Multiple animal studies and several in humans show significant differences in the microbiomes taken from lean vs obese animals or humans. Furthermore, fecal transplantation from obese to lean subjects caused lean subjects to gain weight without changing diet or exercise habits. Similarly, fecal transplantation from lean to obese subjects also caused obese subjects to lose weight without changing diet or exercise habits.

Thus, adhering to a diet low in refined sugars, and one high in micronutrients and plant fiber which serve as food for beneficial gut bacteria will optimize metabolism and immune function. Reduction in refined sugar intake reduces fungal overgrowth, and reduces risk for obesity, diabetes, cancer, and other diseases which are exacerbated by an overabundance of refined sugar.

A discussion of microbiomes would be remiss without inclusion of viral genetic material to which the human has been exposed. Exposure to viruses may result in long-lasting changes to the human genome, which lead to disease. For example, multiple studies document the ability of viruses to predispose or cause diseases as seemingly different as diabetes and cancer. For example, human sarcoma-associated herpesvirus 8 (HHV-8), also known as Kaposi Sarcoma herpesvirus (KSHV) is one of seven currently known human cancer viruses (oncoviruses) which bury themselves in the genetic material of lymphocytes (immune cells). Via multiple mechanisms, the virus alters the metabolism of its human host towards that of a high sugar state (predisposing to diabetes) but also creating an environment permissive to cancers, which feed on sugar. Thus, modulation of viral proteins via plant bioactive compounds provides one means of mitigating or neutralizing this risk. Plants and humans alike require defenses against viruses. While plants do not have lungs, they have developed intricate overlapping compounds which inhibit or neutralize signaling factors hijacked by viruses such as COVID-19. Thus, plants with anti-viral properties are particularly useful in mitigating or altering the course of multifactorial diseases such as diabetes, cancer, and COVID-19.

High protein diets prevent muscle catabolism and preserve existing muscle, which determines much of the basal metabolic rate. A diet which includes healthy omega 3 fats will also help to balance the modern diet which is heavy on inflammatory omega 6 fats which predispose to diseases of inflammation—cardiovascular disease, diabetes, hyperlipidemia, hypertension, autoimmune disorders, and cancer, to name a few.

The nutritional supplements, compositions and formulations of the invention are designed to correct the imbalances created by modern diets, sedentary lifestyles, and pathologies. The nutritional supplements, compositions and formulations combine several specifically chosen components that together may provide an effect(s) that is (are) not achievable by consumption of individual components of the nutritional supplements, compositions, and formulations.

In some of the embodiments, the components are selected such that the nutritional supplements and formulations help multifactorial diseases, e.g., diabetes, cancer, etc.

In some of the embodiments, a supplement with a combination of plant compounds provides more robust and redundant signals which exert effects on both the human and its microbiome than single compound supplements.

In some of the embodiments, to reduce side effects and improve effectiveness, the nutritional supplements and formulation provides for the modification and diversification of bioactive substances present in a plant or herb compound, e.g., by fermentation. This is because minute variations in the human genome exist (called polymorphisms) which determine whether a particular drug or supplement will be effective; and which determine side effects.

As an analogy, the human body could be considered as a lock while a plant compound can be considered a key. For the plant compound to have an effect it must be able to bind to the appropriate receptors as a key may fit into a lock. Each human then may be thought of as having slightly differently shaped locks on their cell surfaces and consequently each human may need an individualized composition. Increasing the diversity of bioactive substances in the nutritional supplement or formulation in accordance with the invention may therefore increase the effectiveness of the nutritional supplement or formulation and render it beneficial for use for many humans.

Diversification also increases the permutations of a particular bioactive molecule and creates more chances that one of the permutations will be able to exert an effect; it decreases the risk associated with high concentrations of one particular compound; and increases the chances that it will benefit each subject.

Diversification further has a secondary benefit—it is an effective strategy for preventing tolerance to a specific molecule when treating a multifactorial, ever-evolving disease, e.g., such as infections, diabetes, and cancer.

Thus, in certain embodiments, the invention is utilizing fermentation of plant extracts to diversify the healthful properties of bioactive compounds, particularly against various infections, inflammation, and cancer. For example, fermented extracts of pomegranates were shown to improve their ability to kill breast cancer cells by several fold in vitro as compared to fresh extracts of pomegranates.

Traditional medicine practices as well as modern medicine and pharmacology recognizes that like dissolves like, that a compound can be both medicine or poison depending on dose, and that similarities observed in nature may reveal molecular patterns which are analogous in different organisms. For example, traditional medical theory indicates that eating analogous organs from animals can supply raw materials for repair of human organs—and thus organ meats were highly prized in many cultures around the world. It was recognized that organ meats, sweetbreads and the like supplied a concentration of nutrients difficult to obtain elsewhere—and this observation has been verified with modern scientific and nutritional analysis.

As another example, traditional medical wisdom from multiple cultures recommends eating walnuts to nourish the brain, as the walnut has a morphology very similar to that of the brain. Modern scientific analysis of walnuts supports this as well—walnuts provide phytochemicals, macro and micronutrients which affect multiple pathways to limit amyloidogenesis, tau phosphorylation, oxidative stress, improve cholinergic pathways, lower serum cholesterol and support neurogenesis (PMID 29208493).

Traditional medical wisdom from multiple cultures have taught that the antidote for a specific disease may reside in something that shares a similar morphology. Solid tumors with capsules most closely resemble pomegranates, blueberries, citrus, and figs while soft tumors without capsules (such as hemangiomas) most closely resemble blackberries, raspberries, lingonberries, marionberries and the like. A review of the primary literature of these fruits reveal that all of the above listed fruits possess anti-cancer properties, as summarized in Table 1.

Thus, in certain embodiments, the components, and the amounts of the components in the nutritional supplements or formulations are chosen to specifically direct the components to a target organ. For example, in certain embodiments, a predominance of blackberries and raspberries maybe used in nutritional supplements for use in humans and animals with soft tumors (e.g., lymphangioma-hemangioma). In certain embodiments, a predominance of pomegranates (including the rind) and blueberries for subjects with encapsulated tumors with calcification, such as lung and breast cancer, may be used.

### Components

The components for inclusion into the nutritional supplements, compositions and formulations are selected based on the desired indication and/or needs of a particular subject (e.g., a human in need of a treatment), based on the guidelines provided in the application, and the knowledge of a person of ordinary skill in the art.

The components of the nutritional supplements comprise bioactive substances found in plants, including, e.g., herbs, fruit, and vegetables. Exemplary components which could be included in the nutritional supplements, compositions and formulations of the invention are listed throughout the specification and in Table 1. It is contemplated that a mixture of any two (or more) ingredients from Table 1 could be used in the nutritional supplements and formulations of the invention. It is noted here that any plant with bioactive compounds could potentially be added to Table 1, which is not exhaustive for purposes of brevity.

TABLE 1

| Ingredient | Properties | Exemplary Utilities |
|---|---|---|
| Emu oil (EO) | Anti-inflammatory, decreases swelling, capable | Diseases involving |
| (contains oleic acid, | of delivery of ingredients into skin, for example | inflammation, |
| linoleic acid, as well as | increasing hair growth when combined with | including, e.g., pain, |
| antioxidants | minoxidil as compared to minoxidil alone | cancer and aging; |
| carotenoids and | (PMID 25657781). | multiple sclerosis, |
| flavones) | Emu oil may exert its anti-inflammatory effects | rheumatoid and |
| Range: 1-99% | by 5 main mechanisms: | osteoarthritis, |

| by volume | 1) | By reducing cellular production of | arthralgias induced by |
|---|---|---|---|
| | | inflammatory cascade members NO, | chemotherapy, gout, |
| | | TNF-α, and iNOS in macrophages | ulcerative colitis, |
| | | (PMID 29526880) but does not impair | improves skin barrier |
| | | their ability to phagocytose (engulf) | function, reduces dark |
| | | debris or bacteria. | spots from sun |
| | 2) | EO also inhibits inflammation due to its | exposure, many others. |

| | high concentration of Omega-3, which |
|---|---|
| | inhibits inflammatory pathways that |
| | produce thromboxane B2, prostaglandin |
| | E2, and leukotriene B4, and suppresses |
| | activators of inflammatory genes such as |
| | IENγ (PMID 26217022) |
| 3) | EO also exerts anti-inflammatory effects |
| | because of its high concentrations of |
| | omega-9 fatty acids, which reduce the |
| | migration of white blood cells |
| | (macrophages) to sites of inflammation. |
| 4) | EO also may exert anti-inflammatory |
| | effects due to synergistic effect of the |
| | different omega fatty acids (PMID |
| | 22369065) |
| 5) | Additionally, EO reduced acute |

```
  inflammation in rats more than other
  oils with a higher content of the above
  fatty acids, thus researchers conclude
  that this effect can't be solely attributed
  to its fat component, and may instead by
  due to the trace elements (naturally
  occurring antioxidants, vitamins and
  other organic compounds) (PMID
  17638122, PMID 22369065)
```

Emu oil may protect against cancer and aging
by its antioxidant components and by its high
ratio of unsaturated to saturated fats, both which
reduce tissue damage by decreasing oxidative
stress on tissues and stem cells (PMID
17638122, PMID 22369065).
Emu oil may permeate, moisturize, and help
heal the skin by the following 6 mechanisms:

| 1) | It destabilizes the alpha-helix structure |
|---|---|
| | of keratin (PMID 28527394) |
| 2) | It interacts with fats in the skin (PMID |
| | 28527394) |
| 3) | It enhances permeation of drugs into the |
| | skin (PMID 28527394) |
| 4) | It promotes growth of new skin cells |
| | (epithelialization, differentiation of |
| | epidermal layers) (PMID 15837639, |
| | PMID 15567771, PMID 27069472) |
| 5) | It promotes restructuring of skin |
| | (fibrogenesis, collagen synthesis) |
| | (PMID 15837639, PMID 15567771, |
| | PMID 27069472) |
| 6) | It shifts white blood cells from the pro- |

```
  inflammatory kind (M1 phenotype) to
  the anti-inflammatory kind (M2
  phenotype) (PMID 28830252)
```

| | Emu oil increases stem cell markers Sox-2, | |
|---|---|---|
| | Nanog, Oct4, Klf4, and c-Myc) which converts | |
| | differentiated skin cells back into a stem cell- | |
| | like state (PMID 28718680). This property | |
| | alone may be helpful for maintaining youthful | |
| | and healthy skin, and in the treatment of cancer - | |
| | in which reprogramming of cancer stem cells | |
| | back into a naïve stem-cell state could mean | |
| | selective apoptosis of cancer stem cells (stem | |
| | cells which have sustained damage and become | |
| | transformed to give rise to tumor causing cells). | |
| | However, emu oil has linoleic acid, an omega-6 | |
| | polyunsaturated fat that improves skin barrier | |
| | function (PMID 7373078) but when consumed | |
| | in high quantities is associated with higher rates | |
| | of obesity and cancer (PMID 23249760) | |
| | Linoleic acid, as well as alpha-linolenic acid, | |
| | both which are found in emu oil, have been | |
| | shown to lighten UV-induced | |
| | hyperpigmentation of the skin (PMID 9749992) | |
| | Palmitic Acid is a saturated fat essential to skin | |
| | health (PMID 24262790), while Stearic acid is | |
| | a saturated fatty acid beneficial to skin | |
| | hydration and healing (PMID 23363400) and | |
| | important in wound healing of burns (PMID | |
| | 10945745) and can increase the “good” | |
| | cholesterol HDL while reducing the “bad” | |
| | cholesterol LDL (PMID 19939984) | |
| | Emu oil has been shown to decrease the joint | |
| | pain induced by aromatase inhibitors taken by | |
| | women with hormone receptor-positive early | |
| | breast cancer (PMID 28691132) | |
| | May synergize with glycyrrhizin (the main | |
| | component of licorice root extract, see below) | |
| | to exert a stronger anti-inflammatory effect by | |
| | modulating inflammatory mediators PPARγ and | |
| | TNFα in an animal model of ulcerative colitis | |
| | (PMID 25560991) | |
| | Taken internally, emu oil reduced disease | |
| | severity in a mouse model of chronic ulcerative | |
| | colitis (PMID 30907169). | |
| | Applied topically when combined with | |
| | curcumin, emu oil was shown to increase skin | |
| | permeation of curcumin in a rodent model of | |
| | rheumatoid arthritis, and reduced | |
| | proinflammatory mediators such as TNFα, IL- | |
| | 1β and IL-6 in arthritic animals (PMID | |
| | 27178879) | |
| | U.S. Pat. No. 5,744,128: Use of emu oil for | |
| | stimulating skin and hair growth. Google | |
| | Books. 2016. | |
| | A review of emu oil composition and benefits, | |
| | with references can be found at | |
| | https://content.selfdecode.com/emu-oil/ | |
| Oleic acid (OA) | Anti-inflammatory, decreases swelling, superior | Increases delivery of |
| (Note: OA is a | delivery of ingredients into skin. | other bioactive |
| component of emu, | Oleic acid (OA) enhances lipophilic penetration | molecules past |
| olive, sunflower, | of skin cells (PMID 21871866, PMID | membranes of cells |
| coconut, macadamia | 2367329), able to facilitate targeted drug | and organelles. |
| nut, jojoba wax, and | delivery across the skin (PMID 2514720) most | Cancer, Diabetes, |
| other oils) | likely because it reduces energy barriers to | Obesity, |
| Range: 1%-97% | membrane fusion (PMID 21871866) and creates | Hypertension, |
| by volume | a temporary disruption to the cell membrane | Peripheral |
| | allowing for drug permeability (PMID | neuropathy, |
| | 2235880). OA has been shown to decrease | hyperlipidemia, |
| | expression of a cholesterol transport-related | wound healing, burns, |
| | protein (NPC1L1) in a cell model (PMID | weight loss, multiple |
| | 21181463). OA has been shown to reduce blood | sclerosis, pruritic |
| | pressure (PMID 10737284), in some cases with | rashes such as |
| | patients no longer needing antihypertensive | eczema, psoriasis, |
| | medications. OA and other monounsaturated | creating a calmer |
| | fatty acid (MUFA) intake have been positively | mood (decreases |
| | associated with a lean body habitus (PMID | anger), and many |
| | 18194589). A diet high in MUFAs such as OA | others. Moisturizer. |
| | in diabetic patients restores sensitivity to | |
| | insulin, increases transport of sugar into cells, | |
| | and changes the composition of vasculature | |
| | thus helping to reverse diabetes (PMID | |
| | 10700478). OA has anti-inflammatory | |
| | properties, but in the setting of a wound has | |
| | pro-inflammatory properties which stimulate a | |
| | stronger wound response with an increase in | |
| | wound healing tissue mass, while decreasing | |
| | the thickness of the necrotic tissue layer in the | |
| | wound (PMID 17918246). OA is crucial for | |
| | nerve repair, myelin production and | |
| | inflammation reduction, promoting growth of | |
| | new nerve cells (PMID 24058332), and | |
| | unexpectedly has been shown to decrease anger | |
| | while increasing mitochondrial function (PMID | |
| | 23446891), decreases intracellular oxidative | |
| | stress (PMID 31802387) thus decreasing | |
| | inflammation and swelling by decreasing | |
| | oxidative stress within cells (PMID 10590211), | |
| | thus decreasing pain as well as decreases risk of | |
| | DNA damage thus decreasing the risk of cancer. | |
| | Additionally, it protects against age-related | |
| | cognitive decline (PMID 10331679) and | |
| | directly inhibits pain and itch receptors (PMID | |
| | 27721373). If taken excessively can eventually | |
| | lead to heart failure (PMID 28391879) though | |
| | this would be impossible to do with a topical | |
| | preparation. | |
| Olive oil | Anti-inflammatory properties of olive oil, | Anti-inflammatory, |
| Range: 1%-97% | rich in oleic acid have been well-documented, | important in |
| by volume | useful in protecting against cancer (PMID | protecting against |
| | 30583613), aging (PMID 26840281), fatty | cancer, aging, fatty |
| | liver disease (PMID 31215262), | liver disease, |
| | neurodegeneration (PMID 29068387, PMID | neurodegeneration, |
| | 32468462) modulates the immune system | cardiovascular |
| | (PMID 29495598), improves | disease. Moisturizer. |
| | metabolism/decreases cardiovascular disease | |
| | (PMID 30487558) among many other | |
| | benefits. | |
| High oleic sunflower | Anti-inflammatory properties resulting in | Anti-inflammatory |
| seed oil | improved cholesterol profile (PMID | properties, useful in |
| Range: 1%-97% | 10545672), decreased atherosclerosis (PMID | improving |
| by volume | 15350986, PMID 9482765) | hyperlipidemia, |
| | | hypercholesterolemia, |
| | | and decreasing |
| | | cardiovascular |
| | | disease. Moisturizer. |
| Coconut oil | Improves hyperlipidemia and fatty acid | Improves |
| (including | profile to reduce cardiovascular risk (PMID | hyperlipidemia, |
| Medium Chain | 26946252, PMID 30725578), improves liver | hypercholesterolemia, |
| Triglycerides derived | antioxidant status (PMID 28816548), has | decreases |
| from coconut oil) | anti-cancer properties, improves fatty liver | cardiovascular |
| Range: 0.0001%-97% | disease, improves insulin resistance, | disease. Helpful in |
| by volume | improves antioxidant status, is anti- | cancer, fatty liver |
| | inflammatory, has anti-microbial properties, | disease, metabolic |
| | and useful as a moisturizer (PMID | syndrome, diabetes, |
| | 33022082). A rich source of non-esterified | anti-aging, diseases of |
| | fatty acids such as myristic acid and lauric | inflammation, and in |
| | acid. | treatment of dry skin |
| | | and preventing |
| | | infections. |
| | | Moisturizer. |
| Fish Oil (EPA + DHA) | Decreases cardiovascular risk, | Improves |
| Range: 0.0001%-97% | atherosclerosis, diabetes, cancer, arthritis, | hyperlipidemia, |
| by volume | osteoporosis, autoimmune and neurological | hypercholesterolemia, |
| | disorders, supporting healthy immune | decreases |
| | function | cardiovascular |
| | | disease. Helpful in |
| | | cancer, fatty liver |
| | | disease, metabolic |
| | | syndrome, diabetes, |
| | | anti-aging, diseases of |
| | | inflammation, and in |
| | | treatment of dry skin |
| | | and preventing |
| | | infections. |
| Flaxseed Oil | Decreases cardiovascular risk, | Improves |
| Range: 0.001%-97% | atherosclerosis, diabetes, cancer, arthritis, | hyperlipidemia, |
| by volume | osteoporosis, autoimmune and neurological | hypercholesterolemia, |
| | disorders, supporting healthy immune | decreases |
| | function (PMID 25190822). Rich in healthful | cardiovascular |
| | oleic and linolenic acid. | disease. Helpful in |
| | | cancer, fatty liver |
| | | disease, metabolic |
| | | syndrome, diabetes, |
| | | anti-aging, diseases of |
| | | inflammation, and in |
| | | treatment of dry skin |
| | | and preventing |
| | | infections. |
| | | Moisturizer. |
| Macadamia Nut Oil | Possesses a very high concentration of | Helpful in treating |
| Range: 0.0001%-97% | healthy mono-unsaturated fatty acids, and | hyperlipidemia, |
| by volume | low in unhealthy omega-6 fatty acid 18:2n-6 | resulting in decreased |
| | and in saturated fatty acids (PMID 8541698) | risk for |
| | which translates into improved serum lipid | atherosclerosis, |
| | profile, leading to decreased risk for | cardiovascular risk, |
| | atherosclerosis, cardiovascular risk, stroke | stroke and cancer risk. |
| | and cancer risk. Relatively rich in arachidonic | Moisturizer. |
| | and oleic acids; and healthy mono- | |
| | unsaturated fatty acids. | |
| Jojoba Wax | Has a fatty acid profile similar to that of | Moisturizer. Carrier |
| Range: 0.001%-97% | human sebum. Useful as a moisturizer. | oil. |
| by volume | | |
| Lecithin | Useful as a surfactant, emulsifier, and source | Surfactant, emulsifier, |
| Range: 0.0001%-70% | of glycerophospholipids found in the cell | and source of |
| by volume | membrane (such as phosphatidylcholine, | glycerophospholipids. |
| | phosphatidylethanolamine, | Moisturizer. |
| | phosphatidylinositol, phosphatidylserine, and | |
| | phosphatidic acid, etc.) | |
| Moroccan chamomile | Moroccan Chamomile essential oil has the | A disease with a |
| essential oil | highest amount of chamazulene of all the | component of |
| (Tanacetum annuum) | blue oils, one of the active compounds which | inflammation such as |
| Range: 0.0001%-20% | possesses potent antioxidant (the ability to | cancer, hay fever, |
| by volume | scavenge free radicals) (PMID 24980540) as | itching, rash, |
| | well as anti-inflammatory, antihistamine, | allergies, asthma, |
| | anti-pruritic and anxiolytic properties (PMID | bronchospasms, |
| | 26304764) and directly improves dry and | eczema, psoriasis, |
| | sensitive skin. It has weak antimicrobial | pain. Anxiolytic |
| | properties (PMID 20922989) and has been | properties help with |
| | shown to possess anti-cancer activity (see | insomnia. Muscle |
| | below). Main constituents include sabinene, | relaxant properties |
| | chamazulene, p-cymene, α-phellandrene, | help with excess |
| | paracymene, β-pinene, β-myrcene, 3,6- | muscle tension. |
| | dihydrochamazulene, β-eudesmol, | |
| | eucalyptol, limonene, linalool, α-terpineol, | |
| | viridiflorol, camphor and parthenolide (which | |
| | induces apoptosis of stem and progenitor | |
| | cells per El Haddar et. al. and found that | |
| | Tanacetum annuum essential oil worked | |
| | almost as well as mitomycin C at a | |
| | concentration of 100). For a full list of | |
| | composite compounds, refer to El Haddar et. | |
| | al. Be aware there is an essential oil of | |
| | Tanacetum vulgare which is toxic, unlike | |
| | Tanacetum annuum. | |
| German chamomile | GC essential oil contains 0.24%-1.9% volatile | Insomnia, hay fever, |
| (GC) essential oil | oil, which contains ~120 secondary metabolites | pain, inflammation, |
| (Matricaria chamomilla or | including anti-inflammatory terpenoids, | muscle spasms, |
| Matricaria recutita) | flavonoids, polyphenols, which exert multiple | menstrual disorders, |
| Range: 0.0001%-20% | effects, e.g. it is a muscle relaxant, CNS | insomnia, ulcers, |
| by volume | relaxant (PMID 21132119 and 28231151); can | wounds, Diabetes, GI |
| | attenuate migraine headaches by inhibiting | disorders, rheumatic |
| | iNOS expression, prohibiting NO release and | pain, hemorrhoids, |
| | synthesis (PMID 25238714), found to be | lupus, multiple |
| | significantly effective in treating pain, nausea, | sclerosis, arthritis, |
| | vomiting, photophobia and phonophobia in | Alzheimer's disease, |
| | human subjects suffering from migraines in a | cancer, gout, skin |
| | randomized, double-blind, placebo-controlled | irritations, bruises, |
| | crossover study (PMID 29808331) | burns, canker sores, |
| | GC compounds naturally penetrate into the skin | neuralgia, sciatica, |
| | (PMID 8073060); and inhibit prostaglandin E2 | rheumatic pain, |
| | release, attenuate COX-2 enzyme activity and | mastitis, diaper rash, |
| | reduces COX-2 mRNA and protein expression, | allergies, |
| | without affecting COX-1 (PMID 19788894) | conjunctivitis, nasal |
| | GC terpenoids and flavonoids attenuate | inflammation, |
| | leukotriene expression (PMID 19788894) thus | anxiety, nightmares, |
| | exerting effects on contraction of bronchial | digestive relaxant, |
| | smooth muscles, stimulation of vascular | flatulence, |
| | permeability, attraction and activation of | indigestion, diarrhea, |
| | leukocytes (PMID 6311078). GC active | anorexia, motion |
| | compounds significantly lower serum IgE and | sickness, nausea and |
| | histamine levels, influencing Th2 cell activation | vomiting, croup, |
| | (PMID 20195063). | colic; as an |
| | Chamomile preparations have been found to | emmenagogue and |
| | facilitate wound healing, increase the rate of | uterine tonic in |
| | wound contraction, increase wound strength, | women; back pain, |
| | hydroxyproline content of scar tissue, and is | bedsores, stomach |
| | superior to corticosteroids for promoting faster | cramps. |
| | wound healing (PMID 18803230) | GC Oil has GRAS |
| | Oral preparations of chamomile have been | status (Generally |
| | shown to attenuate toxic effects of bleomycin | Recognized As safe), |
| | on lung tissues in a rodent model of pulmonary | however has |
| | fibrosis (PMID 31143217). | prescription drug |
| | Chamomile syrup was shown to have a | interaction and may |
| | potentially life-saving immune-building effect, | contraindicate drugs |
| | as it was able to minimize chemotherapy- | metabolized by |
| | induced neutropenia in pediatric leukemia | CYP2D6, CYP1A2, |
| | patients (PMID 31921608) | CYP2C9, and |
| | Chamomile preparations have been found to be | CYP3A4. Dilute |
| | safe and effective for treating colic and diarrhea | before using. |
| | in infants and children ranging from 2 weeks to | |
| | 5.5 years, eliminating colic in 57% of 68 infants, | |
| | and ending diarrhea sooner in 85% of 79 | |
| | children treated (PMID 17400821) | |
| | Apigenin is a central benzodiazepine receptor | |
| | ligand with anxiolytic and slight sedative | |
| | effects (PMID 7617761) which additionally | |
| | exerts an antitumor effect in preclinical models | |
| | of skin, prostate, breast, and ovarian cancer | |
| | (PMID 21132119) | |
| | Quercetin, another antioxidant in GC oil with | |
| | antitumor effects PMID 31880372) the ability | |
| | to decrease prefrontal cortical GABAergic | |
| | transmission and alleviates the hyperactivity | |
| | induced by glutamatergic N-methyl-D-aspartate | |
| | receptor antagonist MK-801 (PMID 30057312) | |
| | and has utility for its mild antipsychotic and | |
| | anti-seizure properties, and neuroprotective | |
| | effects (PMID 31496698). | |
| | Other key active compounds in German and | |
| | Roman Chamomile include α-bisabolol, α- | |
| | bisabolol oxides A&B, and matricin which is | |
| | usually converted to chamazulene and other | |
| | flavonoids which possess anti-inflammatory | |
| | properties. Of note, chamazulene and bisabolol | |
| | are very unstable and are best preserved in an | |
| | alcoholic tincture (PMID 21132119) and it | |
| | preserves its function even when the blue color | |
| | is lost with aging. | |
| Roman chamomile | Anti-inflammatory esters and flavonoids | Decrease hyperactive |
| (RC) essential oil | apigenin, luteolin, hispidulin and eupafolin | smooth muscle tone in |
| (Chamaemelum nobile) | exert antispasmodic effects and instant, | the GI system, |
| Range: 0.0001%-20% | transient, moderate relaxation of smooth | peripheral blood |
| by volume | muscles (PMID 29681854). | vessels for |
| | Apigenin is a central benzodiazepine receptor | hypertension and |
| | ligand with anxiolytic and mild sedative effects | migraine, eczema. |
| | (PMID 7617761), an effect that is reversible | |
| | when a benzodiazepine antagonist flumazenil is | |
| | administered first. | |
| | Topical applications of chamomile have shown | |
| | moderate effectiveness in the treatment of | |
| | atopic eczema, ~60% as effective as 0.25% | |
| | hydrocortisone cream and after 2 weeks of | |
| | treatment showed a slight superiority over 0.5% | |
| | hydrocortisone (PMID6664158) | |
| Orange essential oil | Orange essential oil has preventative properties | Treatment of pain; |
| (Citrus sinensis) | against cancer, and also exhibits antitumor | preventing cancer as |
| Range: 0.0001%-10% | properties. Pleasant smelling. Decreased | well as stimulating |
| by volume | subjective experience of pain in patients with | death of tumor cells. |
| | fractures when inhaled (PMID 29123351) and | Useful in diseases |
| | decreased pain when applied topically in a | where decreasing |
| | double-blind, placebo-controlled study of | inflammation is useful |
| | elderly patients with knee pain (PMID 18534325). | (such as cancer, |
| | The main active component of orange essential | multiple sclerosis) but |
| | oil is D-Limonene (cyclic monoterpene) - | activated T cells are |
| | which has been shown to decrease pain in a | beneficial (such as |
| | murine model of neuropathic | HIV). Useful in |
| | hyperalgesia/fibromyalgia, changing the | diseases where |
| | expression of Fos gene (a family of | diuresis is beneficial, |
| | transcriptions factors important in cancer and | such as in relieving |
| | multiple cellular functions) in dorsal horn | pain caused by |
| | neurons (PMID 28673718). It has also been | localized tissue |
| | shown to be directly cytotoxic to human | swelling or in heart or |
| | neuroblastoma cells (PMID 23707744). D- | lung failure where the |
| | limonene as well as its metabolites limonene-1- | body is fluid |
| | 2-diol and perillic acid has been shown to | overloaded. Useful in |
| | modulate/stimulate T lymphocyte activity and | treating the anxiety |
| | viability (PMID 23059811) by inhibiting | that arises from being |
| | production of pro-inflammatory IFN-γ, IL-2, | in pain. It is useful as |
| | TNF-α, IL-4 and IL-13 by CD3(+) CD4(+) T | an antimicrobial (and |
| | cells; as well IFN-γ, IL-2, and TNF-α, by | thus natural |
| | CD3(+) CD8(+) T cells. D-limonene and | preservative). |
| | metabolites stimulates activated T lymphocytes | |
| | to upregulate expression of CD25, CD69 and | |
| | CD40L on their cell surface, rendering them | |
| | more capable. D-limonene has a mild diuretic | |
| | effect that is dose-dependent but only has effect | |
| | when animals were fluid overloaded, not when | |
| | they were in a euvolemic state (PMID | |
| | 20606379), useful in relief of localized | |
| | swelling. D-limonene is the same as the R(+)- | |
| | isomer. R(+)-Limonene or D-limonene also has | |
| | anxiolytic properties (PMID 22995322) which | |
| | is NOT reversed by flumazenil, indicating a | |
| | separate pathway outside of benzodiazepine | |
| | receptors for treating anxiety. D-limonene and | |
| | other metabolites by yeast Yarrowia (PMID | |
| | 24688495), as well as by Mortierella | |
| | minutissima for maximum biotransformation | |
| | (PMID 15717122). Biotransformation of | |
| | limonene can occur by bacteria, fungi, yeasts | |
| | and plants (PMID 12743755) taking one useful | |
| | compound and creating multiple useful ones as | |
| | a result. D-limonene has antimicrobial | |
| | properties which can be enhanced by nano- | |
| | emulsification and when dissolved in a | |
| | penetrating carrier such as DMSO (PMID | |
| | 30042591) thus it follows that nano- | |
| | emulsification while dissolved in emu oil would | |
| | also have similar enhanced antimicrobial | |
| | effects, potentially precluding need for | |
| | additional preservatives. | |
| Frankincense essential | Adaptogen - alleviating sleep debt, improving | Adaptogen - |
| oil | response to stress while limiting negative | alleviating sleep debt, |
| (Boswellia serrata, | physiological consequences of prolonged stress. | improving response to |
| Boswellia carteri, | Pain (especially arthritic pain), fatigue, wound | stress while limiting |
| Boswellia sacra, | healing, diseases involving inflammation | negative physiological |
| Boswellia frereana, | including cancer, ulcers; antioxidant properties | consequences of |
| Boswellia rivae, | useful for prevention of cancer and diminishing | prolonged stress. Pain |
| Boswellia neglecta, | aging; anti-ulcer and anti-microbial properties. | (especially arthritic |
| Boswellia papyrifera, | Increases lipid fluidity of cells to enhance | pain), fatigue, wound |
| Boswellia dalzielii) | absorption of co-administered bioactive | healing, diseases |
| Range: 0.0001%-30% | products. Useful in the prevention and | involving |
| by volume | treatment of infections against bacteria. Useful | inflammation |
| | in protecting against leishmania infestation. | including cancer, |
| | Traditional uses include for arthritis, rheumatic | ulcers; antioxidant |
| | arthritis, diarrhea, dysentery ringworm, boils, | properties useful for |
| | fevers, skin and blood diseases, cardiovascular | prevention of cancer |
| | diseases, mouth sores, bronchitis, asthma, | and diminishing |
| | cough, hair loss, jaundice, hemorrhoids, | aging; anti-ulcer and |
| | syphilitic diseases, irregular menses, edema. | anti-microbial |
| | Helps normalize blood lipids and protects the | properties. Increases |
| | liver. (PMID 22457547). | lipid fluidity of cells |
| | | to enhance absorption |
| | | of co-administered |
| | | bioactive products. |
| | | Useful in the |
| | | prevention and |
| | | treatment of |
| | | infections against |
| | | bacteria. Useful in |
| | | protecting against |
| | | leishmania |
| | | infestation. |
| | | Traditional uses |
| | | include for arthritis, |
| | | rheumatic arthritis, |
| | | diarrhea, dysentery |
| | | ringworm, boils, |
| | | fevers, skin and blood |
| | | diseases, |
| | | cardiovascular |
| | | diseases, mouth sores, |
| | | bronchitis, asthma, |
| | | cough, hair loss, |
| | | jaundice, |
| | | hemorrhoids, |
| | | syphilitic diseases, |
| | | irregular menses, |
| | | edema. Helps |
| | | normalize blood lipids |
| | | and protects the liver. |
| Myrrh essential oil | When combined with frankincense, myrrh | Pain, and other |
| (Commiphora myrrha, | alleviated neuropathic pain in mice by | diseases with an |
| Commiphora erythraea, | modulating TRPV1 (PMID 28740739) and also | inflammatory |
| Commiphora incisa) | work synergistically with frankincense to treat | component, including |
| Range: 0.0001%-30% | inflammation, cancer, pain, infection, blood | cancer. Has |
| by volume | activation (PMID 31450584), and additionally | antimicrobial |
| | synergizes to penetrate the skin by changing the | properties. Helpful for |
| | conformation of lipids and keratin in the skin, | acne, antiseptic, |
| | increases lipid fluidity of skin cells to allow | athlete's foot, |
| | deeper penetration and also movement of lipid | bacterial infections, |
| | rafts (PMID 31450584) as well as improving | bedsores, boils, |
| | blood circulation (PMID 28959837). Helpful in | cracked skin, cuts, |
| | reducing blood pressure (PMID 9292417), | dermatitis, eczema, |
| | reducing inflammation, nervous disorders, | fungal infections |
| | hyperlipidemia, ischemia, skin disorders, cancer | (athlete's foot, |
| | and relieving chest pain (PMID 26656226, | ringworm), healing |
| | PMID 22388973). Helpful in reducing | agent, inflammation, |
| | neuropathic pain (PMID 24621062). Antibiotic | scars, sores, ulcers, |
| | properties (PMID 31450584). Myrrh possesses | weeping wounds, and |
| | multiple potent anti-cancer properties which are | wrinkles. Helpful in |
| | enhanced and synergized with addition of | reducing blood |
| | Frankincense (PMID 31450584). Myrrh | pressure, |
| | induces apoptosis and inhibits the proliferation | hyperlipidemia, |
| | and migration of gastric cancer cells by down- | decreasing |
| | regulating cyclooxygenase-2 expression (PMID | cardiovascular events. |
| | 32364228). Myrrh has anti-parasitic properties | |
| | (PMID 32121352). Myrrh has an inhibitory | |
| | effect on ICAM-1 adhesion molecule, which is | |
| | one mechanism by which it has anti- | |
| | inflammatory effects (PMID 33374825). | |
| Cinnamon essential oil | In Traditional Chinese Medicine, cinnamon is | Treats pain, increases |
| (Cinnamonum verum) | used to increase circulation to improve delivery | circulation, treats |
| Range: 0.0001%-6% | of other medicines to the rest of the body. | diabetes, has |
| by volume | Additionally, it possesses diuretic effects | anticancer properties, |
| | (PMID 20606379), antioxidant and | helpful in any disease |
| | antiproliferative effects (PMID 31929818), | process involving |
| | antimicrobial properties (PMID 31926578), | inflammation. Slows |
| | anti-inflammatory and anti-diabetic properties | aging due to |
| | (PMID 31901246), decreases | antioxidant properties. |
| | visceral/abdominal fat and regulates lipid | Insect repellent. |
| | metabolism (PMID 31869758), repels insects | |
| | (PMID 31869758), improves blood circulation | |
| | and transdermal penetration of other medicines | |
| | admixed with it (PMID 26457698) and treats | |
| | dysmenorrhea (PMID 26023601) | |
| Calamus essential oil | Wound healing: decreases epithelialization | Wound healing, |
| (Acorus calamus or | time, increases tensile strength of scar tissue, | cancer, antimicrobial |
| sweet flag) | increase in collagen, hexosamine and | properties, insect |
| Range: 0.0001%-6% | hyaluronic acid in full thickness cutaneous | repellent. |
| by volume | wounds in rats as compared to untreated | |
| | animals (PMID 24991107) anti-cancer, anti- | |
| | angiogenic properties (PMID 28348970) | |
| | antimicrobial and antiparasitic properties | |
| | (PMID 27562598), and insect repellent | |
| | properties (PMID 26600710) | |
| Cassia essential oil | Anti-inflammatory by regulating | Anti-cancer, |
| (Cinnamonum cassia) | succinate/SUCNR1 metabolic signaling | stimulates apoptosis |
| Range: 0.0001%-6% | pathway, improving rheumatoid arthritis (PMID | in lung cancer cells, |
| by volume | 31949465) Antimicrobial properties (PMID | treats diseases with an |
| | 31631505) Promotes lung cancer cell death by | inflammatory |
| | inhibiting pyruvate dehydrogenase kinase | component. |
| | activity, (antiglycolytic pathway) (PMID | |
| | 30392804). Cassia Oil also possesses | |
| | analgesic, anti-diabetic, anti-obesity properties; | |
| | is cardioprotective, cytoprotective, | |
| | neuroprotective; has immunoregulatory | |
| | properties, anti-tyrosinase activity (useful in | |
| | cancer and inflammation) - All from (PMID | |
| | 31557828) | |
| Vanilla Oleoresin | Vanilla is useful in treating anxiety by lowering | Useful in treating |
| essential oil or CO2 | serum catecholamine levels while leaving | anxiety, sleep, and |
| extraction | serotonin (feel good hormone) intact; it is | nocturia |
| (Vanilla planifolia) | useful in treating sleep disorders and nocturia | |
| Range: 0.0001%-6% | (PMID 32871621). | |
| by volume | | |
| Jasmine essential oil | Anxiolytic and anti-epileptic effect that is | Anxiety, mood |
| (Jasmine grandiflorum) | comparable to diazepam at 2 mg/kg (PMID | disorders, insomnia, |
| Range: 0.0001%-10% | 30915314, PMID 28262620), sedative effects | convulsive disorders, |
| by volume | useful for treating insomnia, anxiety; | epilepsy, alcohol |
| | significantly decreased heart rate, and an | withdrawal, wound |
| | increase in high-frequency activity in autonomic | healing, ulcers, |
| | nerves resulting in improved mood in human | muscle spasms, |
| | subjects (PMID 15976995). Improves wound | antioxidant properties, |
| | closure rate, healing of open wounds, improved | improves digestion. |
| | skin thickness over a wound, and decrease in | |
| | inflammation within a wound (PMID | |
| | 31916035). Useful in treating pain, digestive | |
| | issues, and ulcers due to its ability to alleviate | |
| | muscle spasms, antimicrobial, antiulcer, and | |
| | antioxidant properties (PMID 25847780) | |
| Lemongrass essential | Relief from pain, depression, fever, abnormal | Anxiety, depression, |
| oil and water extract | muscle tension & spasms, insomnia. Topical | insomnia, convulsive |
| (Cymbopogon citratus and | antimicrobial. Antioxidant effect protects | disorders, increased |
| Cymbopogon flexuosus) | against cancer (PMID 29854620, 27894219, | muscle tension. Has |
| Range: 0.0001%-80% | 22082069, 21089157) and decreases liver stress | antimicrobial and |
| by volume | by increasing liver antioxidant activity (PMID | antioxidant activity |
| | 29389585). Water extracts of kaffir lime | useful in preventing |
| | leaf:galangal:lemongrass in a 1:2:1 ratio have | cancer. Helpful in |
| | been shown to upregulate stem cell markers in | improving |
| | hepatocytes, to stimulate resolution of | metabolism, with |
| | steatohepatitis (fatty liver, from overindulgence | weight loss, fat |
| | of lipids and starches which leads to | metabolism, |
| | hypercholesterolemia), while maintaining | hyperlipidemia. |
| | mitochondrial function and architecture, and | |
| | even correcting blood cholesterol, LDL, HDL | |
| | and TG levels similar to simvastatin (PMID | |
| | 31978768). | |
| Galangal root essential | Anti-inflammatory, anti-microbial, antioxidant, | Helpful in diseases |
| oil and water extracts | anti-cancer, anti-proliferative properties, helpful | which have an |
| (Alpinia galanga, and | in digestion, inhibits nitric oxide production | inflammatory |
| Kaempferia galanga) | leading which may lead to smooth muscle | component, in |
| Range: 0.0001%-80% | dilation or constriction depending on tissue site; | preventing infection, |
| by volume | useful in treating pain, especially headaches. | in reducing |
| | (PMID 28503054). Water extracts of kaffir lime | antioxidant burden |
| | leaf:galangal:lemongrass in a 1:2:1 ratio have | and thus helpful in |
| | been shown to upregulate stem cell markers in | anti-aging products, |
| | hepatocytes, to stimulate resolution of | helpful in treating |
| | steatohepatitis (fatty liver, from overindulgence | pain and digestive |
| | of lipids and starches which leads to | issues. Helpful in |
| | hypercholesterolemia), while maintaining | improving |
| | mitochondrial function and architecture, and | metabolism, with |
| | even correcting blood cholesterol, LDL, HDL | weight loss, fat |
| | and TG levels similar to simvastatin (PMID | metabolism, |
| | 31978768). Kaempferia galanga possesses anti- | hyperlipidemia, in |
| | microbial, antioxidant, amebicidal, analgesic, | treatment of cancer. |
| | anti-inflammatory, anti-tuberculosis, anti- | |
| | dengue, anti-nociceptive, anti-angiogenic, | |
| | anticancer, hyperlipidemic, hypopigmentary, | |
| | osteolysis, larvicidal, insecticidal and mosquito | |
| | repellent, nematocidal, sedative, sniffing, | |
| | vasorelaxant and wound healing (PMID | |
| | 32061673). Alpinia galanga improves mental | |
| | alertness and sustained attention (PMID | |
| | 289101196), has anti-cancer properties (PMID | |
| | 31983172, PMID 33445186), possesses | |
| | emmenagogue, aphrodisiac, abortifacient, | |
| | carminative, antipyretic, and anti-inflammatory | |
| | qualities, and is useful for treating multiple | |
| | diseases including bronchitis, heart disease, | |
| | chronic enteritis, renal calculus, diabetes, | |
| | rheumatism, and kidney disorders (PMID | |
| | 22015185). | |
| Kaffir lime leaf or rind | Helpful in improving metabolism, with weight | Helpful in improving |
| essential oil and water | loss, fat metabolism, hyperlipidemia. Water | metabolism, with |
| extracts | extracts of kaffir lime leaf:galangal:lemongrass | weight loss, fat |
| (Citrus hystrix) | in a 1:2:1 ratio have been shown to upregulate | metabolism, |
| Range: 0.0001%-80% | stem cell markers in hepatocytes, to stimulate | hyperlipidemia. |
| by volume | resolution of steatohepatitis (fatty liver, from | |
| | overindulgence of lipids and starches which | |
| | leads to hypercholesterolemia), while | |
| | maintaining mitochondrial function and | |
| | architecture, and even correcting blood | |
| | cholesterol, LDL, HDL and TG levels similar to | |
| | simvastatin (PMID 31978768). | |
| Xiang mao essential oil | Also known as West Indian Lemongrass, which | Helpful in diseases |
| and water extracts | possesses anti-inflammatory, neuroprotective | which have an |
| (Cymbopogon citratus) | (PMID 32736056), antibacterial, antiviral, anti- | inflammatory |
| Range: 0.001%-80% | trypanosomal, antifungal (PMID 31470085), | component. Helpful in |
| by volume | anti-proliferative/anti-cancer properties (PMID | treating and |
| | 29501481) useful for treating muscle soreness, | preventing infections. |
| | infections, cancer (PMID 20047890), killing | Helpful in |
| | mites (PMID 32251453) and preventing | neurodegenerative |
| | infections (PMID 25242268) | diseases. Helpful in |
| | | killing cancer |
| Clove essential oil | Anti-inflammatory, antimicrobial, antifungal, | Helpful in |
| (Eugenia caryophyllata, | antiviral, antibacterial, antioxidant, anti-cancer, | inflammation, |
| Syzygium aromaticum) | analgesic, facilitates wound healing and dermal | preventing or treating |
| Range: 0.001%-30% | fibroblast remodeling, repellent to insects, | infection, anti-aging; |
| by volume | anesthetic properties (PMID 17380552, PMID | improves wound |
| | 28407719) by inhibiting tissue remodelling | healing, useful in |
| | protein molecules (collagen-I, collagen-III, M- | inhibiting cancer |
| | CSF, tissue inhibitor of metalloproteinase 2 | pathways, modulates |
| | (TIMP-2); downregulates signaling pathways | immune system and |
| | important for inflammation, tissue remodeling, | tissue remodeling. |
| | cancer signaling (PMID 28407719). | |
| Yuzu essential oil | Anti-carcinogenic (PMID 15884872), | Cancer, diseases |
| (Citrus junos) | neutralizes carcinogenic compounds (PMID | which involve |
| Range: 0.001%-30% | 20492298), anti-inflammatory (PMID | inflammation, |
| by volume | 25453522), anti-anxiety (PMID 27103924), | anxiety, mood |
| | helpful in treating mood disturbance, PMS, | disturbance, reduction |
| | anger, hostility, fatigue (PMID 27103924, | of tension, anger, |
| | PMID 28481623), anti-cancer (PMID | fatigue, neutralizing |
| | 29976894), hypocholesterolemic, anti-diabetic, | effect of carcinogens, |
| | anti-obesity, platelet aggregation inhibitor, heart | helpful in normalizing |
| | failure treatment (PMID 29976894) | hypercholesterolemia |
| | | and hyperlipidemia, |
| | | helpful in treating |
| | | diabetes, metabolic |
| | | syndrome, obesity, |
| | | heart failure. |
| | | Functions in |
| | | inhibiting platelet |
| | | aggregation (as a |
| | | blood thinner). |
| Rosemary essential oil | Possesses anti-inflammatory (PMID 30328397, | Helpful in the |
| (Rosmarinus officinalis) | PMID 28862678, PMID 30364169), antioxidant | treatment of any |
| Range: 0.001%-30% | (PMID 25002023), neuroprotective | diseases with an |
| by volume | properties/enhances cognitive function (PMID | inflammatory |
| | 30651162), hepatoprotective properties by | component, including |
| | enhancing liver detoxification, especially in its | cancer, diabetes, |
| | ability to metabolize fat and prevent liver | metabolic syndrome, |
| | steatosis (PMID 25002023), anti-depressant | obesity, non-alcoholic |
| | properties (PMID 30364169), Anti- | fatty liver disease, |
| | hyperglycemic, helpful in treating diabetes, | neurodegeneration, |
| | metabolic syndrome, and obesity by activating | eczema, colitis, |
| | PPAR-gamma which lowers blood glucose | depression, pain, hair |
| | levels, increasing serum insulin; also inhibits | loss, and wound |
| | alpha-glucosidase to reduce sugar absorption | healing. Prevents clot |
| | (PMID 28862678, PMID 30651162), analgesic | formation and |
| | (PMID 25635991), anti-fungal properties | prevents high blood |
| | (PMID 32270657), increased hair growth in | pressure, |
| | patients with androgenetic alopecia (PMID | cardiovascular events |
| | 25842469) and wound healing properties | including stroke, heart |
| | (PMID 29343956, PMID 31525200). Improves | attack. Helpful in |
| | vascular health by preventing clot and thrombus | prevention and |
| | formation, inhibiting platelet reactivity, | treatment of |
| | inhibiting angiotensin I-converting enzyme | infections against |
| | (ACE), which leads to less production of | bacteria, fungi, and |
| | chemical which causes arterial constriction, | viruses. |
| | thus enhancing vasodilation and lower blood | |
| | pressure (PMID 30651162). Anti-cancer | |
| | properties by protecting human cell lines | |
| | against known carcinogens, and by reducing | |
| | expression of pro-inflammatory genes (PMID | |
| | 30651162). Multiple phytocompounds in | |
| | rosemary extract possess antibacterial, | |
| | antioxidant properties, stimulate organized cell | |
| | death of cancer cells, inhibit cancer metastases, | |
| | limits tumor growth, protects liver and kidneys | |
| | from chemical damage, protects against colitis, | |
| | antiviral, protects nervous system, protects | |
| | against atherosclerosis, possesses anxiolytic | |
| | properties, stimulates bone production while | |
| | blocking its breakdown, induces insulin | |
| | sensitivity, possesses antifungal, antidiabetic, | |
| | and immunomodulatory properties, protects | |
| | against peptic ulcers, protection against stroke, | |
| | anti-atopic dermatitis (PMID 30621719). Also | |
| | prevents cardiac remodeling after myocardial | |
| | infarction (PMID 30621719). | |
| Eucalyptus essential oil | Improves wound healing (PMID 29343956), | Wound healing. |
| (extracts of leaf, bark, | possess antimicrobial, antiseptic, antioxidant, | Useful in prevention |
| etc.) | chemotherapeutic, acaricidal, nematicidal | and treatment of |
| (Eucalyptus globulus, | properties, in addition to being useful in the | infections from |
| Eucalyptus radiata, | treatment of respiratory and gastrointestinal | bacteria, viruses and |
| Eucalyptus dives, | disorders, repelling insects (PMID 28758221). | fungi, and also from |
| Eucalyptus smithii, | Eucalyptus essential oil has been found to be | parasitic infestations. |
| Eucalyptus odorata, | protective against a number of bacteria, viruses | Useful in treating |
| Eucalyptus bicostata, | and fungi (PMID 17972131, PMID 22742534, | respiratory and GI |
| Eucalyptus cinerea, | PMID 2274534, PMID 32659315, PMID | disease such as |
| Eucalyptus maidenii, | 28127308) including S. aureus, H. influenzae, | gastroenteritis, colitis, |
| Eucalyptus sideroxylon, | S. agalactiae, S. pyogenes, S.pneumoniae, and | asthma, COPD. |
| Eucalyptus astringens, | Candida albicans, Scopulariopsis brevicaulis, | Useful in repelling |
| Eucalyptus lahmannii, | Trichophyton rubrum, Trichophyton soudanense, | insects. Useful in |
| Eucalyptus leucoxylon, | Microsporum canis. It is also | stimulating the |
| etc.) | effective against mycobacterium tuberculosis | immune system to |
| Range: 0.001%-40% | and methicillin-resistant staphylococcus aureus, | clear an infection |
| by volume | viruses, and fungi (PMID 20359267). Inhalation | (such as stimulating |
| | by vapor or orally provides benefit for multiple | macrophages to clear |
| | respiratory diseases, including bronchitis, | cellular debris). |
| | asthma, chronic obstructive pulmonary disease | |
| | (COPD), increases the frequency with which | |
| | respiratory tract cilium beat in order to move | |
| | more secretions, possesses antioxidant | |
| | properties to counteract reactive oxygen | |
| | species, inhibition of arachidonic acid | |
| | metabolic LTB4 and prostaglandin E2 (PGE2) | |
| | with subsequent improvement in lung function | |
| | in asthma patients, and also exerts | |
| | immunomodulatory properties (stimulating | |
| | phagocytosis by macrophages) without | |
| | producing pro-inflammatory effects; the effects | |
| | of eucalyptus oil was blocked by microtubule | |
| | blocker, meaning that eucalyptus has its effects | |
| | on the microtubules (PMID 20359267). | |
| Lemon essential oil | Stress relief, cytotoxic (against cancer), | As listed on the left. |
| (Citrus limon, Citrus | chemoprotective, anti-obesity, antioxidant, | |
| limon spatafora) | neuroprotective, anti-anxiety, enhances | |
| Range: 0.001%-30% | creativity and mood, analgesic, relief from | |
| by volume | nausea and vomiting during pregnancy, anti- | |
| | spasmodic, improves attention, concentration, | |
| | cognitive performance, enhances mood and | |
| | memory; enhances penetration of skin, | |
| | antibacterial, antifungal, insect repellant | |
| | properties, miticidal (PMID 29976894) | |
| Ravintsara essential oil | Alleviates allergic skin inflammatory responses | Useful in reducing |
| (includes roots, bark | in vitro and in vivo (PMID 31341557). | contact allergy skin |
| and leaves) | Antimicrobial (antibacterial, antiviral, | reactions. Useful in |
| (Cinnamomum camphora) | antifungal, larvicidal properties) (PMID | preventing and |
| Range: 0.001%-30% | 31562551, PMID 31640286, PMID 32035880, | treating infections |
| by volume | 33304322, PMID 31428342). Anti- | from bacteria, |
| | inflammatory, and cell membrane stabilizing | coccidiomycoses, |
| | properties (PMID 33141054) by inhibiting heat- | viruses, fungi as well |
| | induced hemolysis as well as hypotonic solution- | as repelling insects |
| | induced hemolysis in vitro, decreases | and killing larvae. |
| | swelling/edema, decreases expression of | Useful in treating |
| | inflammatory markers (IL1-beta, TNF-alpha). | diseases with an |
| | Bronchodilation, anti-tussive, insecticidal, | inflammatory |
| | antimicrobial, antiviral, antibacterial, | component. Helps to |
| | anticoccidial, anti-nociceptive, anticancer | stabilize cell |
| | properties as well as enhances penetration of | membrane, thus may |
| | skin (PMID 23666009, PMID 30582219). | be useful in diseases |
| | Insecticidal and insect repellent properties | with an abnormal cell |
| | (PMID 27827929, PMID 27043503, PMID | membrane, such as |
| | 16230008). Antifungal properties (PMID | spherocytosis. |
| | 18322727). | Improves pulmonary |
| | | congestion, cough, |
| | | pain, and inhibits |
| | | cancer. Improves |
| | | permeability of the |
| | | skin to other |
| | | substances. |
| Ravensara essential oil | Antimicrobial, antifungal properties (PMID | Antimicrobial, |
| (bark, leaves, stems) | 2633710). Improves symptoms of nasal | Antifungal properties. |
| (Ravensara anisate, | congestion and rhinoconjunctivitis when | Improves symptoms |
| Ravensara aromatica, | inhaled (PMID 27034695). | of nasal congestion |
| Ravensara crassifolia, | | and |
| etc.) | | rhinoconjunctivitis |
| Range: 0.001%-30% | | when inhaled. |
| by volume | | |
| Cinnamon Leaf | Anti-microbial and anti-parasitic activity, | Useful in prevention |
| essential oil | lowers blood glucose, blood pressure, and | and treatment of |
| (Cinnamomum zeylanicum) | serum cholesterol, anti-oxidant and free-radical | infections against |
| Range: 0.001%-30% | scavenging properties, inhibition of tau | bacteria, viruses, or |
| by volume | aggregation and filament formation (hallmarks | fungi. Useful in |
| | of Alzheimer's disease), inhibition of | treating diabetes, high |
| | osteoclastogenesis (osteoclasts are responsible | blood pressure, |
| | for breaking down bone, leading to bone | elevated blood |
| | weakness and osteoporosis), protective against | cholesterol, metabolic |
| | gastric ulcers by reducing acid secretion, | syndrome, obesity, |
| | reduces pain by decreasing inflammation, | polycystic ovarian |
| | wound healing properties, hepatoprotective | syndrome (PCOS), |
| | properties with minimal toxic and adverse | helpful in anti-aging, |
| | effects (PMID 24148965). Potent effects in | protecting against |
| | treating diabetes, metabolic syndrome, PCOS | early dementia by |
| | (PMID 28962661, PMID 22671971, PMID | inhibiting formation |
| | 31741280, PMID 27618575, PMID 30144878). | of the plaques which |
| | Anti-cancer effects by facilitating apoptosis | cause this disease, is |
| | (PMID 31195161). Decreases inflammation and | protective against |
| | has anti-proliferative properties on skin cells by | osteopenia and |
| | down regulating inflammatory cytokines | osteopenia, helpful in |
| | VCAM-1, ICAM-1, MCP-1, interferon gamma | preventing gastric |
| | induced protein 10, interferon-inducible T cell | ulcers by reducing |
| | alpha chemoattractant, monokine induced by | acid secretion, |
| | gamma interferon; as well as tissue remodeling | decreases pain by |
| | molecules such as EGFR, MMP1, plasminogen | decreasing |
| | activator inhibitor 1; and macrophage colony | inflammation, useful |
| | stimulating factor (an immunomodulatory | in facilitating wound |
| | protein molecule); in addition to modulating | healing, and protects |
| | multiple signaling pathways important in | the liver from |
| | inflammation, tissue remodeling, and cancer | chemical damage. |
| | biology (PMID 28444928). Along with Litsea | Anti-cancer |
| | cubeba, has cytotoxic activity against the | properties. Useful in |
| | following cancer cell lines: breast | killing cancer cells |
| | adenocarcinoma MCF7, T47D, MDA-MB- | (breast, chronic |
| | 231), chronic myelogenous erythroleukemia | myelogenous |
| | (K562) and neuroblastoma cell lines (SH- | erythroleukemia, |
| | S75Y) (PMID 31713998). | neuroblastoma). |
| Thyme essential oil | Antimicrobial properties (antifungal, | Useful in prevention |
| (Thymus vulgaris) | antibacterial, antiviral) (PMID 25870697, | and treatment of |
| Range: 0.001%-30% | PMID 32008964, PMID 27994215, PMID | infections against |
| by volume | 30025373). Anticancer properties in vitro and | bacteria, viruses, or |
| | in vivo against breast cancer (PMID 30970626) | fungi. Prevention and |
| | and cancer in general (PMID 29785774) due to | treatment of cancer. |
| | its antioxidant, anti-inflammatory properties. | Treatment of |
| | Also has antispasmodic properties, can enhance | increased muscle |
| | healthy growth as well as has | tension or spasms. |
| | immunomodulatory properties (PMID | Supports immune |
| | 29785774, PMID 29744941). | function. |
| Rosalina essential oil | Hepatoprotective against chemical damage by | Useful when taken |
| (Melaleuca ericifolia) | reducing oxidative stress, inflammation, | internally in liver and |
| Range: 0.001%-30% | necrosis, hemorrhage; Rosalina downregulates | breast cancer, |
| by volume | COX-2 and caspase-3 hepatic expression and | especially in the case |
| | thus is protective against liver cancer (PMID | of liver metastases. |
| | 30506741). Component triterpenes | Useful in prevention |
| | demonstrate antiproliferative activity against a | and treatment of |
| | malignant breast cancer cell line (PMID | infections against |
| | 18826277). Antimicrobial properties - against | bacteria, viruses, or |
| | viruses, bacteria and fungi; has highest | fungi, especially black |
| | inhibitory effects against Bacillus subtilis and | mold. |
| | aspergillus niger (black mold) (PMID | |
| | 14750197, PMID 17449084). | |
| Palmarosa essential oil | Antimicrobial properties (antiviral, antibiotic, | Useful in preventing |
| (including aqueous, | antifungal); treatment of pain and skin | and treating |
| dichloromethane and | conditions; immunomodulatory properties (both | infections, pain, in |
| methanolic extraction) | pro- and anti-inflammatory) on monocytes via | treating diabetes, |
| (Cymbopogon martinii) | increased TNF-alpha and reduced IL-10 (PMID | metabolic syndrome, |
| Range: 0.001%-30% | 24934659). Anti-diabetic properties by | obesity, stress- |
| by volume | inhibition of GLUT2 transporter by geraniol | induced central |
| | from Cymbopogon martinii; and inhibited | adipose deposition, |
| | stress-induced (adrenaline challenge test) | atherosclerosis, and |
| | release of glucose from the liver; also doubled | for reducing |
| | kidney glycogen content, doubling renal glucose | cardiovascular events. |
| | output compared to diabetic control, and | Useful for improving |
| | prevented post-prandial spikes, improving the | renal function, |
| | lipid profile, HbA1c levels, and renal | improving |
| | parameters; with prolonged use over 10 days, | physiologic response |
| | this prevented overexpression of GLUT2, | to stress, especially in |
| | resulting in improved blood sugar control | improving glucose |
| | (PMID 31737917). Antihelmintic activity | regulation. Useful for |
| | (PMID 21820807). Useful for killing 3 main | filling acne bacterium |
| | strains of acne bacteria (Type IA, IB, II) by | while decreasing |
| | changing structure of the cell wall resulting in | inflammation. Potent |
| | cell lysis and changes in bacterial protein | protection against |
| | production when used in range of MIC 0.7 to | neurologic sequelae in |
| | 1.6 mg/ml and has anti-inflammatory properties | animal model stroke |
| | via multiple mechanisms and does not influence | when taken orally for |
| | c. acne population on skin (PMID 30277563). | 10 days. |
| | Neuroprotective in an animal model of stroke | |
| | (cerebral ischemia/reperfusion-induced | |
| | oxidative stress in rats) when taken 10 d prior at | |
| | 50 mg/kg or 100 mg/kg - markedly reversing | |
| | changes and restoring normal levels of lipid | |
| | peroxidation, superoxide dismutase, catalase, | |
| | total thiols and glutathione, helpful in neuralgia, | |
| | epilepsy (PMID 22855942). Bronchodilator, | |
| | vasodilator, and spasmolytic activities (PMID | |
| | 25554990). | |
| Niaouli essential oil | Inhibition of alpha-melanocyte stimulating | Useful as a safe, non- |
| (Melaleuca quinquenervia) | hormone (alpha-MSH)-induced melanin | toxic skin-brightening |
| Range: 0.001%-30% | production and oxidative stress in B15 | and whitening agent, |
| by volume | melanoma cells (PMID 28899502). | as it can decrease |
| | Mechanisms include reduced melanin content, | hyperpigmentation. |
| | reduced malondialdehyde, reduced tyrosinase | Antifungal and |
| | activity, restored antioxidant levels | antinematode |
| | (glutathione, glutathione peroxidase, superoxide | properties, useful in |
| | dismutase, catalase), reduced DNA damage | prevention and |
| | (PMID 28899502). Mosquito repellant (PMID | treatment of infection |
| | 27794392, PMID 16642384). Larvicidal | and infestation. |
| | properties (PMID 21485381). Antifungal, anti- | Useful in treating |
| | nematode properties (PMID 19259503). | diabetes due to ability |
| | Reduces blood glucose, useful in treating | to reduce serum blood |
| | diabetes. | glucose in a diabetic |
| | | model. |
| Laurel leaf, fruit, twig, | Antibacterial, antifungal properties (effective | Useful in prevention |
| root essential oil | against staphylococcus aureus, and partially | and treatment of |
| (Laurus nobilis) | effective against pseudomonas aeruginosa | infections. Useful in |
| Range: 0.001%-30% | ATCC 9027, Escherichia coli ATCC 8739) | killing insect larvae. |
| by volume | (PMID 30813368). Larvicidal properties (PMID | |
| | 30445842) | |
| Litsea leaf, bark, root, | Antimicrobial properties (bacteria, virus, fungi) | Useful in prevention |
| fruit essential oil | including staph aureus but not against Gram- | and treatment of |
| (Litsea cubeba) | negative bacteria (PMID 26411035, PMID | infections. Useful in |
| Range: 0.001%-30% | 29266378). Decreases production of | treatment of contact |
| by volume | inflammatory chemokines TNF-alpha and | hypersensitivity, |
| | cytokine IL-12 in LPS-stimulated dendritic | inflammatory |
| | cells, useful in treating contact hypersensitivity, | diseases, autoimmune |
| | inflammatory diseases, and autoimmune | diseases (multiple |
| | diseases (PMID 27529236). Along with | sclerosis, lupus). |
| | Cinnamonum zeylanicum, has cytotoxic activity | Useful in killing |
| | against the following cancer cell lines: breast | cancer cells (breast, |
| | adenocarcinoma MCF7, T47D, MDA-MB- | chronic myelogenous |
| | 231), chronic myelogenous erythroleukemia | erythroleukemia, |
| | (K562) and neuroblastoma cell lines (SH- | neuroblastoma). |
| | S75Y) (PMID 31713998). | |
| Lime essential oil | Anti-obesity, spasmolytic agent, selective | Obesity, muscle |
| (Citrus aurantifolia) | acetylcholinesterase and buytrylcholinesterase | tension, improved |
| Range: 0.001%-30% | inhibitor, antioxidant, anti-inflammatory, | acetylcholine levels |
| by volume | antibacterial, antifungal, insecticidal (PMID | leading to improved |
| | 29976894) | cognition in dementia, |
| | | anti-aging, useful in |
| | | diseases with |
| | | inflammatory |
| | | component, |
| | | prevention and |
| | | treatment of bacterial |
| | | or fungal infections, |
| | | as use as a natural |
| | | insecticide. |
| Grapefruit essential oil | Anti-obesity, cravings and hunger reducer | Obesity, appetite |
| (Citrus paradisi) | (when mixed with patchouli oil), antioxidant, | suppressant, anti- |
| Range: 0.001%-30% | anti-inflammatory, antibacterial, antifungal, | aging, useful in |
| by volume | insecticidal (PMID 29976894) | treating diseases with |
| | | an inflammatory |
| | | component, |
| | | prevention and |
| | | treatment of bacterial |
| | | and fungal infections, |
| | | as use as a natural |
| | | insecticide. |
| Mandarin essential oil | Antiproliferative, chemoprotective, antioxidant, | Cancer, anti-aging, |
| (Citrus reticulata) | antibacterial, antifungal (PMID 29976894) | prevention and |
| Range: 0.001%-30% | | treatment of infection |
| by volume | | against bacteria and |
| | | fungi. |
| Kumquat essential oil | Antiproliferative, antioxidant, antibacterial, | Cancer, anti-aging, |
| (Citrus Japonica) | antifungal (PMID 29976894) | prevention and |
| Range: 0.001%-30% | | treatment of infection |
| by volume | | against bacteria and |
| | | fungi. |
| Bergamot essential oil | Note that Bergamot modifies normal and | Peripheral |
| (Citrus bergamia) | pathological synaptic plasticity of nociceptive | neuropathy, |
| Range: 0.005%-15% | and neuropathic pain; also modulates | neuropathic pain, |
| by volume | perception of pain, and these effects are | useful in stimulating |
| | reversed by local or systemic pretreatment with | pigment production in |
| | μ-opioid antagonist naloxone hydrochloride | sunless tanning |
| | (PMID 26996621) and bergamot oil also seems | preparations, pain |
| | to exert effects via peripheral cannabinoid and | relief, wound healing, |
| | opioid systems. Melanogenic component in | cancer, protection |
| | suntan preparations, pain relief, peripheral anti- | from |
| | nociceptive, antiallodynic, wound healing, | neurodegeneration, |
| | cytotoxic, anti-tumor, neuroprotective, sedative, | enhancing sedation, |
| | calming, soothing, anxiolytic, mood enhancer, | treatment of anxiety, |
| | antioxidant, antibacterial, antifungal, anti- | enhancing mood, |
| | dermatophyte, antimycoplasmal (PMID | relief from |
| | 29976894) | depression, useful in |
| | | anti-aging, prevention |
| | | and treatment of |
| | | infections. |
| Neroli essential oil | Sedative, soothing, calming, motor relaxant, | Useful in treating |
| (Citrus aurantium) | anxiolytic, antidepressant, anti-seizure, | insomnia, anxiety, |
| Range: 0.001%-30% | anticonvulsant, central and peripheral | increased muscle |
| by volume | antinociceptive effects, anti-inflammatory; | tension, depression, |
| | improves symptoms of menopause and PMS, | seizures, convulsions, |
| | aphrodisiac; endothelium and smooth muscle- | pain (via both central |
| | dependent vasodilator; hypotensive, | and peripheral |
| | antioxidant, anti-amnesic, antibacterial, | nervous system), |
| | antifungal (PMID 29976894) | improves symptoms |
| | | of menopause and |
| | | PMS, low libido, |
| | | hypertension, |
| | | hypertension- |
| | | associated headaches; |
| | | useful in preventing |
| | | or treating infections. |
| Bitter Orange | Mild sedative, hypnotic, soothing, calming, | Useful in treating |
| (Citrus aurantium | motor relaxant, sleep inducer, anxiolytic and | insomnia, anxiety, |
| amara) | antidepressant, pain relief, antiseizure and | depression, pain, |
| Range: 0.001%-30% | anticonvulsant agent, anti-spasmodic, | seizure, convulsions, |
| by volume | aphrodisiac, gastroprotective and ulcer healing, | muscle spasms, |
| | digestive disorders treatment, | depressed libido, |
| | hepatocarcinogenesis suppressant, antioxidant | gastric ulcers, |
| | nephroprotective, antibacterial, pimple and acne | improving digestion, |
| | treatment, antifungal, fumigant and anti- | protection of the |
| | cholinesterase, larvicidal (PMID 29976894) | gastric lining, |
| | | neutralizing |
| | | carcinogens which |
| | | target the liver, |
| | | antioxidant protection |
| | | of the kidneys, |
| | | antibacterial, |
| | | treatment of acne, |
| | | antifungal, |
| | | improvement of |
| | | neurocognitive |
| | | function by increasing |
| | | acetylcholine; |
| | | possesses larvicidal |
| | | properties. |
| Sweet Orange | Anticarcinogenic, relaxant, anxiolytic, pain | Useful in neutralizing |
| (Citrus sinensis) | relief, hepatocarcinogenesis suppressant, anti- | carcinogens, |
| Range: 0.001%-30% | tumor, antioxidant, food preservative, acne | improvement of |
| by volume | treatment when used with sweet basil oil, | anxiety, pain, |
| | antibacterial, antifungal, anti-aflatoxigenic | neutralizing of |
| | when used at 500 ppm), larvicidal, insecticidal, | carcinogens which |
| | anthelminthic, promotes growth of tilapia | target the liver, anti- |
| | (PMID 29976894) | tumor, anti-aging, |
| | | acne, antibacterial, |
| | | antifungal, anti- |
| | | aflatoxin, useful in |
| | | killing larva, insects, |
| | | stimulating growth of |
| | | tilapia, expelling |
| | | parasitic worms. |
| Orange petitgrain | Antioxidant, antibacterial, antifungal properties | Anti-aging. Useful in |
| essential oil | (PMID 29976894) | preventing and |
| (Citrus aurantium) | | treating bacterial and |
| Range: 0.001%-30% | | fungal infections. |
| by volume | | |
| Peppermint essential | When inhaled, found to be just as effective as | Migraine. Useful in |
| oil or water extract | 4% intranasal lidocaine in treating migraine | treating parasitic |
| (Mentha piperita) | attacks (PMID 31404204). Mild anthelmintic | worm infestations. |
| Range: 0.001%-80% | properties (PMID 21820807). Significant | Useful in preventing |
| by volume | antimicrobial, antiviral, antioxidant and | or treatment of |
| | antitumor, and antiallergenic properties, relaxes | infections from |
| | GI tissue, has analgesic and anesthetic effects in | bacteria, viruses and |
| | the central and peripheral nervous system, | fungi. Helpful in |
| | possesses immunomodulating actions and | improving ease of |
| | chemopreventive potential, helpful in irritable | breathing. Useful in |
| | bowel syndrome (PMID 16767798). Improves | treating pain and |
| | cognitive performance, attenuates fatigue, | cancer. Improves |
| | improves concentration (PMID 30087294). | cognitive function and |
| | Possesses high antiviral activity against HSV1 | focus. Protects against |
| | and HSV2 (Herpes Simplex Virus) if applied to | herpes virus infection |
| | cells prior exposure to adsorption of the virus | when applied |
| | but has no effects after penetration into the host | prophylactically. |
| | cell (PMID 31195752). Has antifungal | |
| | properties (PMID 31195752). | |
| Spearmint essential oil | Helpful in treatment of osteoarthritic pain, in | Treatment of pain, |
| (Mentha spicata) | prevention of flatulence (PMID 28107842). | osteoarthritic pain, |
| Range: 0.001%-80% | Possesses anti-androgenic properties, thus | flatulence, PCOS, |
| by volume | useful in treating polycystic ovarian syndrome | metabolic syndrome, |
| | (PCOS) - including reducing weight, | diabetes. Useful in |
| | testosterone level, ovarian cysts, atretic | anti-aging due to |
| | follicles, and increases Graafian follicles in an | antioxidant properties. |
| | animal model of PCOS, by inhibiting | |
| | testosterone and restoring follicular | |
| | development in ovarian tissue (PMID | |
| | 29399556). Antioxidant properties (PMID | |
| | 31382468) able to scavenge free radicals and | |
| | mitigate lipid peroxidation. Also enhances | |
| | endogenous antioxidant function (increases | |
| | endogenous glutathione production) (PMID | |
| | 31382468). | |
| Wintergreen essential | Treatment of pain, especially osteoarthritic pain | Antiparasitic |
| oil | (PMID 28107842). Along with coriander and | properties against |
| (Gaultheria procumbens) | frankincense, possesses anti-leishmanial | leishmania and |
| Range: 0.001%-5% | properties (parasite) (PMID 30934998), | larvicidal against |
| by volume | insecticide properties (PMID 29029320, | mosquito larvae. |
| | larvicidal properties against mosquito larvae | Improves transdermal |
| | (PMID 26528914). Improves penetration of | penetration of skin. |
| | skin for other bioactive and medicinal | Topical treatment of |
| | compounds (PMID 29052396) by reducing skin | pain, especially |
| | barrier function and enhancing transdermal | osteoarthritic pain. |
| | absorption of lipophilic and hydrophilic drugs. | |
| | Oil of wintergreen (methyl salicylate) 5 ml is | |
| | equivalent to 7000 mg of salicylate or 21.7 adult | |
| | aspirin tablets (PMID 11335011), thus care | |
| | should be used in formulating doses appropriate | |
| | for pediatric, adult, and geriatric populations. | |
| Coriander seed | Possesses antioxidant, antimicrobial and | Useful in prevention |
| essential oil, | antibiofilm activity of coriander (PMID | and treatment of |
| Coriander seed | 32143314, PMID 32143314) including | infections from |
| extract | antifungal properties (PMID 31142010). | bacteria, viruses and |
| (Coriandrum sativum) | Along with essential oil of frankincense and | fungi. Possess |
| Range: 0.001%-80% | wintergreen, coriander seed derivatives possess | antiparasitic |
| by volume | anti-leishmanial properties (leishmania parasite) | properties |
| | (PMID 30934998). Possess antimicrobial, | (leishmania). Useful |
| | antioxidant, antidiabetic, anxiolytic, | in treating diabetes, |
| | antiepileptic, antidepressant, antimutagenic, | anxiety, epilepsy, |
| | anti-inflammatory, anti-dyslipidemic, | depression, cancer, |
| | antihypertensive, neuroprotective and diuretic | inflammation, |
| | properties (PMID 23281145). | hyperlipidemia, |
| | | hypertension, |
| | | protecting neurons, |
| | | and alleviating edema |
| | | due to diuretic |
| | | properties. |
| Gingergrass essential | Exerts immunomodulatory and anti- | Useful in preventing |
| oil | inflammatory properties on human monocytes | and treating |
| (Cymbopogon martinii | (PMID 24934659). Has antimicrobial (bacteria, | infections, pain. |
| var. sofia) | fungus, virus) properties (PMID 32684097, | Useful for killing acne |
| Range: 0.001%-50% | PMID 30277563). Useful in repelling | bacterium while |
| by volume | mosquitoes (PMID 15119079). | decreasing |
| | | inflammation. Repels |
| | | mosquitoes. |
| Bergamot mint | Antioxidant properties, cytotoxic to colon | Useful in anti-aging, |
| essential oil | cancer cells (PMID 31749482, PMID | and cancer. Mild |
| (from stems, leaves | 21646282). Mild insect repellent, larvicidal, and | insect repellent, |
| and flowers) | pupicidal properties (PMID 21338379). | larvicidal and |
| (Mentha citrata) | | pupicidal properties. |
| Range: 0.001%-50% | | |
| by volume | | |
| Lemon balm essential | Possesses antioxidant properties (PMID | Anxiety, improves |
| oil | 27620926 and PMID 30045422), helpful for | concentration, |
| (Melissa officinalis) | improving serum biomarkers of oxidative | improves sleep |
| Range: 0.001%-30% | stress, inflammation and lipid profile (PMID | disruption in |
| by volume | 30045422) anxiolytic properties and improves | menopausal women |
| | cognition and focus (PMID 25360512), | |
| | improves sleep disruption in menopausal | |
| | women (PMID 24199972), improves skin | |
| | elasticity and reduces arterial stiffness due to | |
| | decrease in protein glycation (PMID 28367927) | |
| Pine needle essential | Frankincense, pine needle and geranium | Cancer, infection, any |
| oil and extract | essential oils suppress tumor progression | diseases involving |
| (Cedrus deodara, | (PMID 29115548, PMID 29434792, PMID | inflammation |
| Pinus brutia, Pinus | 25293350, PMID 32523794). Possesses | |
| halepensis, etc.) | antioxidant (PMID 31538201), antimicrobial | |
| Range: 0.001%-30% | (PMID 22757704, PMID 32013183, PMID | |
| by volume | 332303819) and anti-inflammatory (PMID | |
| | 31659812, PMID 30018892) however extracts | |
| | of Ponderosa Pine has abortifacient properties | |
| | and thus will be avoided (PMID 1526928), as | |
| | well as neuroprotective effects (PMID | |
| | 28642096). | |
| Geranium essential oil | Frankincense, pine needle and geranium | Cancer, prevents |
| (Pelargonium graveolens) | essential oils suppress tumor progression | infection, helpful in |
| Range: 0.001%-30% | (PMID 29115548). Geranium triggers cell cycle | treating neuropathic |
| by volume | arrest and apoptosis in cancer cell lines (PMID | pain, diabetes. Useful |
| | 30914034), possesses antibacterial and | for mild sunblock |
| | antifungal activity, is useful in neuropathic pain | properties. |
| | (PMID 30000892), useful in treating diabetes as | |
| | it reduces serum blood glucose and improved | |
| | serum antioxidant status when administered | |
| | orally (PMID 22734822), possesses mild | |
| | sunscreen properties (PMID 30251317) to | |
| | protect skin from sunburn. | |
| Wang-Cho-Pi (Korean | Zanthoxylum coreanum nakai essential oil and | Most useful in allergic |
| lime tree) essential oil | extracts have been shown to inhibit mast cell | inflammatory |
| and extract | degranulation and reduce the level of IL-4, a | diseases. |
| (Zanthoxylum | key inflammatory factor in allergy symptoms | |
| coreanum nakai) | (PMID 30618741). Mechanisms include | |
| Range: 0.001%-10% | suppressing activation of NF-kB, inhibiting NF- | |
| by volume | kB p65 translocation into the nucleus, inhibiting | |
| | inflammatory markers TNF-alpha, IL-6, and | |
| | NO, downregulating protein levels of iNOS and | |
| | COX-2; and down-regulating phosphorylation | |
| | of MAPK signaling cascade despite an | |
| | inflammatory milieu. | |
| Winged prickly ash | Zanthoxylum armatum possesses antimicrobial, | Antimicrobial, |
| essential oil and extract | antiviral, antioxidant, anti-inflammatory, anti- | antioxidant, useful in |
| (Zanthoxylum armatum) | tumor, hepatoprotective, insecticidal properties | treatment of diseases |
| Range: 0.001%-10% | (PMID 30166217, PMID 33289429) as well as | of inflammation, |
| by volume | lipid and serum glucose lowering properties | diabetes, |
| | useful in treatment of hyperlipidemia, diabetes, | cardiovascular |
| | metabolic syndrome, obesity, stroke and | disease, metabolic |
| | cardiovascular disease (PMID 29463309, PMID | syndrome, |
| | 33390134). Mechanisms include inhibiting | hyperlipidemia, |
| | alpha-glucosidase, leading to decrease in fasting | obesity, stroke, |
| | blood sugar levels (PMID 29463309). Possesses | cancer. Helpful in |
| | stomachic, carminative and anthelminthic | protecting the liver. |
| | properties (PMID 30166217). | |
| Carrot seed oil and | Shown to have high repellent activity against | Useful in repelling |
| extract | mosquitoes when applied topically (PMID | mosquitoes, treating |
| (Daucus carota) | 31442148). Has antifungal properties (PMID | or preventing fungal |
| Range: 0.001%-99% | 31489671) and mild sun protection factor SPF | infections, or in |
| by volume | value 6.92 PMID 29737890. | formulations as a mild |
| | | sunscreen. Also useful |
| | | as a skin moisturizer. |
| Blackberry seed | Antioxidant properties (PMID 28098355). | Anti-aging properties. |
| essential oil and extract | Moisturizer and serves as a carrier oil. | Moisturizer and |
| (supercritical carbon | | serves as carrier oil. |
| dioxide extraction, | | |
| hexane, ethanol, water | | |
| distillation) | | |
| (Rubus fruticosus, | | |
| Rubus ursinus, etc.) | | |
| Range: 0.001%-99% | | |
| by volume | | |
| Blueberry seed | Antioxidant properties (PMID 32363872, PMID | Anti-aging properties. |
| essential oil and extract | 32059466). Moisturizer and serves as carrier | Moisturizer and |
| (Vaccinium corymbosum, | oil. | serves as carrier oil. |
| Vaccinium uliginosum, | | |
| Vaccinium virgatum | | |
| aiton, Vaccinium ashei, | | |
| Vaccinium angustifolium, etc.) | | |
| Range: 0.001%-99% | | |
| by volume | | |
| Raspberry seed | Antioxidant properties. Moisturizer and serves | Anti-aging properties. |
| essential oil and extract | as carrier oil. Dietary supplementation | Improves liver |
| (Rubus idaeus) | modulates liver functions, inflammatory state, | antioxidant status, |
| Range: 0.001%-99% | and lipid metabolism in animal models (PMID | helps to neutralize an |
| by volume | 26108544) | inflammatory state, |
| | | and improves lipid |
| | | metabolism. |
| | | Moisturizer and |
| | | serves as carrier oil. |
| Turmeric essential oil | Possesses powerful anti-inflammatory | Anti-aging, improves |
| and extract | properties, as well as hepatoprotective | liver function, |
| (Curcuma longa, | properties, antispasmodic properties, improves | treatment of muscle |
| Curcuma zedoaria, | bile secretion (PMID 2062949). Antioxidant, | cramps, pain, cancer, |
| Curcuma aeruginosa, | anti-cancer, antimicrobial, anti-neoplastic | useful in the |
| Curcuma zanthorrhiza, | properties (PMID 26528921, PMID 27213821). | prevention and |
| Curcuma aromatica, | Useful in oral and topical treatment of acne, | treatment of |
| Curcuma phaeocaulis, | alopecia, atopic dermatitis, facial photoaging, | infections, skin |
| Curcuma amada, | oral lichen planus, pruritus, psoriasis, | conditions including |
| Curcuma caesia, etc.) | radiodermatitis, and vitiligo (PMID 27213821). | acne, alopecia, atopic |
| Range: 0.001%-70% | Non-mutagenic, nongenotoxic, safe for use | dermatitis/eczema, |
| by volume | during pregnancy however may cause GI upset | photoaging, oral |
| | at high doses but is GRAS (PMID 29480523). | lichen planus, pruritic |
| | Helpful in treating diabetes, metabolic | skin, psoriasis, |
| | syndrome and obesity (PMID 29624265). | dermatitis, vitiligo, |
| | Helpful in treating pain (PMID 27078813), | diabetes, metabolic |
| | protecting the liver (PMID 30947655), | syndrome, obesity, |
| | preventing fungal infections (PMID 30947655), | cardiovascular |
| | reducing blood pressure (PMID 30947655), and | disease, treating high |
| | neuroprotective (PMID 30947655), improves | blood pressure and or |
| | wound healing, improves arthritic pain, anti- | hypertension, protects |
| | tumor properties (PMID 30947655) anti- | cognitive function, |
| | hyperlipidemic (PMID 30200410), treatment of | improves wound |
| | GI disorders (PMID 30200410). | healing, reduces |
| | | serum lipids, and |
| | | inflammatory GI |
| | | diseases. |
| Black seed essential | Useful in the treatment of pain, especially that | Cancer, hypertension, |
| oil, Black cumin | of rheumatoid arthritis (PMID 30097124), anti- | diarrhea, rheumatoid |
| essential oil and extract | inflammatory properties useful in normalizing | arthritis, degenerative |
| (Nigella sativa) | liver enzymes, hyperlipidemia, insulin and | osteoarthritis, chronic |
| Range: 0.001%-60% | fasting blood sugar levels (PMID 31890671, | pain, fibromyalgia, |
| by volume | PMID 31152309), improves weight loss efforts | kidney stones, |
| | (PMID 31152309) by limiting inflammation | hyperlipidemia, non- |
| | which causes upregulation of signaling | alcoholic fatty liver |
| | molecules such as adiponectin which has anti- | disease (NAFLD), |
| | diabetic, anti-inflammatory, anti-atherogenic, | asthma, vitiligo, |
| | and cardioprotective effects to improve energy | obesity, potentiates |
| | metabolism; while also downregulating | weight loss efforts. |
| | inflammatory molecules such as TNF-alpha. | |
| | Mechanisms include restoring normal | |
| | expression levels of DNMT3A and HDAC1, | |
| | which are altered under conditions of | |
| | inflammation; and limiting pro-inflammatory | |
| | cytokine production (PMID 31878334). When | |
| | injected intra-articularly was found to protect | |
| | cartilage from degeneration in early stages of | |
| | osteoarthritis (PMID 3145944). Helps to | |
| | convert metabolically unhealthy white fat into | |
| | beige fat (PMID 32512788) which improves | |
| | metabolism and promotes weight loss, healthy | |
| | lipid levels. Possesses neuroprotective | |
| | properties (PMID 316388880). Applied | |
| | topically can ameliorate vitiligo appearance and | |
| | progression (PMID 31025474). Protects | |
| | multiple organs against side effects of | |
| | chemotherapy (PMID 29223554, PMID | |
| | 30888204, PMID 28287318, PMID 31781612, | |
| | PMID 31453801, PMID 29854586) and against | |
| | gastric carcinoma (PMID 12881014), breast | |
| | cancer (PMID 30678630, PMID 24098377) and | |
| | limits cancer cell proliferation (PMID | |
| | 31622301). Treats asthma, diarrhea (PMID | |
| | 12722128). Possesses antipyretic properties, | |
| | antimicrobial properties (PMID 12722128). | |
| | Decreases blood pressure and enhances | |
| | respiratory function (PMID 12722128). Induces | |
| | increase in hemoglobin, packed cell volume, | |
| | possesses cytoprotective and antioxidant | |
| | properties (PMID 12722128). Possesses | |
| | immunomodulatory and immunotherapeutic | |
| | properties - specifically by augmenting T-cell | |
| | and natural killer cell-mediated immune | |
| | responses, as well as anti-microbial and anti- | |
| | tumor properties (PMID 16275613) | |
| Garlic essential oil and | Anti-inflammatory properties by inhibiting NF- | Treats pain, any |
| extract | kappa B activation, iNOS and COX-2, useful in | diseases with an |
| (Allium sativum) | treating pain, stiffness associated with | inflammatory |
| Range: 0.001%-50% | osteoarthritis (PMID 30651162). Improves | component including |
| by volume | cardiovascular health and endothelial function | diabetes, |
| | by reducing atherosclerotic plaques, | cardiovascular |
| | suppressing inflammatory cell adhesion to | disease, stroke, |
| | endothelial cells, increases blood flow and | hypertension/high |
| | circulation, downregulating inflammatory | blood pressure, |
| | markers such as CRP, plasminogen activator | improves blood flow |
| | inhibitor-1, LDL-C, and reduced carotid intima- | and circulation, useful |
| | media thickness progression in patients with | in treating |
| | coronary artery diseases; lowers serum | hyperlipidemia, |
| | cholesterol, triglycerides, but not LDL or HDL; | hypercholesterolemia, |
| | lowers blood pressure by stimulating NO and | useful in dissolving |
| | inhibiting ACE activity; while garlic-derived | small clots and |
| | organic polysulfides are converted by red blood | preventing clot |
| | cells into hydrogen sulfide gas which leads to | formation, treats |
| | vasorelaxation via vascular smooth-muscle cell | metabolic syndrome, |
| | signaling pathway to further reduce blood | diabetes, obesity, and |
| | pressure; can reduce systolic blood pressure by | protects against |
| | 15 points and diastolic blood pressure by 9 | cognitive decline. |
| | points; has antithrombotic and anticoagulant | Enhances memory |
| | properties because garlic inhibits platelet | and learning, as well |
| | aggregation by inhibiting COX-1 activity and | as stimulating activity |
| | thromboxane A1 formation; also activates | and proliferation of |
| | fibrinolytic activity and is able to dissolve small | immune cells and |
| | clots only in unhealthy patients but not in | stimulates their |
| | healthy controls. Garlic lowers blood glucose | function to fight |
| | and thus is helpful in treatment/management of | infections and cancer. |
| | diabetes, metabolic syndrome, and obesity by | |
| | increasing insulin sensitivity as well as total | |
| | secretion, decreasing triglyceride levels. Garlic | |
| | protects against ischemic stroke and improves | |
| | memory and learning by protecting neurons | |
| | from A-beta-induced neurotoxicity and | |
| | apoptosis and prevents cognitive decline | |
| | associated with Alzheimer's Disease. Garlic | |
| | possesses immunomodulatory activity by | |
| | stimulating lymphocyte proliferation and | |
| | release of interferon-gamma to enhance | |
| | phagocytosis by macrophages and enhancing | |
| | killer-T-cell activity (PMID 30651162) | |
| Wolfberry (Goji berry) | Antioxidant properties (PMID 28407975). | Goji berry seed oil is |
| seed essential oil, | Water extract possesses anti-tumor, antioxidant, | useful for an |
| aqueous extract of | antidiabetic, protective against radiation, | antioxidant rich |
| whole fruit. | antiviral, blood lipid lowering, anti-fatigue, | carrier oil and or |
| (Lycium barbarum, | anti-aging, anti-inflammatory, and | moisturizer. Helpful |
| Lycium chinense) | immunomodulatory properties (PMID | in treating acute liver |
| Range: 0.001%-50% | 31030757). | injury, alcoholic liver |
| by volume | | injury, nonalcoholic |
| | | fatty liver disease, |
| | | performance |
| | | impairment, brain |
| | | injury, retinal |
| | | degeneration, stroke |
| | | and Alzheimer's |
| | | Disease. |
| Alcohol | Used in preserving some of the more easily | Preservative, |
| (190-200 proof) | degraded compounds found in the essential oils | improves solubility |
| | of Moroccan, German, and Roman chamomile | and stability of |
| | (e.g. bisabolols) | phenolic compounds |
| Pomegranate seed oil | Pomegranate seeds, fruit, skin, juice and oil all | Diseases with an |
| and extract | have therapeutic benefits - anti-inflammatory, | inflammatory |
| (Punica granatum) | anti-proliferative, anti-tumorigenic properties | component, including |
| Range: 0.0001%-6% | affecting multiple signaling pathways | cancer. Antioxidant |
| by volume | universally implicated in all cancers but | properties slow the |
| | specifically showing promise in the prevention | process of aging and |
| | and treatment of skin, breast, prostate, lung, and | prevent cancer. |
| | colon cancers (PMID 28125044) | |
| Ginger essential oil, | In Traditional Chinese Medicine, the use of | Useful in improving |
| ethanolic extract, water | ginger in any formulary is to improve | circulation, |
| extract | circulation in general, but also to improve | metabolism, |
| (Zingiber officinale) | circulation of medicine into the correct | digestion, helps with |
| Range: 0.0001%-80% | meridian. This latter effect is greatly enhanced | headaches, anti- |
| by volume | with the addition of licorice root (Personal | emesis, pain, male |
| | communication, Dr. Hu-Shen Wang, L. Ac. | infertility, congestive |
| | M. S., Ph. D.). At least one component of Ginger | heart failure (due to |
| | Oil, zingerone exhibited a mild diuretic effect | diuretic properties). |
| | that was observed only when at a dose of | |
| | 30 mg/kg in normal mice (PMID 20606379). | |
| | Possesses gastroprotective (PMID 23612703), | |
| | improves metabolism and metabolic syndrome | |
| | (PMID 28505392), antiviral properties (PMID | |
| | 23123794), anti-inflammatory properties | |
| | (PMID 17950516) useful in treating pain and | |
| | improving circulation (PMID 17950516), | |
| | improves semen quality (concentration, | |
| | viability, motility and morphology) (PMID | |
| | 31012134). Ethanolic extracts of ginger are | |
| | helpful in improving metabolism, treating | |
| | hyperlipidemia, and useful in weight loss | |
| | (PMID 32064135). Water extracts of ginger is | |
| | protective against gastric cancers (PMID | |
| | 31155951). | |
| Licorice extract | In Traditional Chinese Medicine, the use of | Useful in treating |
| (Glycyrrhiza uralensis) | ginger is to improve circulation and licorice is | disorders involving |
| Range: 0.0001%-80% | for helping to deliver herbal medicine into the | inflammation. |
| by volume | appropriate meridians. Together, ginger and | |
| | licorice serve to circulate the medicine as well | |
| | as deliver medicines to tonify the meridians that | |
| | need strengthening (Personal communication, | |
| | Dr. Hu-Shen Wang, L. Ac. M. S., Ph. D.). The | |
| | active component of licorice (glycyrrhizin) | |
| | synergizes with emu oil to exert a stronger anti- | |
| | inflammatory effect by modulating | |
| | inflammatory markers PPARγ and TNFα in an | |
| | animal model of ulcerative colitis (PMID | |
| | 25560991) | |
| Bupleurum extract | Radix Bupleurum is a mainstay in Traditional | |
| (Bupleurum chinense) | Chinese Medicine, safely used for thousands of | |
| Range: 0.0001%-80% | years when in the correct proportion with other | |
| by volume | herbs and in appropriate dose (Personal | |
| | communication, Dr. Hu-Shen Wang, L. Ac. | |
| | M. S., Ph. D.). There are over 281 components | |
| | isolated from Radix bupleuri, including 15 | |
| | flavonoids, 430 lignins, 12 phenyl propanol | |
| | derivatives, 66 triterpenoid saponins, and | |
| | volatile oils, which have antipyretic, antiviral, | |
| | anticonvulsant, antitumor, sedative, analgesic, | |
| | antitussive, hepato- and nephron-protective | |
| | properties, anxiolytic as well as | |
| | immunomodulatory properties (PMID | |
| | 29956627) | |
| Coenzyme q10 | Ubiquinol = an electron-rich (reduced) form of | Useful as a |
| Ubiquinol, Ubiquinone | coenzyme Q10, one of the 3 forms of coenzyme | supplement in patients |
| Range: 0.0001%-30% | Q10 (fully oxidized (ubiquinone), partially | with cardiovascular |
| by weight | reduced (semiquinone or ubisemiquinone) and | compromise. Useful |
| | fully reduced (ubiquinol). | in improving energy |
| | Ubiquinone is the most bio-available form of | profile and |
| | coenzyme Q10, which is important in cellular | metabolism to address |
| | energy production as part of the electron | obesity, metabolic |
| | transport chain in the mitochondria where the | syndrome, and |
| | energy for the body is produced. | diabetes. Useful in |
| | Possesses antioxidant properties and improves | improving skin cell |
| | renal function (PMID 20878200 and PMID | function when applied |
| | 24151980). | topically. |
| Food-Grade | FGDE are biocompatible, nontoxic porous | |
| Diatomaceous Earth | biosilicates skeletal remains of unicellular | |
| (FGDE) | diatom microalgae that are tiny (nano microns) | |
| Range: 0.0001%-90% | long which can be used as micro-shuttles in | |
| by weight | drug delivery systems that have been | |
| | demonstrated capable of opening intercellular | |
| | tight junctions (PMID 31618958) - particularly | |
| | useful in delivery of substances with poor water | |
| | solubility and low oral bioavailability such as | |
| | quercetin (PMID 31496698), prolonging drug | |
| | delivery (PMID 316618958) and particularly | |
| | useful in the treatment of metastatic cancer | |
| | (PMID 31330820), which requires infiltrating | |
| | the intracellular signaling pathways taken over | |
| | by cancer (PMID 25239399). FGDE is safe to | |
| | consume. It passes through the digestive tract | |
| | unchanged and does not enter the bloodstream. | |
| | Inhalation of FGDE can cause silicosis lung | |
| | disease, thus workers must be appropriately | |
| | masked when working with it. | |
| Dead Sea Salt | Refer to (PMID 22503590) for scientific | Psoriasis, Eczema, |
| Range: 0.0001%-30% | evidence of the therapeutic effects of dead sea | Acne, Allergies, Hair |
| by weight | treatments: a systematic review. Dead sea salts | Loss, Osteoarthritis, |
| | have a good safety profile, useful for | Rheumatoid Arthritis, |
| | rheumatologic diseases and psoriasis, do not | Dry Skin, Stress, |
| | increase blood pressure. The Dead Sea is the | Muscle Soreness, |
| | world's deepest and highest salinity lake, with 9 | Chronic Pain, Restless |
| | times the minerals and salts than sea water, | Leg Syndrome, |
| | simply due to gravity pooling the minerals into | Insomnia |
| | the deepest lake thus collecting all minerals. | |
| | Readily replenishes trace minerals required for | |
| | human health. Readily receives and reflects | |
| | light and even gamma radiation for over 336 h | |
| | after initial optical stimulation (PMID | |
| | 28495302), thus the perfect vehicle for | |
| | receiving sound and optical energy prior to | |
| | dissolution into solvent. Dead sea water has | |
| | been shown in in vitro and ex vivo human skin | |
| | organ cultures to stimulate the expression of | |
| | barrier-related proteins filaggrin, involucrin and | |
| | transglutaminase, thus strengthening the | |
| | structural integrity of skin; it also stimulated | |
| | secretion of β-endorphin which promotes | |
| | feelings of well-being, while simultaneously | |
| | attenuating the expression of inflammatory and | |
| | irritation-related cytokines (PMID 30903724) | |
| Organic pea protein | Provides all amino acids, including essential | Rebuilding muscle, |
| Range: 0.0001%-30% | branched chain amino acids required for muscle | bone, connective |
| by weight | growth; decreases muscle damage | tissue |
| Organic brown rice | Provides all amino acids, including essential | Rebuilding muscle, |
| protein | branched chain amino acids required for muscle | bone, connective |
| Range: 0.0001%-30% | growth; decreases muscle damage | tissue |
| by weight | | |
| Sea Kelp Bioferment | Moisturizer, humectant, source of antioxidants, | Antioxidant, anti- |
| (extract of fermented | with anti-inflammatory properties, vitamins, | inflammatory |
| seaweed) | minerals especially trace minerals such as | properties, provides |
| (Macrocystis pyrifera, | iodine, copper, selenium, zinc which are | cofactors important |
| Nereocystis luetkeana, | important cofactors for cellular function, | for cellular function, |
| Laminariales, other | metabolism, and regeneration. | metabolism and |
| kelp, etc.) | | regeneration. |
| Range: 0.01%-40% | | |
| N-Acetyl Cysteine | One of 3 most abundant amino acids in pre- | Rebuilding collagen |
| (NAC) | collagen and collagen. Antioxidant that | (<1% by volume). |
| Range: 0.0001%-50% | completely blocks Reactive Oxygen Species | Recharging liver |
| by weight | (ROS) protecting from cancer, reducing fatigue | glutathione (<50% by |
| | (PMID 21715129) | volume) |
| Glycine: | One of 3 most abundant amino acids in pre- | Rebuilding collagen |
| Range: 0.0001%-50% | collagen and collagen | (<1% by volume). |
| by weight | | Useful for promoting |
| | | restful sleep, or as an |
| | | anxiolytic (<50% by |
| | | weight) |
| L-proline: | One of 3 most abundant amino acids in pre- | Rebuilding muscle, |
| Range: 0.0001%-50% | collagen and collagen | bone, connective |
| by weight | | tissue (<1% by |
| | | weight). |
| Vitamin A: | Essential for amino acid utilization. Critical for | Rebuilding muscle, |
| Range: 0.0001%-50% | wound healing (PMID 31697447), regulation of | bone, connective |
| by weight | gene transcription which regulate reproduction, | tissue (<1% by |
| | embryogenesis, vision, growth, differentiation | weight). |
| | and proliferation of stem cells, maintenance of | |
| | skin cell integrity, immune function (PMID | |
| | 26565606) | |
| Vitamin B3 | Essential for amino acid utilization. Possesses | Rebuilding muscle, |
| (niacinamide): | anti-pruritic, antimicrobial, vasoactive, photo- | bone, connective |
| Range: 0.0001%-50% | protective, sebostatic, and pigment lightening | tissue (<1% by |
| by weight | effects (PMID 24993939, PMID 29405129). | weight). |
| Vitamin B6: | Serves as a coenzyme catalyzing more than 150 | Important antioxidant |
| Range: 0.0001%-50% | enzymes regulating metabolism and synthesis | required for proper |
| by weight | of all macromolecules, heme and other | metabolism, |
| | bioactive metabolites (PMID 29477221). | preventing |
| | Possesses antioxidant properties, synthesis of | inflammation, |
| | neurotransmitters, protection against advanced | cardiovascular |
| | glycation end-products and thus against aging | disease, healthy aging |
| | (PMID 20110903). | and cancer. |
| Vitamin C: | Essential for amino acid utilization and collagen | Rebuilding muscle, |
| Range: 0.0001%-50% | formation. Powerful antioxidant, electron | bone, connective |
| by weight | donor, and cofactor to many enzymatic | tissue (<1% by |
| | reactions (PMID 26808119), important in | weight). |
| | metabolism, proper cognitive function (PMID | |
| | 28867798), proper immune function (PMID | |
| | 29099763), skin health (PMID 28805671), and | |
| | prevention of coronary heart disease, stroke and | |
| | cancer (PMID 29477224). | |
| Vitamin D: | Essential for amino acid utilization; low levels | Rebuilding muscle, |
| Range: 0.0001%-50% | of serum 1.25(OH)2D (active vitamin D) is | bone, connective |
| by weight or volume | associated with psoriasis (PMID 31803350) and | tissue (<1% by |
| | topical application of calcipotriene improves | weight). Ameliorates |
| | chronic plaque psoriasis (PMID 10753146). | psoriasis (0.005% |
| | Vitamin D2 and D3 are precursors of hormones | calcipotriene by v/v; |
| | with important roles in regulating | or 1.25- |
| | concentrations of calcium and phosphates | dihydroxyvitamin D3 |
| | (PMID 22716179), is important in proper | 0.005%-5% in human |
| | immune function (PMID 25912039), | mimicry oil blend); |
| | optimizing strength in human muscles (PMID | same ranges for |
| | 27379960), preventing cardiovascular disease | insomnia/fatigue, |
| | and hypertension (PMID 26768241). Important | cancer. Eczema, |
| | in proper skin barrier formation and regulation | Psoriasis, acne and |
| | of the innate immune system which controls | other diseases with a |
| | immunologic response to allergens and | disrupted skin barrier. |
| | microbial pathogens (by improving innate | |
| | antimicrobial peptides such as cathelicidin, LL- | |
| | 37 and beta-defensin) (PMID 27918470). | |
| | Integral for synthesis, metabolism and activity | |
| | of a healthy skin barrier, without which cellular | |
| | proliferation, differentiation and apoptosis is | |
| | impaired, making the skin more prone to | |
| | development of psoriasis and eczema (PMID | |
| | 29306952) and acne (PMID 31322523) | |
| Vitamin E: | Powerful antioxidant (PMID 20399614) anti- | Eczema, Psoriasis, |
| Range: 0.0001%-50% | inflammatory (PMID 32204073), especially | diseases of the skin |
| by weight or volume | when coupled with Vitamin A (PMID | barrier, antioxidant, |
| | 32204073), improves skin clarity (PMID | anti-inflammatory |
| | 31975502), anti-tumorigenic, photoprotective, | |
| | skin barrier stabilizing properties (PMID | |
| | 17719081). Upregulates gene expression of | |
| | keratinocyte differentiation markers (PMID | |
| | 33070130). | |
| Vitamin K2 (MK7): | Improves weight loss efforts in a subset of | High vitamin K2 |
| Range: 0.0001%-50% | patients who respond to supplementation with | intake is supportive of |
| by weight or volume | Vitamin K2 MK7 with increased carboxylation | reducing body weight, |
| | of osteocalcin (PMID 28952607) - the pts had | abdominal and |
| | reduced body weight, abdominal and visceral | visceral fat in patients |
| | fat. Prevents age-related deterioration of | who increase |
| | trabecular bone microarchitecture in | carboxylation of |
| | postmenopausal women (PMID 27625301), | osteocalcin as a result |
| | reduces progression of atherosclerosis in | of supplementation. |
| | chronic kidney disease patients (PMID | |
| | 26176325), important cofactor for blood | |
| | coagulation in the liver, for preventing arterial | |
| | calcification, for general cellular metabolism | |
| | (PMID 30609653). MK7 form is the most | |
| | bioactive form as it is carboxylated and can | |
| | readily promote hemostasis, useful in regulating | |
| | signaling cascades important in osteoporosis, | |
| | atherosclerosis, cancer and inflammatory | |
| | diseases without risk of negative side effects or | |
| | dosing (PMID 30791399). Only the MK7 form | |
| | of Vitamin K2 can promote gamma- | |
| | carboxylation of extrahepatic vitamin K- | |
| | dependent proteins (VKDPs), osteocalcin, and | |
| | the matrix Gla protein at a nutritional dose | |
| | around the recommended daily intake. MK7 has | |
| | a higher bioavailability and longer half-life than | |
| | other vitamin K homologs. MK7 increases | |
| | bone mineral density by facilitating signaling | |
| | cascades which improve translocation of | |
| | calcium from the serum into the bony matrix, | |
| | and promotes the quality and strength of bone | |
| | and collagen (PMID 32244313) | |
| Gallic Acid | Plant polyphenol with strong inhibitory | Cancer, Acne, |
| (GA-3,4,5- | properties in vitro and in vivo against cancer | antioxidant, anti- |
| trihydroxybenzoic acid, | (PMID 23501608) by inhibition of NFKB, Akt, | inflammatory, |
| found in grape seeds, | COX, ribonucleotide reductase and GSH | antimicrobial. |
| rose flowers, sumac, | pathways; and also activates ATM kinase | |
| oak and witch hazel) | signaling to prevent carcinogenesis (PMID | |
| Range: 0.001%-50% | 23501608). Useful in preventing and treating | |
| by weight or volume | acne (PMID 32390309, PMID 30617549). | |
| | Powerful antioxidant, anti-inflammatory, anti- | |
| | microbial, anti-cancer activities (PMID | |
| | 30657034) | |
| Grape Seed Extract | Main component is resveratrol, and other | Useful in treating and |
| (Vitis vinifera) | polyphenols and proanthocyanidins. Anti- | prevention of |
| Range: 0.001%-50% | microbial properties (PMID 31760860), anti- | infections, improving |
| by weight or volume | obesity properties by converting white fat to | metabolism, reducing |
| | beige fat (PMID 32114568), anti-hypertension | obesity, improving |
| | properties by altering function of vascular | hyperlipidemia, fatty |
| | endothelial cells (PMID 31757033, PMID | liver, diabetes, anti- |
| | 29683391), improves glycemic control, lowers | aging, wrinkles, |
| | serum lipoproteins, decreases inflammation, | hypercholesterolemia, |
| | and body weight (PMID 31880030), decreases | hypertriglyceridemia, |
| | appetite via altering neuropeptide Y signaling | reducing high blood |
| | (PMID 31713941), possesses powerful anti- | pressure/hypertension, |
| | inflammatory properties by altering NFKB | improving glycemic |
| | signaling and alleviates arsenic-induced lung | control, decreases |
| | damage (PMID 30869553), increases bone | inflammation, useful |
| | callus formation and mechanical strength | in the treatment of any |
| | (PMID 31277691), Improves wound-healing | disease of |
| | (PMID 31003677), ameliorates bleomycin- | inflammation, |
| | induced pulmonary fibrosis in mouse model | decreases body weight |
| | (PMID 2830065), reduces atherosclerosis | by altering |
| | (PMID 33456610), reduces oxidative damage | neuropeptide Y |
| | and apoptosis in kidneys in an animal model of | signaling, useful in |
| | sodium-fluoride-induced damage (PMID | treating osteoporosis, |
| | 32641209); due to proanthocyanidins. | preventing |
| | | chemotherapy- |
| | | induced lung and |
| | | tissue damage, |
| | | decreases |
| | | atherosclerosis. |
| Grape Skin Extract | Main component is resveratrol, and other | Useful in treating and |
| (Vitis vinifera) | polyphenols and proanthocyanidins. Similar to | prevention of |
| Range: 0.001%-50% | Grape Seed Extract, see above. Improves | infections, improving |
| by weight or volume | muscle function and extends lifespan in | metabolism, reducing |
| | drosophila model of Parkinson's disease | obesity, improving |
| | through activation of mitophagy (PMID | hyperlipidemia, fatty |
| | 30248358), has neuroprotective effect in | liver, diabetes, anti- |
| | Parkinson's Disease (PMID 31331731), | aging, wrinkles, |
| | protects skin from UVB-induced damage in | hypercholesterolemia, |
| | mice (PMID 28697472), reduces amyloid-beta | hypertriglyceridemia, |
| | peptide aggregation, and thus helpful for | reducing high blood |
| | treatment of Alzheimer's Disease, as it is taken | pressure/hypertension, |
| | up by brain endothelial cells (PMID 28208831) | improving glycemic |
| | | control, decreases |
| | | inflammation, useful |
| | | in the treatment of any |
| | | disease of |
| | | inflammation, |
| | | decreases body weight |
| | | by altering |
| | | neuropeptide Y |
| | | signaling, useful in |
| | | treating osteoporosis, |
| | | preventing |
| | | chemotherapy- |
| | | induced lung and |
| | | tissue damage, |
| | | decreases |
| | | atherosclerosis. |
| | | Helpful in treating |
| | | dementia, Parkinson's |
| | | and Alzheimer's |
| | | Disease. |
| Exosomes | Exosomes are mediators of cell-cell | Useful in many |
| (Exosomes may be | communication between different cell | diseases of many |
| derived from stem | populations (PMID 30344611). By definition | organs, as exosomes |
| cells, e.g., human | they are nanosized membrane vesicles released | possess signals which |
| placental mesenchymal | by fusion of an organelle of the endocytic | may stimulate |
| stem cells) | pathway, the multivesicular body, with the | regeneration and |
| Range: 0.0001%-95% | plasma membrane. Once released from the cell, | healing in the target |
| | they facilitate communication between the cell | tissue or organ and/or, |
| | of origin and other cells as they contain | if necessary, induce |
| | signaling molecules such as lipids, nucleic acids | apoptosis. They can |
| | (PMID 28733901), ubiquitinated proteins | be administered |
| | (PMID 16203162), and micro RNAs (miRNA) | intravenously (IV), |
| | specific to the cell of origin. For example | intramuscularly (IM) |
| | exosomes derived from colorectal cancer cells | or applied topically to |
| | showed distinct miRNA profiles compared to | affected areas. With |
| | wild-type cells (PMID 26132860). Thus, | respect to this |
| | exosomes may transmit signals which may | application, the use of |
| | drive normal physiologic as well as pathologic | Liquid Skin or Vegan |
| | processes (PMID 30344611). Ubiquitination | Liquid Skin as |
| | appears to target proteins to exosomes (PMID | described herein may |
| | 26246139, PMID 26574179), while the | be used to enhance |
| | membranes of the exosomes allow them to | production of |
| | deliver the signaling molecules past the cell | exosomes by |
| | membranes. Internal composition of exosomes | decreasing energy |
| | is influenced by cellular conditions or | barriers to exosome |
| | treatments while exosome membrane | release; and/or to |
| | composition is determined by the cell of origin | enhance delivery of |
| | (PMID 28733901). Exosome membranes are | exosome |
| | also rich in lipid rafts, which determine contents | payload/internal |
| | loaded into exosomes (PMID 28733901). | components to target |
| | Release of exosomes from a cell and | tissues. Biosilicates |
| | incorporation of exosomes into a cell require | may be loaded with |
| | overcoming multiple energy barriers, e.g., | exosomes, and then |
| | protein-lipid and protein-protein interactions | with Liquid Skin or |
| | occur to reduce the energy barriers and allow | Vegan Liquid Skin to |
| | fusion (PMID 28733901). Oleic acid may | permit both extended |
| | enhance lipophilic penetration of skin cells | release and enhanced |
| | (PMID 21871866, PMID 2367329), able to | delivery of exosomes |
| | facilitate targeted drug delivery across the skin | into target cells, |
| | (PMID 2514720) most likely because it reduces | tissues and organs. |
| | energy barriers to membrane fusion (PMID | This may permit |
| | 21871866) and creates a temporary disruption | localized, extended |
| | to the cell membrane allowing for drug | release of exosome |
| | permeability (PMID 2235880). As exosomes | contents into target |
| | are released from the cell via “reverse | tissues and limit their |
| | endocytosis” they are by definition coated with | entry into the systemic |
| | a lipid membrane which allows them to fuse | circulation. |
| | with other cells (PMID 28733901). The cells | |
| | from which exosomes are derived determine | |
| | their function, e.g., exosomes derived from | |
| | cancer cells promote angiogenesis, modulate | |
| | the immune system and remodel the | |
| | surrounding parenchyma tissues; all which | |
| | support tumor progression (PMID 27960084). | |
| | For simplicity, “exosome(s)” will be taken to | |
| | mean exosomes derived from stem cells, | |
| | especially those from human placenta, as these | |
| | possess properties which directly stimulate | |
| | regeneration of existing adult tissues/organs. In | |
| | injured tissues, stem cell-derived exosomes | |
| | facilitate rapid healing and recovery. One of the | |
| | current challenges of using stem cell-derived | |
| | exosomes is that they tend to enter the systemic | |
| | circulation; oftentimes away from intended | |
| | target tissues if there is an area of greater injury | |
| | within the body. The present invention provides | |
| | a mechanism for slowly releasing the stem cell- | |
| | derived exosomes in target tissues without | |
| | affecting their inherent signaling capabilities. In | |
| | certain embodiments, such a mechanism also | |
| | enhances one or more function(s) of exosomes, | |
| | as modulates their ability to penetrate the cell | |
| | membrane lipid bilayer to deliver their contents | |
| | to the nucleus and nucleolus (the “command | |
| | center” of a cell). | |
| Ceramides, cholesterol, | Ceramides are a functional part of the human | Ceramides are useful |
| essential free fatty | cell membrane, required for appropriate signals | in regeneration of skin |
| acids and non-essential | regulating cell differentiation, proliferation, and | and other cells, |
| free fatty acids in a | programmed cell death (important in both | required for regulating |
| 3:1:1:1 ratio adjusted | cancer and normal cell function). Ceramide | cell differentiation, |
| for the final volume | levels are diminished in the epidermis of | proliferation and |
| Range: adhere to the | patients with eczema and psoriasis, thus | apoptosis |
| 3:1:1:1 ratio adjusted | restoring ceramides in this patient population | (programmed cell |
| for final volume | will aid in restoring their skin to a normal state | death; important in |
| | (PMID 16962101). Ceramides must exist in | cancer and also |
| | equimolar ratios with cholesterol and free fatty | normal cell function; |
| | acids in order for proper epithelial cell | important in cellular |
| | membrane formation (PMID 8618046 and | signaling. The correct |
| | 16962101). In particular, a 3:1:1:1 ratio of | ratio of cholesterol, |
| | cholesterol, ceramides, essential and | ceramides, essential |
| | nonessential free fatty acids accelerate human | and non-essential free |
| | skin barrier recovery in aged skin (PMID | fatty acids are critical |
| | 9308554) | for restoring proper |
| | We will aim to restore the 9 major ceramides | skin barrier which has |
| | found in human stratum corneum (skin) (PMID | been lost in eczema, |
| | 8357845): | psoriasis, and irritant |
| | Cer 1 (EOS, or ester-linked fatty acids, omega- | dermatitis. |
| | OH fatty acids and sphingosines) | |
| | Cer 2 (NS, or non-OH fatty acids and | |
| | sphingosines) | |
| | Cer 3 (NP, non-OH fatty acids and | |
| | phytosphingosines) | |
| | Cer 4 (EOH) | |
| | Cer 5 (AS, alpha-OH fatty acids and | |
| | sphingosines) | |
| | Cer 6 (AP, alpha-OH fatty acids and | |
| | phytosphingosines) | |
| | Cer 7 (AH,) | |
| | Cer 8 (NH) | |
| | Cer 9 (EOP) | |
| | **Cer 1 (EOS, or ester-linked fatty acids, | |
| | omega-OH fatty acids and sphingosines) is the | |
| | main Cer fraction that is deficient in psoriasis | |
| | (along with Cer 3 and Cer 6), with concurrent | |
| | increase in ceramides containing sphingosine, | |
| | while the total amount remained identical. | |
| | Since one of the suggested pathways for | |
| | phytosphingosine biosynthesis involves | |
| | addition of water to the corresponding | |
| | sphingosine double bond, we can speculate that | |
| | the observed alteration is due to a deranged | |
| | water bioavailability associated with psoriasis | |
| | (PMID 8357845) Either way, adjusting the | |
| | ceramide fractions in the Psoriasis Preparation | |
| | would make sense. | |
| | **of note, ALL ceramide fractions are | |
| | decreased in eczema. Thus, increasing | |
| | ceramides globally in the Eczema Preparation | |
| | will be helpful. | |
| | ***Ceramide signaling in stem cells and cancer | |
| | cells (PMID 19050750) | |
| Phospholipids | Phospholipids form the majority of the cellular | Major component of |
| Range: (see list to | membrane and allow for a proper separation | the cell membrane |
| right) | between the inside environment of the cell from | important in virtually |
| Aim to recreate | the outside of the cell; they provide structure | every bodily function. |
| phospholipid | and stability to the membrane while | |
| composition of human | maintaining and allowing for multiple signaling | |
| skin with +/−5% if no | interactions to take place on both the internal | |
| range specified | and external surfaces of the cell membrane | |
| | which are important for every disease process | |
| | (e.g., inflammation, cancer, cell division, pain, | |
| | to name a few). | |
| | An aim is to recreate the phospholipid | |
| | composition of the human skin, with +/−5% if | |
| | no range is specified: | |
| | Lecithin 68.3%-72.5% | |
| | Phosphatidylcholine 36.6% | |
| | Choline Plasmalogen 3.7% | |
| | Phosphatidylethanolamine 3.4-10.2% | |
| | Ethanolamine plasmalogen 7.6% | |
| | Sphingomyelin 10.8%-18.7% | |
| | Phosphatidylserine 2.1%-7.1% | |
| | Lysophosphatidylcholine 7.5% | |
| | Lysolecithin 4.9%-7.5% | |
| | Phosphatidylinositol 3.1% | |
| | Lysophosphatidylethanolamine 3.6% | |
| | Phosphatidylinositol 4,5-bisphosphate 1.8% | |
| | Phosphatidic acid 1.9% | |
| | Phosphatidylinositol 4-phosphate 1.5% | |
| | Cardiolipin 1.9% | |
| | (PMID 1315902 and 6057496) | |
| Hyaluronic Acids | Important for hydration of the skin - | Dry skin, eczema, |
| (mixed types) | holds >1000 times its weight in water, | psoriasis, burns, |
| Range: 0.0001%-30% | especially useful in the treatment of | facilitating stem cell |
| by weight | dry skin (xerosis), eczema and psoriasis. | migration and |
| | | proliferation in wound |
| | | healing. |
| Vegetable glycerin | Important as a barrier and for hydration of the | Dry skin, eczema, |
| Range: 0.0001%-30% | skin, used to seal in moisture. Useful as an | psoriasis, burns |
| by weight | emulsifier. | |
| Fusogens such as | (PMID 30502271) Fusogens: Chemical Agents | Potentially useful in |
| (polyethylene glycol, | That Can Rapidly Restore Function After Nerve | peripheral neuropathy |
| chitosan, dextran | Injury. “Chitosan and Its Applications: A | |
| sulfate, n-nonyl | Review of Literature”, | |
| bromide, calcium, | | |
| sodium nitrate, and H- | | |
| α-7) | | |
| Range: 0.0001%-50% | | |
| by weight | | |
| Alpha-Lipoic Acid | Antioxidant which specifically protects lipids | Peripheral |
| Range: 0.001%-10% | such as those found in the myelin sheath of | neuropathy, anti- |
| by weight | neurons. Possesses anti-inflammatory properties | aging, diabetic |
| | by downregulating NFKB (NF kappa B) helpful | peripheral neuropathy, |
| | in improving diabetic polyneuropathy, reducing | anti-inflammatory, |
| | oxidative stress, aging, cancer, improves | Raynaud's |
| | microcirculation (PMID 160261130), improves | Phenomenon |
| | blood flow to damaged nerves, nerve | |
| | conduction velocity, and other measures of | |
| | nerve function; is safe and efficacious in the | |
| | treatment of diabetic neuropathy (PMID | |
| | 25381809) | |
| Low Dose Naltrexone | While not a natural compound, it was decided | Multiple clinical |
| (LDN) | to include this as it is a safe drug with minimal | reports of LDN have |
| Range: 0.5 mg-5 mg | side effects, and when used in a low dose of 1 | demonstrated benefits |
| daily = Low Dose | to 5 mg daily has been found to reduce glial | in fibromyalgia, |
| Naltrexone (LDN) | inflammatory response by modulating Toll-like | Chronic Fatigue |
| <1 ug X <0.5 mg daily = | receptor 4 signaling in addition to systemically | Syndrome (CFS), |
| Very Low Dose | upregulating endogenous opioid signaling by | Crohn's Disease |
| Naltrexone (VLDN) | transient opioid-receptor blockade (PMID | (CD), Multiple |
| <1 ug daily = Ultra | 30248938) | Sclerosis (MS), |
| Low Dose Naltrexone | Ranges: | complex-regional pain |
| | LDN: fibromyalgia, Crohn's disease, multiple | syndrome, Hailey- |
| | sclerosis, complex-regional pain syndrome, | Hailey disease, and |
| | Hailey-Hailey disease, and different types of | different types of |
| | cancer | cancer (PMID |
| | VLDN: boosting tolerability of opioid-weaning | 30248938) |
| | methadone taper | |
| | ULDN: postoperative control of analgesia | |
| | (reduces the need for total amount of opioids | |
| | following surgery and ameliorating side-effects | |
| | of opioid-related treatment) | |

The nutritional supplements and formulations of the invention may further comprise one or more additional component(s) selected from a group consisting of a phospholipids, ceramides, cholesterol, fatty acids, oils, biosilicates, vitamins, minerals, amino acids, a hyaluronic acid, a fusogen, a biofermentation product of fruit, seaweed or other plants, dead sea salt, an organic pea protein, an organic brown rice protein, N-acetyl cysteine, stillbenoids, polyphenols, bioflavonoids, plant extracts, oils derived from animals or other organic matter, pollen, honey, and mixtures of any of the foregoing. The formulation may be free from conventional drugs (i.e., substances approved by regulatory authorities (e.g., US FDA) for treatment of diseases in humans). The formulations may also be free from preservatives. In some of the embodiments, the nutritional supplement or formulation comprises a drug approved by regulatory authorities (e.g., US FDA) for treatment of diseases in humans or animals. The nutritional supplement may, e.g., comprise tranexamic acid, fenbendazole, naltrexone.

In certain embodiments, the nutritional supplement may include one or more of the following:
Fuzheng Yiliu (extracts of Radix ginseng, Radix astragali (huang qi), Ganoderma lucidum (lingahi), Angelica sinensis (dang gui) and lyceum chinense (gou qi zi) as this formula has been shown to increase DC3+, CD4+ and NK cells, and inhibiting hepatocellular cancer (PMID 32372963, PMID 22791308);
Shen Qi Fu Zheng injection (extracts of codonopsis (dang shen) and Radix astragalus (huang qi) as this improved chemotherapy outcomes and improved immune function by upregulating CD3+, CD4+, CD4+/CD8+, and NK+ cells while reducing adverse side effects such as leukocytopenia, thrombocytopenia, and gastrointestinal toxicity (PMID 32372963, PMID: 28953950);
Xiao Ai Ping (Marsdenia tenacissima, tong guan teng) as this promotes both infiltration and function of CD8+ T cells (PMID 32372963, PMID 31236124);
Fei Yanning Formula (Radix astragali mongolicin (sheng huangqi) 40 g, Rhizoma atractylodis macrocephalae (baizhu) 15 g, Succys bufo skin (gan chenpi) 9 g, Nidus vespae (fengfang) 9 g, Rhizoma paridis (qiye yizhihua) 15 g, Rhizoma polygonate sibirici (huangjing) 30 g, herba epimedii brevicornus (sianlingpi) 15 g, Ganoderma lucidum (lingzhi) 30 g) as this has been found to reduce Treg cells of the spleen and thymus and in downregulating Foxp3, iNOS, and COX-2 mRNA in tumors (PMID 32372963, PMID 22704420, PMID 19671412);
American ginseng or panacis quinquefolia radix (xi yang shen) as it has been found to inhibit cancer of the liver, colon, and breast PMID 32372963);
Cistanche deserticola (rou cong rong) when used as an adjuvant as it enhanced proliferation of both T and B cells, the production of IFN-gamma and IL-4 in CD4+T cells, and expression of IFN-gamma in CD8+ T cells while downregulating Tregs while up-regulating levels of both CD40 and CD80 signaling proteins on the surface of antigen presenting cells, dendritic cells, B cells and monocytes (PMID 32372963);
polysaccharides from Epimedium koreanum nakai (yin yang huo), which was found to significantly increase macrophage activity in mice—showing enhanced CD4+ differentiation, increased immunomodulatory cytokines such as IFN-gamma and thus inhibiting tumor growth (PMID 32372963, PMID 28627460); and
herbal formulas found to stimulate immune function and decrease tumor burden. For example, the herbal formulas summarized in PMID 32372963.

In certain embodiments, nutritional supplements and formulation may comprise a biosilicate (e.g., a Food Grade Diatomaceous Earth (FDGE) biosilicate) or a plurality of biosilicates (e.g., a plurality of FDGE biosilicates). The biosilicate(s) may, e.g., extend a duration of a desired effect(s) of the formulation. In addition, or in alternative to biosilicates, nutritional supplements and formulations of the invention may comprise another pharmaceutically acceptable matrix. When included, biosilicates may comprise from about 1% to about 95%, about 5% to about 90%, about 10% to about 80%, or about 20 to about 60% of the nutritional supplement by weight or volume. For example, biosilicates may comprise from about 1% to about 45% of the nutritional supplement or formulation by weight. In some of the embodiments, the biosilicates may be preloaded with one or more component(s) to create a fraction which provide extended release of one or more component(s).

In some of the embodiments, biosilicates and pharmaceutically acceptable matrices provide release of a component(s) of the formulation for an extended period. The extended release may, e.g., be provided at least for 10 hours, 12 hours, 14 hours, 16 hours, 18 hours, 20 hours, 22 hours, 24 hours, 26 hours, 28 hours, 30 hours, 36 hours, 48 hours, 60 hours, 72 hours, 96 hours, 5 days, 6 days, 7 days, 8 days, 9 days, or 10 days. The extended release may be provided up to 1 week, 2 weeks, 3 weeks, 4 weeks, 5 weeks, 6 weeks, 7 weeks, 8 weeks, 9 weeks, 10 weeks, 11 weeks, 12 weeks, or longer, after application of the formulation to an affected area.

In some of the embodiments, the nutritional supplement or formulation may be loaded onto a biosilicate or another pharmaceutically acceptable matrix and admixed with Liquid Skin to improve delivery and allow for extended local delivery at a desired location (e.g., a tumor or into cells to reprogram stem cells and to alter the tumor microenvironment).

A nutritional supplement or formulation in accordance with the invention may comprise one or more exosome(s). Exosomes may, e.g., be loaded onto biosilicates (e.g., FDGE biosilicates) for, e.g., localized and/or extended release. In certain embodiments, administration of stem cell exosomes may heal and reprogram diseased stem cell niches “tumor microenvironment” which have been converted into cancer stem cell niches back into healthy stem cell niches. In certain embodiments, administration of stem cells may delay and/or may prevent future recurrences and perpetual generation of cancer stem cells as well as tumor cells.

### Fatty Acids

A nutritional supplement or a formulation in accordance with the invention may comprise a fatty acid or a mixture of fatty acids. The fatty acids may, e.g., be supplied in the form of oil or a mixture of oils.

The individual fatty acids, the mixtures of fatty acids, and oils in the formulations of the invention may, e.g., act as a carrier for incorporation and/or delivery of other phospholipids, ceramides, cholesterol, essential and free fatty acids, additional oils, vitamins, minerals, bioactive ingredients, and additional therapeutic agents into and/or through cell membranes and/or (ii) as a therapeutic agent, e.g., to correct an impairment in a cell membrane composition and/or function and/or (iii) to stimulate expression of stem cell transcription factors Sox-2, Nanog, Oct4, Klf4, and c-Myc and/or (iv) downregulate expression of markers of inflammation such as COX2, NO, TNF-α, and iNOS, thromboxane B2, prostaglandin E2, leukotriene B4, IFNγ, interleukin-1 (IL-1), IL-6, IL-8, IL-12, and PPARγ (v) stimulate production of anti-inflammatory cytokines and/or (vi) stimulate production of pluripotent stem cells (e.g., capable of differentiating into skin cells, connective tissues, blood vessels, neurons, and a variety of other cell types). The mixture may comprise only vegetable oils, only animal oils or a combination of vegetable oils and animal oils, with or without at least one additional component(s). In the preferred embodiments, the formulation comprises a base composition comprising a mixture of fatty acids and at least one additional ingredient. The fatty acids for the compositions may be contained in oil(s) included in the formulations.

The fatty acids in the formulations may come from oil(s) and/or fats or may be individually incorporated into the mixture.

The formulation may comprise a mixture of specific fatty acids in specific ratios such that the formulation may cross, integrate, modulate, regulate, or restore a function(s) of a membrane of a cell, an organelle and/or a function of cell and/or an organelle and/or an exosome.

The fatty acids in the nutritional supplements or formulations may, e.g., be selected from a group consisting of myristic acid (C14:0), lauric acid (C12:0), palmitic acid (C16:0), arachidonic acid (C20:4 n-6), stearic acid (C18:0), oleic acid (C18:1 n-9), linoleic acid (C18:1 n-9), linoleic acid (C18-3 n-9), crotonic acid (C4H602), myristoleic acid, palmitoleic (C16:1) acid, sapienic acid (C16:1 n-10), oleic acid (C18:1 n-9), elaidic acid or trans-oleic acid (C18:1 n-9), vaccenic acid (C18:1 n-7), gadoleic acid (C20:1 n-11), eicosenoic acid (C20:1 n-9), erucic acid (C22:1 n-9) nervonic acid (C24:1 n-9), or a combination of two or more of any of the foregoing.

In addition to the fatty acids, the formulations may comprise other components, as, e.g., described in detail herein. The ratio of the fatty acids in the mixture and the formulations themselves (i.e., the individual components of the formulation and their amounts) are customizable, as for example, described in detail below, to address specific diseases, and/or root deficiencies, and/or restore a composition of a membrane of a cell, as well as the membrane of various organelles within a cell (e.g., a mammalian cell), and/or restore and/or improve cellular function(s).

### Fatty Acid Composition of the Base Composition

The present invention specifically encompasses formulations comprising a fatty acid composition substantially similar (i.e., approximate) to a fatty acid composition of healthy human skin and/or sebum and/or human cells.

The formulation may comprise a mixture of individual fatty acids, wherein the fatty acids are combined in the mixture such that the mixture and/or formulation has a fatty acid composition that is substantially the same (i.e., approximate) as that of non-diseased human skin and/or sebum and/or cell membranes. In some of these embodiments, the fatty acids are combined such that the fatty acid composition of the mixture is substantially the same as that of human skin and/or sebum. In some of these embodiments, the fatty acids are combined such that the composition of the mixture supplements components of a membrane of a cell, organelle or exosome which may be deficient in such components due to disease, poor diet, or another cause.

In some of the embodiments, the fatty acid composition of the formulation or the base composition included in the formulation may be identical or substantially similar to a fatty acid composition of the cell membrane, and the mammalian cell is a human cell. The mixture may, e.g., comprise, in % by volume, from about 0% to about 40% ceramides (e.g., 13%), from about 5% to about 99% fatty acids (e.g., 47%), including, e.g., phospholipids such as phosphatidylcholine, sphingomyelin, phosphatidylethanolamine, phosphatidylserine, and phosphatidylinositol; from about 0% to about 25% cholesterol (e.g., 7%), from about 0% to about 25% cholesterol esters (e.g., 2%), from about 0% to about 25% squalene (e.g., 11%), from about 0% to about 20% triglycerides (e.g., 3%), from about 5% to about 99% proteins (e.g., 47%), and from about 0% to about 30% wax esters (e.g., 17%). The mixture may also comprise myristic acid (C14:0), lauric acid (C12:0), palmitic acid (C16:0), arachidonic acid (C20:4 n-6), stearic acid (C18:0), oleic acid (C18:1 n-9), linoleic acid (C18:1 n-9), linoleic acid (C18-3 n-9), crotonic acid (C₄H₆O₂), myristoleic acid, palmitoleic (C16:1) acid, sapienic acid (C16:1 n-10), oleic acid (C18:1 n-9), elaidic acid or trans-oleic acid (C18:1 n-9), vaccenic acid (C18:1 n-7), gadoleic acid (C20:1 n-11), eicosenoic acid (C20:1 n-9), erucic acid (C22:1 n-9) nervonic acid (C24:1 n-9), or a combination of two or more of any of the foregoing, such that the fatty acid composition of the mixture is substantially the same as that of healthy human skin and/or sebum. The mixture may also comprise a composition that is sufficient to correct an imbalance in a membrane of a cell or a membrane of a cell organelle, e.g., supply deficient membrane component(s). In some of the embodiments, oleic acid comprises greater than 50% (e.g., about 65%, about 70%, about 75%, about 80%, about 85%, or about 95%) of the fatty acid composition. Generally, higher concentrations of oleic acid is required to penetrate into the subcellular organelles (e.g., to directly influence cellular metabolism) than a cell membrane because the compounds must cross more than one set of cell membranes. The fatty acids may be incorporated into the formulations by themselves or in the form of oils, phospholipids, or mixtures of lipids.

The fatty acids may be supplied, e.g., a mixture comprising coconut oil and macadamia nut oil and/or a mixture comprising coconut oil and macadamia nut oil and further comprising emu oil and/or high oleic sunflower seed oil.

In certain embodiments, the fatty acid composition of the invention mimics the fatty acid composition of healthy human sebum and/or subcutaneous fat. The composition of healthy human sebum and subcutaneous fat, along with composition of some oils, is provided in Table 2A and 2B.

TABLE 2A
Fatty Acid Composition of Human Sebum and Human Cells

| | | Human Sebum | Human Cell | Human Diabetic Cell |
|---|---|---|---|---|
| | Fatty Acid | (PMID 2940302) | (PMID 238788791) | (PMID 23878791) |
| Non-Esterified | Myristic Acid | 1.8%-2.1% | 2.48% | 2.68% |
| Fatty Acid | (C14:0) | | | |
| Fraction | Lauric Acid | 0.9% | 0.68% +/− 0.10 | 0.44% +/− 0.09 |
| | (C12:0) | | | |
| | Palmitic Acid | 20.2%-75.1% | 28.50% +/− 3.15 | 24.12% +/− 1.22 |
| | (C16:0) | | | |
| | Arachidonic Acid | * | 0.64% +/− 0.19 | 0.39% +/− 0.07 |
| | (C20:4 n-6) | | | |
| Phospholipid | Palmitic Acid | 20.2%-75.1% | 27.84% +/− 1.82 | 25.01% +/− 1.58 |
| Fraction | (C16:0) | | | |
| | Stearic Acid | 11.2%-13.3% | 13.15% +/− 1.24 | 14.62% +/− 1.18 |
| | (C18:0) | | | |
| | Oleic Acid | 30.8% | 8.13% +/− 1.24 | 8.96% +/− 1.08 |
| | (C18:1 n-9) | | | |
| | Linoleic Acid | 15.1% | 22.95% +/− 2.64 | 20.25% +/− 2.45 |
| | (C18:2 n-6) | | | |
| | Linolenic Acid | 0.3% | 0.16% +/− 0.04 | 0.11% +/− 0.05 |
| | (C18:3 n-9) | | | |
| Other Mono- | Combined | * | 11.64% +/− 1.36 | 9.45% +/− 1.32 |
| Unsaturated | MUFAs | | | |
| Fatty Acid | Crotonic Acid | * | * | * |
| (MUFA) | (C₄H₆O₂) | | | |
| Fraction | Myristoleic Acid | 1.8% | * | * |
| | (C14:1 n-5) | | | |
| | Palmitoleic Acid | 3.8%-15% | 1.41% | 1.45% |
| | (C16:1) | | | |
| | Sapienic Acid | 3.8%-15% | * | * |
| | (C16:1 n-10) | | | |
| | Oleic Acid | 30.8% | 8.13% +/− 1.24 | 8.96% +/− 1.08 |
| | (C18:1 n-9) | | | |
| | Elaidic Acid | 30.8% | 8.13% +/− 1.24 | 8.96% +/− 1.08 |
| | (C18:1 n-9) | | | |
| | Vaccenic Acid | 30.8% | 8.13% +/− 1.24 | 8.96% +/− 1.08 |
| | (C18:1 n-7) | | | |
| | Gadoleic Acid | 0.9% | * | * |
| | (C20:1 n-11) | | | |
| | Eicosenoic Acid | 0.9% | * | * |
| | (C20:1 n-9) | | | |
| | Erucic Acid | 1.4% | * | * |
| | (C22:1 n-9) | | | |
| | Nervonic Acid | * | * | * |
| | (C24:1 n-9) | | | |

* Insignificant amounts

The percent lipid composition of pooled human sebum analyzed by thin-layer chromatography was as follows: ceramides (13%), fatty acid (47%), cholesterol (7%), cholesterol esters (2%), squalene (11%), triglycerides (3%), and wax esters (17%) (PMID 12677098) with approximately 50% as phospholipids. In certain embodiments, the preparations of the invention follow these ratios, with adjustments to components made depending on the disease being targeted.

TABLE 2B
Fatty Acid Composition of Various Oils

| | | | High Oleic | | | | |
|---|---|---|---|---|---|---|---|
| | | | Sunflower | Macadamia | | | |
| | | | Seed Oil | Nut Oil | | | Flaxseed Oil |
| | | | (PMID | (PMID | | | (PMID |
| | Fatty Acid | Emu Oil¹ | 23610599) | 23610599) | Coconut Oil² | Olive Oil³ | 31623168) |
| Non- | Myristic Acid | 0.4% | 0.1% | 0.4%-1.6% | 13.1%-18.5% | 0.1%-2% | 0.08% |
| Esterified | (C14:0) | | | | | | |
| Fatty Acid | Lauric Acid | * | * | 0.1% | 44%-52% | * | * |
| Fraction | (C12:0) | | | | | | |
| | Palmitic Acid | 20%-22% | 2%-6.5% | 7%-10% | 8%-11% | 7%-16% | 4.9% |
| | (C16:0) | | | | | | |
| | Arachidonic Acid | * | * | 1.5%-3% | * | * | * |
| | (C20:4 n-6) | | | | | | |
| Phospholipid | Palmitic Acid | 20%-22% | 2%-6.5% | 8.3% | 7.5%-10.5% | 7.5%-20% | 5% |
| Fraction | (C16:0) | | | | | | |
| | Stearic Acid | 9.6%-18% | 3.57%-3.94% | 3.9% | 1%-3.2% | 0.5%-5% | 4%-4.8% |
| | (C18:0) | | | | | | |
| | Oleic Acid | 40%-47.4% | 75%-90.7% | 54%-63% | 5%-8.2% | 55%-83% | 18.3%-20.2% |
| | (C18:1 n-9) | | | | | | |
| | Linoleic Acid | 15.2%-20% | 2.1%-69.8%% | 1.6% | 0%-2.6% | 2.5%-21% | 16% |
| | (C18:2 n-6) | | | | | | |
| | Linolenic Acid | 0.9% | 0.1% | 0.1% | * | <1% | 57% |
| | (C18:3 n-9) | | | | | | |
| Other Mono- | Combined MUFAs | * | 19.2% | 81.3% | * | * | * |
| Unsaturated | Crotonic Acid | * | * | * | * | * | * |
| Fatty Acid | (C₄H₆O₂) | | | | | | |
| (MUFA) | Myristoleic Acid | * | * | * | * | * | * |
| Fraction | (C14:1 n-5) | | | | | | |
| | Palmitoleic Acid | 3.5%-5% | 0.1% | 16%-23% | 2.5%-10.5% | 0.3%-3.5% | 0.06% |
| | (C16:1) | | | | | | |
| | Sapienic Acid | * | 0.1% | 16%-23% | * | * | * |
| | (C16:1 n-10) | | | | | | |
| | Oleic Acid | 40%-47.4% | 75%-90.7% | 60.9% | 5%-8% | 55%-83% | 18.3%-20.2% |
| | (C18:1 n-9) | | | | | | |
| | Elaidic Acid | 40%-47.4% | 18.9% | 60.9% | 5%-8% | 55%-83% | 18.3%-20.2% |
| | (C18:1 n-9) | | | | | | |
| | Vaccenic Acid | 40%-47.4% | 18.9% | 60.9% | 5%-8% | 55%-83% | * |
| | (C18:1 n-7) | | | | | | |
| | Gadoleic Acid | * | 0.2% | 1%-3% | | * | 0.4% |
| | (C20:1 n-11) | | | | | | |
| | Eicosenoic Acid | * | 0.2% | 1%-3% | 0%-0.5% | 0.1%-0.3% | * |
| | (C20:1 n-9) | | | | | | |
| | Erucic Acid | * | * | * | * | * | * |
| | (C22:1 n-9) | | | | | | |
| | Nervonic Acid | * | * | * | * | * | * |
| | (C24:1 n-9) | | | | | | |

¹https://www.bluespringwellness.com/blogs/scientific-studies/fatty-acid-analysis-of-emu-oil
²https://www.chempro.in/fattyacid.htm
³https://www.chempro.in/fattyacid.htm

In certain embodiments, the formulation comprises a mixture of oils to match a fatty acid composition of human sebum, human cell or human diabetic cell as provided in Table 2A. In certain embodiments, the formulation comprises a mixture of oils to supplement a diseased cell membrane to improve profile of membrane components back to a state of health. The oils for inclusion in the mixture may be selected from the oils listed in Table 2B, or other oils. The oils are combined in specific amounts to provide a fatty acid composition that is different from a fatty acid composition of the individual oils used and is better suited for an intended purpose.

For example, in certain embodiments, the formulation may comprise a mixture of (i) macadamia nut and coconut oil and (ii) emu oil or high oleic sunflower seed oil. The addition of macadamia nut and coconut oils to either emu oil or to high oleic sunflower seed oil results in a fatty acid composition comprising oleic acid concentration that is substantially identical to (or higher) than the concentration of oleic acid in human cell membranes and may therefore facilitate and/or improve permeability of the formulation and its components into cell membranes and/or into the subcellular spaces and/or into the subcellular organelles of a mammalian cell. In some of these embodiments, the addition of macadamia nut and coconut oils to either emu oil (as in Liquid Skin) or to high oleic sunflower seed oil (as in Vegan Liquid Skin) increases the oleic acid at minimum 5-fold that of human cell membranes, resulting in greater penetrability of admixed therapeutic substances into the cell membrane, into the subcellular space, or into the subcellular organelles of a mammalian cell (e.g., a mammalian cell). Higher concentrations of oleic acid may be required to penetrate into the subcellular organelles (e.g., to directly influence cellular metabolism) because the compounds must cross more than one set of cell membranes.

In view of the information provided herein, including Table 1, Tables 2A and 2B, one of ordinary skill in the art would be able to tailor a fatty acid composition of the mixture by using various oils and in specific amounts and provide a desired fatty acid composition and/or formulation without undue experimentation.

In certain embodiments, the composition comprises emu oil. Emu oil may comprise, in % by volume, from about 1% to about 99%, from about 2% to about 99%, from about 5% to about 98%, from about 10% to about 96%, from about 15% to about 96%, from about 20% to about 95%, from about 25% to about 95%, from about 30% to about 95%, from about 40% to about 95%, from about 45% to about 95%, from about 60% to about 95%.

In consideration of subjects who may object to the animal origin of emu oil, in certain embodiments, the invention is directed in part to the use of a blend of organic vegetable oils to achieve a profile similar to that of the composition seen in healthy human skin and human subcutaneous adipose (PMID 23878791). In shall be noted that the fatty acid profile of the formulation may be optimized for specific diseases intended to be treated by the formulation and route of administration. For example, in certain embodiments the formulation may comprise organic high-oleic sunflower seed oil, with a high oleic acid content of 75-91% and used as a topical preparation useful in stimulating peripheral neuronal growth, since oleic acid is a necessary component of myelin sheath formation for neuronogenesis (the formation of new neurons in an adult human). Some of the vegetable oils that can be used in the formulation of the invention are listed in Table 2B, above, and include olive oil, due to the additional benefits of polyphenols (antioxidants), vitamins, and essential fatty acids present in this healthful oil, as well as flax seed oil and coconut oil.

Oleic acid is postulated to be the fatty acid most responsible for the superior penetration properties of emu oil, which confer its penetration properties upon substances intermixed in it. Emu oil has been demonstrated to penetrate and to carry active ingredients (PIMD 27178879, PMID 28527394) around 3 mm into human skin, by destabilizing the alpha-helix structure of keratin (PMID 28527392), interacting with fats in the skin (PMID 28527394), and promoting restructuring of skin (PMID 15837639, PMID 15567771, PMID 27069472). Application of pure emu oil alone has been found to have anti-inflammatory, and thus analgesic effects. This effect may be improved, in the present invention, upon modifying the fatty acid composition of emu oil, e.g., by blending emu oil with one or more additional oil(s) (e.g., vegetable oils) to make the profile to more closely resemble that of a human or mammalian cell membrane, a cell, an organelle, or an exosome, depending on the intended target.

The fatty acid composition of the formulation may be adjusted using the base compositions and additional ingredients disclosed herein to render the formulation capable of crossing, integrating, modulating, regulating, or restoring cell membranes of the following cells: skin cells, brain cells, fibroblast cells, endothelial cells (cells lining the blood vessels), macrophages, immune cells, red blood cells, white blood cells, lymphocytes, leukocytes, hepatocytes, neurons, astrocytes, microglia, oligodendrocytes, bronchial endothelial cells, respiratory interstitial cells, sustentacular cells, olfactory bulb neurons, adipocytes, dermal fibroblasts, muscle cells, cardiomyocytes, pancreatic islet cells, Brunner's gland cell in the duodenum (secrete enzymes and alkaline mucus), all glandular cells, goblet cells of the respiratory mucosa (secrete mucus), goblet cells of the digestive tract (secrete mucus), foveolar cells (secrete mucus), chief cells (secrete pepsinogen), parietal cells (secrete HCL), pancreatic acinar cells (secrete bicarbonate and digestive enzymes), Paneth cells of the small intestine (secrete lysozyme), type II pneumocytes of the lungs (secrete surfactant), club cells of the lung, type I pneumocytes, epithelial cells of every organ, centroacinar cells of the pancreas, intercalated duct cell of the pancreas, intestinal brush border cells with microvilli, enteroendocrine cells, K cells (secrete gastric inhibitory peptide), L cells (secrete glucagon-like peptide-1, peptide YY3-36, oxyntomodulin, and glucagon-like peptide-2), I cells (secrete cholecystokinin), G cells (secrete gastrin), enterochromaffin cells (secrete serotonin), enterochromaffin-like cells (secrete histamine), N cells (secrete neurotensin), S cells (secrete secretin), D cells (secrete somatostatin), Mo cell or M cell (secrete motilin), megakaryocytes, bone marrow cells, bone cells, osteoclasts, osteoblasts, mast cells, thyroid epithelial cells, parafollicular cells of the thyroid, parathyroid chief cells, oxyphil cells, alpha cells of the pancreas (secrete glucagon), beta cells of the pancreas (secrete insulin and amylin), delta cells of the pancreas, secrete somatostatin), epsilon cells of the pancreas (secrete ghrelin), PP cells, a.k.a. gamma cells of the pancreas (secrete pancreatic polypeptide), salivary gland mucous cells, salivary gland serous cells, Von Ebner's gland cells in the tongue, mammary gland cells (secrete milk), lacrimal gland cells (secrete tear), ceruminous gland cells in ear (secrete earwax), eccrine sweat gland dark cells (secrete glycoprotein), eccrine sweat gland clear cells (secrete small molecule), apocrine sweat gland cells (secrete odoriferous secretions; are sex-hormone sensitive), gland of Moll cells in eyelid (specialized sweat glands), sebaceous gland cells (secrete lipid-rich sebum), Bowman's gland cells in nose, olfactory epithelial cells, hair cells, hair follicle cells, endogenous stem cells of each organ, corticotropes, gonadotropes, lactotropes, melanotropes, somatotropes, thyrotropes, magnocellular neurosecretory cells (secrete oxytocin and vasopressin), parvocellular neurosecretory cells (secrete thyrotropin-releasing hormone, corticotropin-releasing hormone, vasopressin, oxytocin, neurotensin, and prolactin), chromaffin cells of the adrenal glands, keratinocytes, epidermal basal cells, melanocytes, trichocytes (give rise to hair and nail cells), medullary hair shaft cells, cortical hair shaft cells, cuticular hair shaft cells, Huxley's layer hair root sheath cells, Henle's layer hair root sheath cells, outer root sheath hair cells, surface epithelial cells of the cornea, tongue, mouth, nasal cavity, distal anal canal, distal urethra, distal vagina; basal cells (stem cells of the cornea, tongue, mouth, nasal cavity, distal anal canal, distal urethra and distal vagina), intercalated duct cells of the salivary glands, striated duct cells of the salivary glands, lactiferous duct cells of the mammary glands, ameloblasts (secrete and deposit tooth enamel), odontoblasts (secrete and form tooth dentin), cementoblasts (secrete and form tooth cementum), auditory inner hair cells of the organ of Corti, auditory outer hair cells of the organ of Corti, basal cells of olfactory epithelium (stem cells for olfactory neurons), cold-sensitive primary sensory neurons, heat-sensitive primary sensory neurons, Merkel cells of the epidermis, olfactory receptor neurons, pain-sensitive primary sensory neurons, photoreceptor rod cells, photoreceptor blue-sensitive cone cells of the eye, photoreceptor green-sensitive cone cells of the eye, photoreceptor red-sensitive cone cells of the eye, proprioceptive primary sensory neurons, chemoreceptor glomus cells of the carotid body cell (blood pH sensors), outer hair cells of vestibular system of ear (acceleration and gravity sensors), taste receptor cells of the taste buds, cholinergic neurons, adrenergic neurons, peptidergic neurons, inner pillar cells of the organ of Corti, outer pillar cells of the organ of Corti, inner phalangeal cells of the organ of Corti, outer phalangeal cells of the organ of Corti, border cells of the organ of Corti, vestibular apparatus supporting cells, taste bud supporting cells, olfactory epithelium supporting cells, olfactory ensheathing cells, Schwann cells, satellite glial cells, enteric glial cells, interneurons, basket cells, cartwheel cells, stellate cells, Golgi cells, granule cells, Lugaro cells, unipolar brush cells, Martinotti cells, chandelier cells, Cajal-Retzius cells, double-bouquet cells, neurogliaform cells, retina horizontal cells, amacrine cells, starburst amacrine cells, spinal interneurons, Renshaw cells, principal cells, spindle neurons, fork neurons, pyramidal cells, place cells, grid cells, speed cells, head direction cells, Betz cells, stellate cells, boundary cells, bushy cells, Purkinje cells, medium spiny neurons, ependymal cells, tanycytes, pituicytes, lens cells, anterior lens epithelial cells, corneal epithelial cells, crystallin-containing lens fiber cells, white fat cells, brown fat cells, beige fat cells, other adipocytes, liver adipocytes, cells of the adrenal cortex, cells of the zona glomerulosa (secrete mineralocorticoid), cells of the zona fasciculata (secrete glucocorticoid), cells of the zona reticularis (secrete androgen), theca interna cells of the ovarian follicle (secrete estrogen), corpus luteum cells of the ruptured ovarian follicle (secrete progesterone), granulosa lutein cells, theca lutein cells, Leydig cells of the testes (secrete testosterone), seminal vesicle cells (secrete seminal fluid), prostate gland cells (secrete seminal fluid components), bulbourethral gland cells (secrete mucus), Bartholin's gland cell (secrete vaginal lubricants), gland of Littre cells (secrete mucus), uterus endometrial cells (secrete carbohydrate), juxtaglomerular cells (secrete renin), myometrial cells, macula densa cells of the kidney, peripolar cells of the kidney, mesangial cells of the kidney, parietal epithelial cells, podocytes, proximal tubule brush border cells, loop of Henle thin segment cells, kidney distal tubule cells, kidney collecting duct cells, principal cells, intercalated cells, transitional epithelial cells (lining urinary bladder), duct cells of seminal vesicles, duct cells of prostate gland, etc., efferent duct cells, epididymal principal cells, epididymal basal cells, planum semilunatum epithelial cells of the vestibular system of the ear (secrete proteoglycan), organ of Corti interdental epithelial cells (secrete tectorial membrane covering the hair cells), loose connective tissue fibroblasts, cells of the fascia, corneal fibroblasts (corneal keratocytes), tendon fibroblasts, bone marrow reticular tissue fibroblasts, nonepithelial fibroblasts, pericytes, hepatic stellate cells (Ito cells), nucleus pulposus cells of the intervertebral disc, hyaline cartilage chondrocytes, fibrocartilage chondrocytes, elastic cartilage chondrocytes, osteoblasts/osteocytes, osteoprogenitor cells (stem cells of the osteoblast), hyalocytes of the vitreous body of the eye, stellate cells of the perilymphatic space of the ear, pancreatic stellate cells, red skeletal muscle cells (slow twitch), white skeletal muscle cells (fast twitch), intermediate skeletal muscle cells, nuclear bag cells of the muscle spindle, nuclear chain cells of muscle spindles, myosatellite cells (stem cells of the muscle), cardiac muscle cells, SA node cells, Purkinje fiber cells, smooth muscle cells, myoepithelial cells of the iris, myoepithelial cells of the exocrine glands, monocytes, connective tissue macrophages associated with each type of tissue or organ, epidermal Langerhans cells, dendritic cells in lymphoid tissue, neutrophil granulocytes and precursors (myeloblasts, promyelocytes, myelocytes, metamyelocytes), eosinophils, granulocytes and precursors (basophil granulocytes and precursors), helper T cells, regulatory T cells, cytotoxic T cells, natural killer T cells, B cells, plasma cells, natural killer cells, hematopoietic stem cells and committed progenitors for the blood and immune system, oogonium cells, oocytes, spermatids, spermatocytes, spermatogonium cells (stem cells for spermatocytes), spermatozoon cells, nurse cells, granulosa cells (in ovaries), Sertoli cells (in testis), epithelial reticular cells (in thymus), and interstitial kidney cells.

The present invention encompasses nutritional supplements and formulations comprising a composition comprising palmitic acid, stearic acid, oleic acid, and linoleic acid, wherein the palmitic acid comprises from about 20% to about 75% of the composition by weight, the stearic acid comprises from about 11% to about 13% of the composition by weight, the oleic acid comprises from about 8% to about 31% of the composition by weight, the linoleic acid comprises from about 15% to about 23% of the formulation by weight.

In some of the embodiments, the mixture of fatty acids included in the nutritional supplement and formulations of the invention may comprise a fatty acid composition that is similar to that of a mammalian cell membrane (e.g., a human cell membrane), except that it contains more oleic acid that the mammalian cell. In some of the embodiments, the concentration of oleic acid may be adjusted to facilitate different degrees of penetration for admixed component(s).

### Oils

The oils included in the mixtures of the present invention may be selected, e.g., from a group comprising or consisting of emu oil, German chamomile essential oil, Moroccan chamomile essential oil, Roman chamomile essential oil, coconut oil, macadamia oil, jojoba wax, lime essential oil, grapefruit essential oil, blackberry seed oil, blueberry seed oil, raspberry seed oil, yuzu essential oil, turmeric essential oil, garlic essential oil, wolfberry seed oil, jasmine essential oil, ginger essential oil, myrrh essential oil, orange essential oil, organic extra virgin olive oil, clove essential oil, calamus essential oil, cassia essential oil, cinnamon essential oil, frankincense essential oil, rosemary essential oil, Eucalyptus essential oil, flaxseed oil, lemon essential oil, lemongrass essential oil, xiang mao essential oil, galangal root essential oil, licorice extract, pomegranate seed oil, ravintsara essential oil, bergamot essential oil, cinnamon leaf essential oil, Bupleurum extract, Jasminum officinale essential oil, Vanilla planifolia essential oil, Artemisia absinthium essential oil, Artemisia annua essential oil, xiang mao oil, blackseed oil, avocado seed oil, apricot seed oil, tangerine essential oil, red thyme essential oil, white thyme essential oil, oregano essential oil, laurel leaf essential oil, niaouli essential oil, palmarosa essential oil, Rosalina essential oil, fennel essential oil, Litsea essential oil, pomelo essential oil, and combinations of any of the foregoing.

In some of these embodiments, the formulation comprises emu oil and at least one additional ingredient selected from the group consisting of German chamomile essential oil, Moroccan chamomile essential oil, Roman chamomile essential oil, coconut oil, macadamia oil, jojoba wax, lime essential oil, grapefruit essential oil, blackberry seed oil, blueberry seed oil, raspberry seed oil, yuzu essential oil, turmeric essential oil, garlic essential oil, wolfberry seed oil, jasmine essential oil, ginger essential oil, myrrh essential oil, orange essential oil, organic extra virgin olive oil, clove essential oil, calamus essential oil, cassia essential oil, cinnamon essential oil, frankincense essential oil, rosemary essential oil, Eucalyptus essential oil, flaxseed oil, lemon essential oil, lemongrass essential oil, xiang mao essential oil, galangal root essential oil, licorice extract, pomegranate seed oil, ravintsara essential oil, bergamot essential oil, cinnamon leaf essential oil, Bupleurum extract, Jasminum officinale essential oil, Vanilla planifolia essential oil, etc.), and combinations of any of the foregoing.

### Biofermentation

Biofermentation, which is the use of microbes such as bacteria and fungi to ferment an existing product, is a helpful tool to diversify an array of phytochemicals or bioactive compounds to increase bioactivity, increase the number of compounds, depending on the starting materials, duration, and selected microorganisms.

Biofermentation is a process by which already beneficial compounds are metabolized into multiple useful compounds, essentially creating multiple iterations of similar molecules (PMID 12002340) with slightly different actions and binding activity, duration of effect, etc. which is useful for preventing the rapid acclimatization of cancer cells to chemotherapy since cancer is a dynamic, ever-evolving disease.

In certain embodiments of the present invention, biofermentation is used to increase biodiversity of the nutrition, antioxidants, and phytochemicals found in plant matter, especially the contents within the seeds (e.g., endosperm as these comprise the nutritive content of the plant's germ cells), most which have anti-inflammatory and anti-cancer properties as seeds are the stem cells of the plant.

In some of the embodiments, biofermentation increases compounds that may decrease proliferation and/or induce apoptosis of abnormally dividing cells and/or alter signaling between these cells. In these embodiments, biofermentation increases the number of compounds with anti-cancer properties, as compared to a formulation prior to the fermentation.

For example, punicic acid derived from pomegranates possess a myriad of beneficial bioactive properties, including anti-cancer, anti-diabetic, anti-obesity, antioxidant, anti-inflammatory properties to name a few. However, extracting punicic acid is limited by low yield and unstable supply of pomegranate seeds which are available only during the fall season. Fermentation of whole crushed pomegranates, including the seed, arils, internal septations, fiber and juice provides a greater number of bioactive compounds, derivatives of punicic acid and other compounds from pomegranates with the above properties due to chemical modifications made by the microorganisms, resulting in variants of these beneficial phytochemicals some which possessed greater abilities against cancer and other diseases as compared to unfermented pomegranate juice.

In certain embodiments, biofermentation may involve sonic activation and be done in iterations. For example, the first batch of macerated fruit/seeds will be allowed to ferment at room temperature. After 24 hours of fermentation, a second portion of macerated fruit/seeds will be added to the initial batch to introduce additional biochemical diversity. Every 24 hours another portion of macerated fruit/seeds will be added to the mix, to further increase the diversity of compounds generated as some chemical reactions are instantaneous while others require a multi-step process. The biofermentation process may continue for at least 72 hours or a total of 3 to 120 days (e.g., 10 to 90 days) prior to use. In some embodiments, extraction of active compounds in alcohol or other solvents may is used to concentrate active compounds prior to administration.

In certain embodiments, a formulation comprises one or more biofermentation product(s). The biofermentation product(s) may, e.g., be derived from plants (e.g., a fruit, a legume, or an herb). The fruit and plants may, e.g., comprise a compound with anti-cancer and/or chemoprotective properties and or chemopreventive properties. In some of the embodiments, such a compound is resveratrol.

In some of the embodiments for topical application, the biofermentation products may be combined with Liquid Skin in a 1:3 ratio will ensure that all the biofermentation products will be properly coated with Liquid Skin components that will confer penetration of biofermentation products into the cells.

In some of the embodiments, the biofermentation products maybe loaded onto diatoms to allow long-acting delivery of these compounds.

### Delivery System

In one aspect, the invention is directed in part to a delivery system comprising a mixture of fatty acids. In certain embodiments, the mixture comprises emu oil. Emu oil possesses a high concentration (up to 47%) of oleic acid in addition to other naturally occurring substances which result in anti-inflammatory properties useful in the treatment of pain and other inflammatory illnesses. The composition by percentage of fatty acids from Emu shows that it is quite comparable to that of human skin (See Table 2), with the exception of a slightly higher percentage of oleic acid (47%) vs 31% for human skin. This similarity in composition to human skin renders it capable of serving as a carrier for other lipid as well as aqueous ingredients. For example, in certain embodiments emu oil may be combined with a selected mixture of vegetable oils composed to mimic the fatty acid profile of human skin and sebum (hereinafter, “Liquid Skin”) that can be admixed with medicinally active compounds such that they incorporate into existing skin cells or may be used as raw material for creating new cells. Similarly, it is possible to create a “Vegan Liquid Skin” by using a mixture of vegetable oils to approximate the fatty acid profile of human skin and sebum. For ease of reference, “Liquid Skin” in the present disclosure encompasses both types of mixtures.

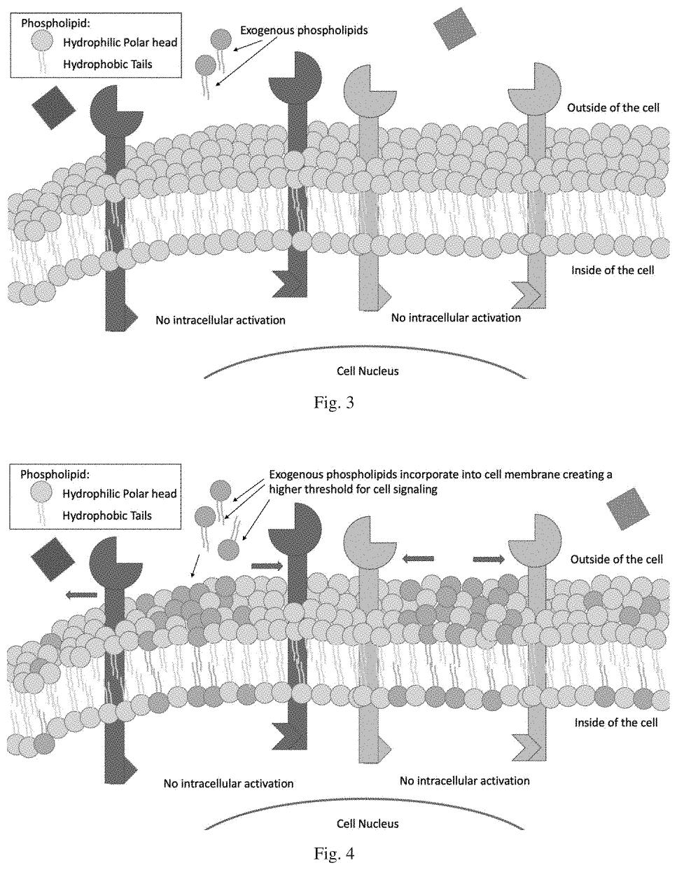

Additionally, the integration of additional phospholipids, ceramides, cholesterol, essential and free fatty acids into existing cell membranes create distance between receptors for pain and inflammation within the cell membrane, which require proximity in order to function in signal transduction (See FIGS. 3-4). This culminates in an increased pain threshold, since it would decrease the chance of transmembrane receptors interacting to signal for pain.

Thus, in one aspect, the invention is directed in part to a mixture of various oils to mimic or restore or modulate the fatty acid profile of healthy human skin and sebum, which can be customized to deliver medicinally active compounds for the treatment of multiple diseases.

To further illustrate these concepts and to emphasize the significance of the oil blend that is identical or substantially similar or can modulate the composition of healthy human skin/oil in the treatment of diseases, and can modify it, basic cellular biology of the following information is provided.

Phospholipids are phosphorus-containing lipids composed of a fatty acid, a phosphate group, a glycerol, and a simple organic molecule such as choline; they are the basic building block of cell membranes.

Due to the complexity of the chemical structure, phospholipids are typically represented as a ball-like structure with two tails in most diagrams.

Of note, phospholipids can self-assemble in water into organized bilayer structures or even micelles (spheres).

The cell is essentially a giant double-layered liposome, which houses many smaller organelles “mini organs” which are the machinery of the cell (akin to lifting up the hood of a car to see the parts that make up an engine) including the cell nucleus which is the command center of the cell housing the deoxyribonucleic acid or DNA (think of the nucleus as the hub that directs the organelles how to function, what proteins to make, etc.). Any cell can individually activate specific DNA sequences to make proteins that cause the cell to signal to other cells. If the DNA sequences become activated out of sequence or lose their system of checks and balances, then cancer or other diseases may result. Similarly, if cells lose their function, or the healthy ability to recognize that it is damaged and fail to auto-destruct in an orderly fashion (“apoptosis”), this also leads to disease. Thus, the cell surface is critical for how signals from outside the cell make its way into the cell nucleus to change the activity and function of the cell. A healthy cell membrane is required for signals from within the cell to be sent appropriately into the environment outside of the cell. One cell's signaling directly alters the activity of other cells locally or in remote locations.

If one were to snip out a small square from the surface of the human cell membrane, one would discover that there are many proteins, lipids, signaling proteins, ceramides, cholesterol, receptors and other biologically active molecules spanning the cell surface; as well as some that are only on the outer or inner leaflet of the cell membrane, each which are important in signaling for different cell pathways (such as ones for cell division, cell death, inflammation, cancer, diabetes, etc.).

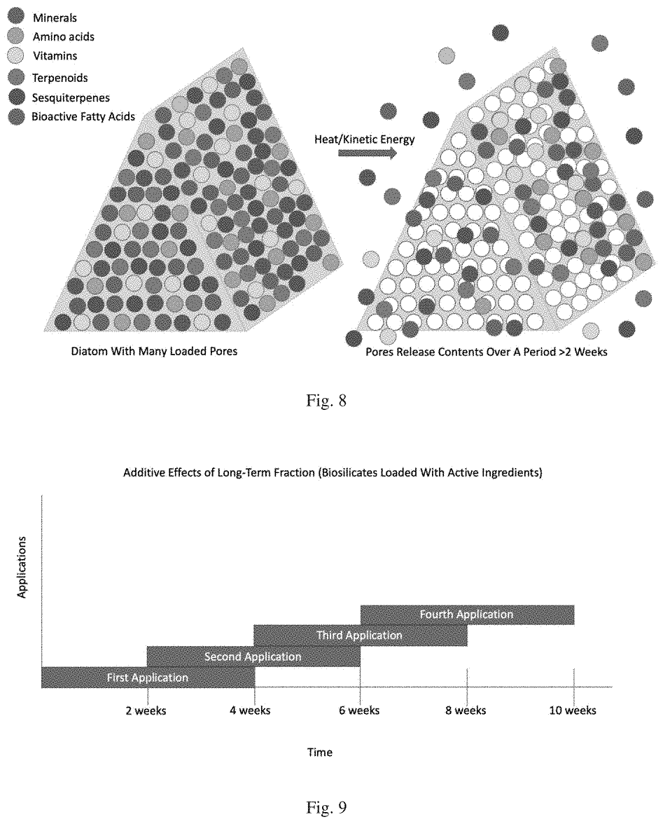

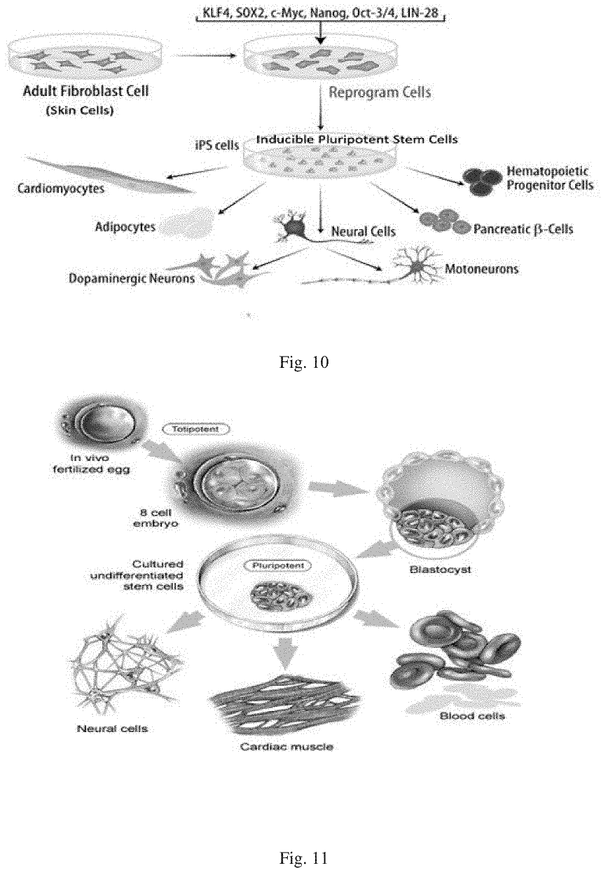

Information from outside of the cell is transmitted via reactions at the outer cell membrane leaflet, resulting in changes in membrane-embedded cell receptors that leads to changes inside the cell, resulting in gene expression and protein production within the cell (FIG. 8).

For example, this cross section of a cell shows the EGFR (Epidermal Growth Factor Receptor) embedded in the cell membrane. EGFR is important in cell proliferation. Dysregulated EGFR signaling leads to unregulated cell growth, cancer, and metastases.

The EGFR receptors must move together closely in the cell membrane (displacing phospholipids to do so) in order for the extracellular signals (the EGFR-specific ligands) outside of the cell to exert their effects (delivering the “order” for the cell to start dividing) to the cell nucleus (the command center of the cell). Similar receptors exist for pain, and other biological processes in a mammal

The cell membrane is the site where signals from the outside environment are interpreted and translated into directions that drive that cell's behavior. A healthy cell membrane is composed of a mixture of lipids, proteins, and sugars, organized into regional domains (commonly called “lipid rafts”) that serve to signal for multiple aspects of cell behavior such as growth, cell division, pain, cell differentiation, or cell death (PMID 31052427). Specific sub-compartments of the cell possess different lipid compositions (PMID 31052427), which when altered due to diet or genetic defects lead to alterations in cell function, metabolism, and ultimately to chronic disease such as cancer (PMID 30518103), diabetes (PMID 29462590, 28742512), Alzheimer's Disease (PMID 31379503), neuroinflammation (PMID 31862695) and altered pain processing (PMID 31862695, PMID 29459435) as just a few examples.

Fatty acids and other plant-derived compounds have an ability to insert into the human cell membrane. For example, n-3 polyunsaturated fatty acids such as eicosapentaenoic acid (EPA) and docosahexaenoic acid (DHA); as well as plant-derived polyphenolic and terpenoid phytochemicals such as curcumin (diferuloylmethane) possess the ability to span the cell membrane and disrupt cell signaling. When EPA, DHA and curcumin were used separately or together in one study, they reduced the number of atypical/precancerous stem cells in an animal model of colorectal cancer (PMID 16475686, 29860560). The proposed mechanism was the disruption of the lipid rafts (regions of the cell surface enriched in signaling proteins) necessary for transmembrane signaling.

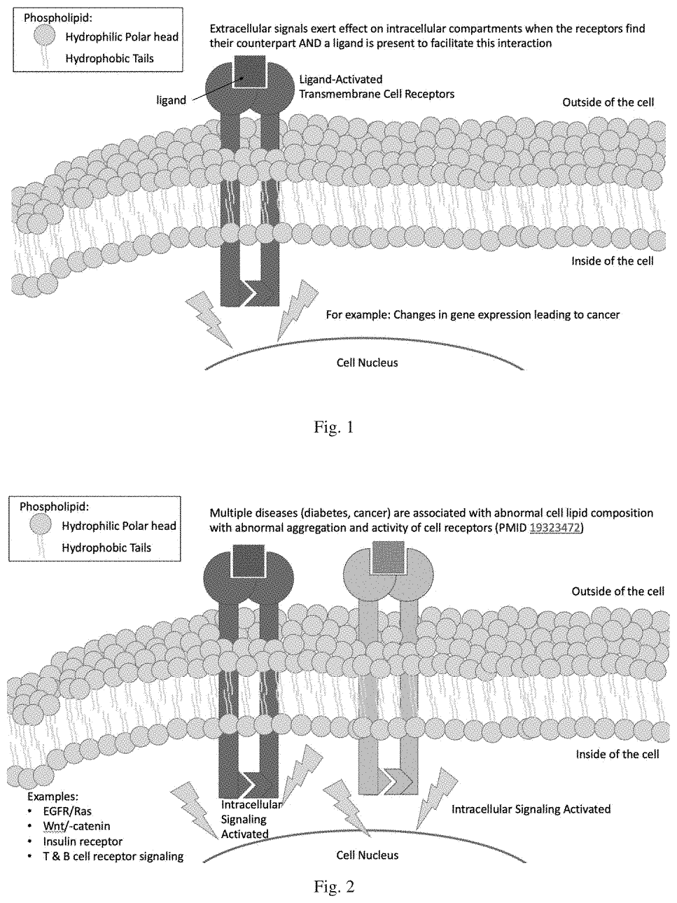

Similarly, a possible mechanism by which “Liquid Skin” (a blend of oils to approximate the fatty acid composition of human cell membranes and sebum) may treat a medical condition (e.g., pain) is by disrupting the signaling that occurs at the cell surface by inserting into the cell membrane, decreasing the likelihood of the paired or multimeric receptors interacting with each other (See FIGS. 1-4).

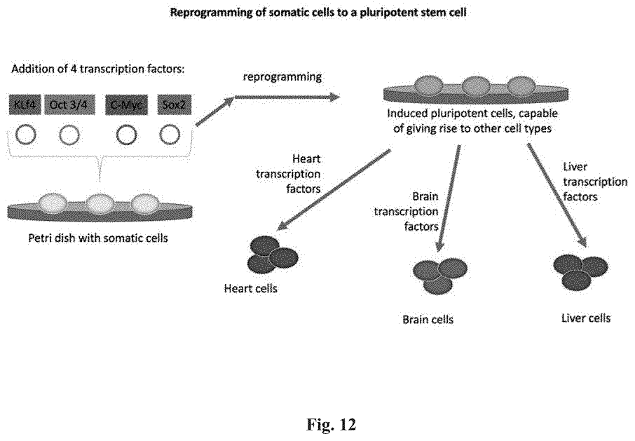

Transmembrane receptors migrate along the surface of the cell in multiple directions according to Brownian Motion (a random movement of microscopic particles suspended in liquids or gases resulting from the impact of molecules of the surrounding medium), but in this case restricted to the plane of the cell membrane surface until they encounter an appropriate counterpart. Once dimerized (see the transmembrane protein-protein interaction in FIG. 11) or multimerized (formation of a multi-protein cluster) new signaling receptor docking sites may form (See FIG. 2).

Additionally, exogenous phospholipids and other lipid mixtures like Liquid Skin can be used to confer penetrability to nanoparticles such as naturally occurring biosilicates such as Food Grade Diatomaceous Earth (FGDE). FGDE are biocompatible, nontoxic porous biosilicate skeletal remains of unicellular diatom microalgae that measure between 1.9 μm to 180 μm. They have many complex shapes and surfaces which renders them useful as micro drug delivery systems (PMID 31618958)—particularly useful in the delivery of substances with poor water solubility and low oral bioavailability such as quercetin (PMID 31496698), useful for prolonging drug delivery (PMID 316618958) and useful in the treatment of metastatic cancer (PMID 31330820), which requires the sustained ability to regain control of intracellular signaling pathways appropriated by cancer (PMID 25239399).

FGDE is safe to consume but hazardous to work with when dry. Thus, in certain embodiments, an N95 mask must be worn to cover the nose and mouth when handling it in a well-ventilated space to prevent interstitial lung disease from silicosis. When taken orally after it has been coated, FGDE will pass through the digestive tract unchanged and does not enter the bloodstream. Diatoms do not penetrate the skin when applied to the skin as a clay paste, unless coated with substances that confer penetrative properties. The diatoms are possessed of many pores and have complex 3-dimensional architecture, ideal for loading multiple bioactive compounds.

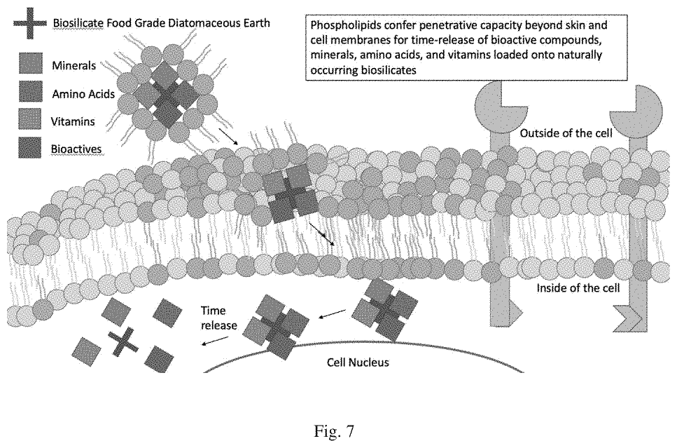

In certain embodiments, the invention is directed in part to diatoms hydrated in a dead sea saltwater solution to render the surface of the diatoms able to form bonds and to load minerals. In some of these embodiments, the hydrated diatoms are sequentially loaded with amino acids, vitamins, and other bioactive compounds (See FIGS. 6, 7) and then coated with a mixture of oils which will confer ability to penetrate the skin and the cell membrane (FIG. 6,7). Alternatively, hydrated diatoms may be loaded with one bioactive ingredient; mixtures of these individually loaded diatoms may be combined to provide benefit in the target disease. In some of these embodiments, the hydrated, coated, and loaded diatoms release the loaded compound(s) and provide a therapeutic effect, e.g., for a duration from about 5 seconds to 8, or more, weeks (See FIG. 8). In some embodiments, it takes about 2 to 4, 2 to 6 or 2 to 8 weeks or longer for the loaded components to dissociate from the nanoparticle (See FIGS. 8,9).

Thus, the invention is also directed in part to the use of natural biosilicate nanoparticles (Food Grade Diatomaceous Earth, or FGDE) as a delayed-release delivery system for multiple bioactive compounds, and then coating these loaded particles with Liquid Skin to confer the ability to penetrate the skin as well as the cell membranes for the purpose of delivering compounds that alter cell function and/or alleviate and reduce severity of one or more symptom(s) of a medical condition (See FIGS. 6, 7).

It shall be noted that some of the coated nanoparticles may penetrate the skin into the intercellular space while other coated nanoparticles may penetrate past the cell membrane into the cell. Both sets of nanoparticles will slowly deliver vital nutrients such as minerals, amino acids, vitamins important for tissue regeneration and repair, coupled with bioactive compounds that facilitate healing and stem cell regeneration over, e.g., at least 2-4 weeks (See FIGS. 6, 7).

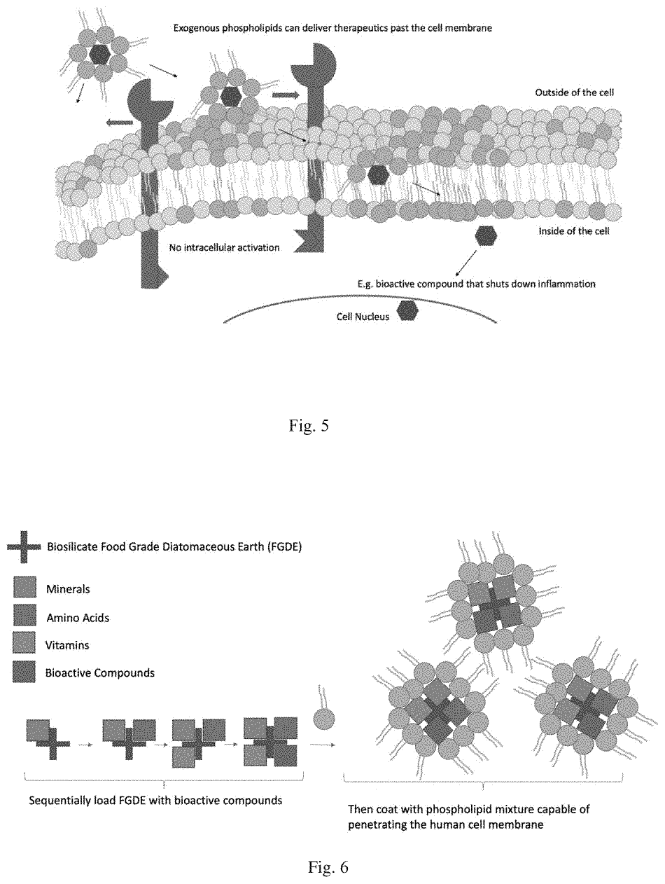

It shall also be noted that in the recipe provided below that the diatoms are added in a proportion that makes them the rate-limiting component to ensure that every diatom will be coated, and that a large proportion of the preparation will be immediate-acting (e.g., an active compound surrounded by lipid mixture conferring penetration into the skin and the cell membrane, See FIG. 5).

Lastly, the lipid coating which permits tissue penetration may play an additional role: that of adding into the cell membrane surface to raise the threshold for signaling for pain (FIG. 5 and FIG. 7). With time, and with the kinetic energy provided by being placed on warm human skin, the loaded components held by reversible bonds may be released gradually for, e.g., a duration from about 1 minute to 8, or more, weeks (e.g., for at least 2-8 weeks); while the components coated with lipid coating may confer immediate action. Each application of the preparations may have an additive effect due to long duration of action (See FIGS. 8, 9). Thus, for example, the goals of immediate relief from pain and inflammation are achieved, while providing long-term release of active elements required for tissue regeneration and repair over a number of weeks. With each application the subject will build more nutrients only in the area that needs restoration and healing (See FIG. 9). Side effects, if any, will be limited due to the local, non-systemic application.

One diatom, while tiny, may be loaded with a multitude of bioactive compounds, minerals, amino acids, and vitamins due to a multitude of open pores in which compounds may nestle into and form temporary bonds.

In certain embodiments such as in the treatment of diseases of inflammation (such as Cancer, Multiple Sclerosis, Diabetes, Atherosclerosis, Coronary Artery Disease, and Obesity, to name a few) emu oil in combination with one or more additional oil(s) in accordance with the present invention may be used to shift white blood cells from a pro-inflammatory M1 phenotype to an anti-inflammatory M2 phenotype.

In certain embodiments, emu oil in combination with one ore additional oil(s) may be used to upregulate stem cell markers Sox-2, Nanog, Oct4, Klf4, and c-Myc, which possess the ability to reprogram differentiated skin cells back into a stem cell-like progenitor state. This property alone may be useful in hastening recovery times for injured skin or for maintaining youthful and healthy skin. It could also be useful in the treatment of cancer (in which reprogramming of cancer stem cells into a naïve stem cell-like state could result in selective apoptosis of cancer stem cells (normal stem cells which have sustained damage and become transformed to give rise to tumor-forming cells).

For example, while oleic acid plays a significant role in allowing superior delivery of substances into the human body, it also decreases anger (treating one of the emotional aspects of pain) while increasing mitochondrial function (PMID 23446891), decreases intracellular oxidative stress (PMID 31802387) thus decreasing inflammation and swelling, thus decreasing pain.

### Formulations

The compositions of the invention may be included into a topical preparation (e.g., a solution, an emulsion (e.g., an oil/oil emulsion), a cream, an ointment, or a balm). The formulation may also be incorporated into a shampoo, conditioner, a mask, a face wash, a body wash, a cleanser, a toner, a wrinkle cream, an age spot fading cream, a serum, a dental preparation, a gum, floss, nasal spray, sunblock, self-tan product, a galactagogue preparation, a needle-free vaccine, a needle-free medicine (e.g., transdermal insulin), a henna preparation, a moisturizer, a keloid and scar preparation, an eyelash and eyebrow growth stimulating serum, a hair gloss, a hair spray, a hair mousse, a hair mask, a topical cream for erectile dysfunction, e.g. when admixed with PDE5 inhibitors, an oral preparation to be taken internally to heal the gut lining in Ulcerative Colitis/Crohn's Disease, Irritable Bowel Disease, or a preparation for HIV mucositis, aphthous ulcers, diverticulitis, colitis, and other mucosal irritations, an oral preparation to treat abnormal sleep debt, an oral preparation to treat osteoporosis, osteopenia, and anemia of chronic disease, an oral preparation to be taken internally to prevent or slow progression of a prediabetic subject from developing or progression of diabetes/obesity/hyperlipidemia/hypertriglyceridemia/metabolic syndrome/atherosclerosis/coronary artery disease, an oral preparation to improve insulin sensitivity, an oral preparation to be taken internally to prevent or slow progression of Alzheimer's Disease, Parkinson's Disease or Multiple Sclerosis, an oral preparation to prevent or slow development or progression of cancer, an inhaled nebulized preparation, e.g., to treat asthma and Chronic Obstructive Pulmonary Disease (COPD), a topical preparation for treatment of Lichen Sclerosis (LS), a topical preparation for treatment of Lichen Planus (LP), a topical preparation to alleviate Raynaud's Phenomena, a topical preparation to alleviate edema and lymphedema, a topical preparation to deliver natural antimicrobials into wounds to promote rapid wound healing, a set of antibiotic drops for treating infections of the ears or eyes, a topical gel that can quickly alleviate chest pain when applied over the left chest, a topical preparation that can quickly alleviate hypertension when applied over the great vessels to prevent a stroke, a topical preparation to be applied over the head and neck to alleviate headache, etc. This preparation, or modifications thereof, can be admixed with existing pharmaceuticals to enhance delivery. The “pharmaceuticals” as used herein include vitamins, minerals and drugs approved by US FDA for use in humans and/or animals.

The formulation may also be an oral formulation. In some of these embodiments, the formulation is administered orally and incorporates into membranes of gastrointestinal tract but is not absorbed into the systemic circulation. In other embodiments, the formulation is absorbed into the systemic formulation in an amount to provide an intended effect (e.g., a therapeutically beneficial effect). In some embodiments, the formulation may also be coated over a substrate. A substrate may e.g., a nanoparticle, a Food-Grade Diatomaceous Earth (FGDE) or a pharmaceutically acceptable matrix. The substrate may comprise a phospholipid, a ceramide, cholesterol, a fatty acid, an oil, a vitamin, a mineral, an amino acid, a hyaluronic acid, a fusogen, a biofermentation product of a fruit or plants, an additional therapeutic agent (e.g., a drug approved by U.S. FDA for use in humans), or a combination of two or more of the foregoing. The formulation may be, e.g., in the form of an ointment or another topical preparation, tor formulated to be administered orally, intranasally, intravenously, intramuscularly, during open surgery, as a suppository or via other routes.

The invention is further directed in part to a method of treating a disorder comprising administering a formulation comprising a mixture of fatty acids to a subject in need thereof in an amount and for a duration sufficient to alleviate one or more symptoms of the disorder in a subject. In one embodiment, the mixture has a fatty acid composition that is substantially the same (i.e., approximate) as that of human skin and sebum.

The invention is further directed to a method of treating a symptom of a disease associated with an injury, damage, or dysfunction of a cellular membrane function in a mammal. The disease associated with a dysfunction, injury of damage of a cellular membrane function may, e.g., be pain, eczema, psoriasis, erythema, a burn, a cut, a bruise, a boil, a scar, a keloid, a non-healing wound, acne, rosacea, an allergy, an arthritis, an arthralgia, cancer, a neuropathy, a metabolic syndrome, an infection, a canker sore, an ulcer, Ulcerative Colitis (UC), a mucositis, diverticulitis, celiac disease, a colitis, Crohn's Disease (CD), Irritable Bowel Syndrome (IBS), Inflammatory Bowel Disease (IBD) atherosclerosis, Alzheimer's Disease (AD), Parkinson's Disease (PD), gout, solar lentigo, senile lentigines, skin atrophy, Lichen Sclerosis (LS), Lichen Planus (LP), asthma, Chronic Obstructive Pulmonary Disease (COPD), angina, Coronary Artery Disease (CAD), hypertension (HTN), hyperlipidemia (HLD), Diabetes Mellitus (DM), insulin resistance, metabolic syndrome, a neuropathy, PMS, anxiety, depression, nightmares, insomnia, abnormal sleep debt, neuralgia, sciatica, mastitis, conjunctivitis, a convulsive disorder, alcohol withdrawal, abnormal muscle tension, xerosis, osteoporosis, osteopenia, anemia of chronic disease, fibromyalgia, alopecia, Erectile Dysfunction (ED), Polycystic Ovarian Syndrome (PCOS), premature adrenarche, Restless Legs Syndrome (RDS), Multiple Sclerosis (MS), urticaria, hemorrhoids, Chronic Fatigue Syndrome (CFS), leukoplakia, edema, heavy lymph load, sunburn, vaginal atrophy, hyperpigmented skin due to aging or prior trauma, or a muscle spasm. The symptom may, e.g., be selected from the group consisting of pain, inflammation, skin irritation, rash, a lesion, a wrinkle, hyperpigmentation, a keloid, a scar, pruritus, itching, indigestion, diarrhea, a cramp, cough, a bronchospasm, a discoloration, and combinations or two or more of the foregoing.

The invention is also directed in part to a method of treating a disorder comprising administering a formulation comprising a mixture of oils, including animal oils and vegetable oils, to a subject in need thereof in an amount and for a duration sufficient to alleviate one or more symptoms of the disorder in a subject. In one embodiment, the mixture has a fatty acid composition that is substantially the same (i.e., approximate) as that of human skin and sebum. In certain embodiments, the formulation is administered topically. In other embodiments, the formulation may be administered orally, intranasally, intravenously, intramuscularly, during open surgery, as a suppository or via other routes of administration.

The invention is also directed in part to a method of treating a disorder comprising administering a formulation comprising a mixture of naturally occurring compounds found in vegetable oils, animal oils, plant matter, mineral matter, exosomes, or other organic materials which have been subjected to fermentation (via bacteria, fungi, or other micro-organisms), e.g., in order to diversify and improve chemical activity of bioactive compounds, which have then been admixed or modified with a mixture of oils to improve delivery of such compounds to treat, improve or ameliorate a disease. A combination of therapeutics designed to address multiple aspects of a disease may be administered in conjunction via topical, oral, intranasal, intravenous, intramuscular, suppository or other routes such as, e.g., applied during open surgery or inhaled.

The disorders that may be treated with the formulations of the present invention include but are not limited to the following: e.g., abnormal muscle tension, abnormal sleep debt, acne, alcohol withdrawal, allergies, alopecia, Alzheimer's Disease (AD), angina/chest pain, aphthous ulcers, arthritis (e.g., rheumatoid arthritis, osteoarthritis, psoriatic arthritis, etc.), arthralgias induced by chemotherapy, arthralgias caused by autoimmune disease, arthralgias caused by trauma, asthma, atherosclerosis, anxiety, boils, bronchospasm, bruises, burns, canker sores, cancer, celiac disease, Chronic Fatigue Syndrome (CFS), Chronic Obstructive Pulmonary Disease (COPD), colitis, conjunctivitis, Coronary Artery Disease (CAD), cough, cramps/muscle spasms, Crohn's Disease (CD), cuts in skin, depression, dermatitis, Diabetes Mellitus (DM), diaper rash, diverticulitis, eczema, edema, epilepsy and other convulsive disorders, epistaxis due to persistent nasal dryness, Erectile Dysfunction (ED), erythema, fibromyalgia, gingivitis, gout, hair loss, healing of tattoos or other skin wounds, hemorrhoids, HIV mucositis, hypercholesterolemia, hyperlipidemia (HLD), hyperpigmentation, hypertension (HTN), hypertriglyceridemia, increased muscle tension, indigestion, infection, Inflammatory Bowel Disease (IBD), insomnia, Irritable Bowel Syndrome (IBS), itching, keloids, leukoplakia, Lichen Planus (LP), Lichen Sclerosis (LS), lymphedema, mastitis, metabolic syndrome, mucositis, insulin resistance, Multiple Sclerosis (MS), nasal inflammation, neuralgia, neuropathic pain, neuropathy (numbness/paresthesias), nightmares, non-healing wounds, obesity, otitis externa, otitis media, osteopenia, osteoporosis, anemia of chronic disease, pain, Parkinson's Disease (PD), peripheral neuropathy, pharyngitis, polycystic ovarian syndrome (PCOS), poor immune function, pre-menstrual syndrome (PMS), premature adrenarche, pruritic rashes, psoriasis, rash, Restless Leg Syndrome (RLS), rosacea, scars (including, e.g., keloid and atrophic), sciatica, senile lentigines, skin atrophy from overuse of topical corticosteroids, skin lesions, social anxiety, solar lentigines, strokes, sunburn, topical infections (impetigo, staphylococcal, streptococcal and fungal infections), ulcers, Ulcerative Colitis (UC), unspecified skin irritations, urticaria, vaginal atrophy, wounds, wrinkles, xerosis (dry skin), among others. Formulations can also be formulated to address or improve surfactant production (such as would be useful in reducing atelectasis in subjects who have recently undergone surgery); to facilitate lung maturity in neonates, to address acetylcholine deficiency, to improve nutrient absorption, slow down aging by decreasing free radical production and inflammation, decrease risk for or progression of cancer by decreasing free radical production and inflammation, and decrease risk of acute infarctions of the brain and myocardium (e.g. stroke and heart attacks) by improving atherosclerosis.

In certain embodiments, the formulation is administered topically. In other embodiments, the formulation may be administered, intranasally, intravenously, intramuscularly, during open surgery, or a suppository, or via a spray.

### Formulations with Bioactive Substances Found in Lipophilic Fractions of Plants

In certain embodiments, the invention is directed to a nutritional supplement comprising, by weight, about 0.001% to about 20% fermented garlic cloves, about 0.0001% to about 10% Food Grade Diatomaceous Earth, about 7% to about 27% Blackseed oil, about 5×10⁻⁷% to 2×10⁻⁸%, about 7% to about 27% Emu Oil, about 0.005% to about 10% Grapeseed Extract, about 0.1% to about 10% Glycine, about 0.001% to about 14% Macadamia Nut Oil about 0.0001% to about 10% Coconut Oil, about 1.4×10⁻⁶% to 1.4×10⁻²% Vitamin D, about 1×10⁻¹⁰% to about 1×10⁻⁶% phytonadione, about 1×10⁻¹⁰% to about 1×10⁻⁶% menaquinone-4, about 1×10⁻⁸% to about 1×10⁻⁴% trans menaquinone-7, about 30% to about 52% High Oleic sunflower seed oil, about 0.001% to about 10% organic turmeric powder, about 0.001% to about 12% German Chamomile EO, about 0.001% to about 12% Roman Chamomile EO, about 0.001% to about 12% Moroccan Chamomile EO, about 0.001% to about 15% Rosemary EO, about 0.001% to about 15% Cinnamon EO, about 0.001% to about 15% Lemon EO, about 0.001% to about 15% Clove EO, about 0.001% to about 15% Eucalyptus EO, about 0.001% to about 15% Ginger EO, about 0.001% to about 15% Lemongrass EO, about 0.001% to about 15% Grapefruit EO, about 0.001% to about Lime EO, about 0.001% to about 20% Myrrh EO, about 0.001% to about 20% Frankincense EO, about 0.001% to about 15% orange EO, about 0.001% to about 15% Cinnamon Leaf EO, and about 0.001% to about 15% Spearmint EO. These nutritional supplements may be useful for humans with hyperlipidemia, hypertriglyceridemia, diabetes, diabetic neuropathy, generalized inflammation such as caused by COVID-19 infection or other generalized infections, autoimmune diseases, metabolic syndrome, sleep debt, insomnia, osteoporosis, hyperlipidemia, obesity, insulin insensitivity, polycystic ovarian syndrome, and found to be useful in weight loss.

In certain embodiments, the invention is directed to a nutritional supplement comprising, by weight, about 1% to about 20% fermented garlic cloves, about 0.01% to about 12% Food Grade Diatomaceous Earth, about 1% to about 20% Blackseed oil, about 0.00004% to about 1% Vit B12, about 1% to about 25% Emu Oil, about 0.003% to about 15%, Grapeseed Extract, about 0.001% to about 15% Glycine, about 0.003% to about 10% Macadamia Nut Oil, about 0.005% to about 10% Coconut Oil, about 3×10⁻⁴% to about 0.3% Vitamin D, about 2×10⁻¹⁰% to about 2×10⁻⁶% phytonadione, about 2×10⁻¹⁰% to 2×10⁻⁶ 00 menaquinone-4, about 2×10⁻⁸% to about 2×10⁻⁴% trans menaquinone-7, about 20% to about 45% High Oleic sunflower seed oil, about 0.001% to about 10% organic turmeric powder, about 0.001% to about 20% trans-resveratrol powder, about 0.001% to about 40% pomegranate extract, about 0.001% to about 20% vegetable glycerin, about 0.001% to about 10% German Chamomile EO, about 0.001% to about 10% Roman Chamomile EO, about 0.001% to about 10% Moroccan Chamomile EO, about 0.001% to about 15% Rosemary EO, 0.001% to about 15% Cinnamon EO, about 0.001% to about 15% Lemon EO, about 0.001% to about 15% Clove EO, about 0.001% to about 15% Eucalyptus EO, about 0.001% to about 15% Ginger EO, about 0.001% to about 15% Lemongrass EO, about 0.001% to about 15% Grapefruit EO, 0.001% to about 15% Lime EO, about 0.001% to about 15% galangal EO, about 0.001% to about 15% tangerine EO, about 0.002% to about 30% thyme EO, about 0.001% to about 15% xiang mao EO, about 0.001% to about 15% yuzu EO, about 0.001% to about 15% coriander seed EO, about 0.001% to about 15% turmeric EO, about 0.001% to about 15% palmarosa EO, about 0.001% to about 15% niaouli EO, about 0.001% to about 30% myrrh EO, about 0.001% to about 30% frankincense EO, about 0.001% to about 15% orange EO, about 0.001% to about 30% Cinnamon Leaf EO, and about 0.001% to about 15% Spearmint EO. These nutritional supplements may be useful for humans with hyperlipidemia, hypertriglyceridemia, diabetes, diabetic neuropathy, generalized inflammation such as caused by COVID-19 infection or other generalized infections, autoimmune diseases, metabolic syndrome, sleep debt, insomnia, osteoporosis, hyperlipidemia, obesity, insulin insensitivity, polycystic ovarian syndrome, and found to be useful in weight loss.

In certain embodiments, the invention is directed to a nutritional supplement comprising, by weight, about 1% to about 20% fermented garlic cloves, about 0.01% to about 12% Food Grade Diatomaceous Earth, about 1% to about 20% Blackseed oil, 0.00004% to about 1% Vitamin B12, about 1% to about 25% Emu Oil, about 0.003% to about 15% Grapeseed Extract, about 0.001% to 15% Glycine, about 0.003% to about 10% Macadamia Nut Oil, about 0.005% to about 10% Coconut Oil, about 3×10⁻⁴% to about 0.3% Vitamin D, about 2×10⁻¹⁰% to about 2×10⁻⁶% Vitamin K1 as phytonadione, about 2×10¹⁰% to about 2×10⁻⁶% Vitamin K2, as menaquinone-4, about 2×10⁻⁸% to about 2×10⁻⁴% Vitamin K2, about 20% to 45% High Oleic sunflower seed oil, about 0.001% to about 10% organic turmeric, about 0.001% to about 20% trans-resveratrol powder, about 0.001% to about 40% pomegranate extract, about 0.001% to about 20% vegetable glycerin, about 0.001% to about 10% German Chamomile EO, about 0.001% to about 10% Roman Chamomile EO, about 0.001% to about 10% Moroccan Chamomile EO, about 0.001% to about 10% Artemisia annua EO, about 0.001% to about 10% Oregano EO, about 0.001% to about 15% Rosemary EO, about 0.001% to 15% Cinnamon EO, about 0.001% to about 15% Lemon EO, about 0.001% to about 15% Clove EO, about 0.001% to about 15 ml Eucalyptus EO, about 0.001% to about 15% Ginger EO, about 0.001% to about 15% Lemongrass EO, about 0.001% to about 15% Grapefruit EO, about 0.001% to about 15% Lime EO, about 0.001% to about 15% galangal EO, about 0.001% to about 15% tangerine EO, about 0.002% to about 30% thyme EO, about 0.001% to about 15% xiang mao EO, about 0.001% to about 15% yuzu EO, about 0.001% to about 15% coriander seed EO, about 0.001% to about 15% turmeric EO, about 0.001% to about 15% palmarosa EO, about 0.001% to about 15% niaouli EO, about 0.001% to about 30% myrrh EO, about 0.001% to about 30% frankincense EO, about 0.001% to about 15% orange EO, about 0.001% to about 30% Cinnamon Leaf EO, and about 0.001% to about 15% Spearmint EO. These nutritional supplements may be useful for humans with hyperlipidemia, hypertriglyceridemia, diabetes, diabetic neuropathy, generalized inflammation such as caused by COVID-19 infection or other generalized infections, autoimmune diseases, metabolic syndrome, sleep debt, insomnia, osteoporosis, hyperlipidemia, obesity, insulin insensitivity, polycystic ovarian syndrome, and found to be useful in weight loss.

In certain embodiments, the invention is directed to a nutritional supplement comprising, by weight, about 1% to 5% of Dead Sea Salt water, about 7×10⁻⁶% to about 7×10⁻²% Histidine, about 7×10⁻⁶% to about 7×10⁻²% L-Isoleucine, about 7×10⁻⁶% to about 7×10⁻²% L-Leucine, about 7×10⁻⁶% to about 7×10⁻²% Lysine HCL, about 7×10⁻⁶% to about 7×10⁻²% Methionine, about 7×10⁻⁶% to about 7×10⁻²% L-Phenylalanine, about 7×10⁻⁶% to about 7×10⁻²% L-Threonine, about 3×10⁻⁹% to about 4×10⁻⁴% Vitamin A, about 3×10⁻⁶% to about 4×10⁻²% Vitamin C, about 1×10⁻¹⁰% to about 1×10⁻⁶% Vitamin D, about 7×10⁻⁷% to about 7×10⁻³% Vitamin E, about 5×10⁻¹⁰% to about 5×10⁻⁷% Vitamin K, about 5×10⁻⁸% to about 5×10⁻⁴% Vitamin B2, about 7×10⁻⁸% to about 7×10⁻⁴% Vitamin B3, about 2×10⁻⁷% to about 2×10⁻³% Vitamin B5, about 7×10⁻⁸% to about 7×10⁻⁴% Vitamin B6, about 3×10⁻¹¹% to about 3×10⁻⁷% Vitamin B9, about 2×10⁻¹²% to about 2×10⁻⁸% Vitamin B12, about 1×10⁻¹⁰% to about 1×10⁻⁷% biotin, about 2×10⁻⁷% to about 2×10⁻³% Iron, about 2×10⁻⁷% to about 2×10⁻³% Zinc, about 1×10⁻¹¹% to about 1×10⁻⁷% Selenium, about 2×10⁻⁷% to about 2×10⁻³% Manganese, about 2×10⁻¹¹% to about 1×10⁻⁷% Chromium, about 2×10⁻¹¹% to about 2×10⁻⁷% Molybdenum, about 0.01% to about 10% Macadamia Nut Oil, about 5×10⁻⁴% to about 5% Coconut Oil, about 60% to about 95% Emu Oil. These nutritional supplements may be useful for humans with impaired digestion, food and seasonal allergies, food intolerance, history of disrupted circadian rhythm, sleep disturbance, depression, anxiety, insomnia, hallucinations, attention deficit disorder, atopy, eczema, autoimmune disorders, gastroesophageal reflux disease, Crohn's disease, Ulcerative Colitis, Chronic Fatigue Syndrome, Chronic Pain, and Fibromyalgia.

In certain embodiments, the nutritional supplement comprises a formulation comprising a composition comprising, by weight or volume, about 20% to about 90% Artemisia absinthium EO, about 20% to about 90% Artemisia annua EO, about 0.001% to about 5% Ginger EO, about 20% to about 90% High Oleic Olive Oil, about 20% to about 90% High Oleic Sunflower Seed Oil, about 20% to about 90% Macadamia Nut Oil, about 20% to about 90% Coconut Oil, about 20% to about 90% Xiang Mao EO, about 20% to about 90% Clove EO, about 20% to about 90% Cinnamon EO, about 20% to about 90% Rosemary EO, about 20% to about 90% Eucalyptus EO, about 20% to about 90% Lemon EO, about 20% to about 90% Ravintsara EO, about 20% to about 90% Cinnamon Leaf, about 20% to about 90% Frankincense EO about 20% to about 90% Red Thyme EO, about 20% to about 90% Rosalina EO, about 20% to about 90% Palmarosa EO, about 20% to about 90% Niaouli EO, about 20% to about 90% Laurel Leaf EO, about 20% to about 90% Litsea Leaf EO, and about 20% to about 90% Myrrh EO. The formulation may be a topical formulation, an oral formulation, or an inhalation formulation. The formulation may, e.g., be used to provide nutritional support for human and animals with upper respiratory infections, parasitic infections of the lungs, inflamed skin lesions, skin tags or other superficial tumors, malignancies within the lungs, for skin cancer or premalignant skin lesions, inflammation of the oral mucosa including, e.g., viral eruptions, for treatment of pain. In certain embodiments, the nutritional supplement may be used to support an anti-tumor, neuroprotective, anti-depressant, immunomodulatory, wound healing, hepatoprotective, and renal protective effects. In certain embodiments, administration of the nutritional supplement may result in lowering blood sugar, reduce fevers and pain, improve cardiac function by lowering lipids, ability to improve hormonal function in PCOS by suppressing aromatase and 5-alpha-reductase enzymes to promote lean muscle growth performance, anti-ulcer, antibacterial, antiviral, antifungal and antiparasitic properties (PMID 32585887). The nutritional supplement may, e.g., be dosed at about 5 to about 12.5 mg/kg body weight/day. In certain embodiments, the nutritional supplement is contraindicated in pregnant individuals, breastfeeding mothers, individuals with peptic ulcers, and individuals with allergies to any of the constituents.

In certain embodiments, the invention is directed to a nutritional supplement comprising a formulation comprising a composition comprising, by weight, about 0.001% to about 20% Peppermint EO, about 0.001% to about 15% Ginger EO about 0.001% to about 20% High Oleic Olive Oil, 0.001% to about 20% High Oleic Sunflower Seed Oil, about 0.001% to about 20% Macadamia Nut Oil, about 0.001% to about 20% Coconut Oil, about 0.001% to about 20% Myrrh EO, about 0.001% to about 20% Xiang Mao EO, about 0.001% to about 20% Clove EO, about 0.001% to about 20% Cinnamon EO, about 0.001% to about 20% Rosemary EO, about 0.001% to about 20% Eucalyptus EO, about 0.001% to about 20% Lemon EO, about 0.001% to about 20% Ravintsara EO, about 0.001% to about 20% Cinnamon Leaf EO, about 0.001% to about 20% Frankincense EO, about 0.001% to about 20% Red Thyme EO, about 0.001% to about 20% Rosalina EO, about 0.001% to about 20% Palmarosa EO, about 0.001% to about 20% Niaouli EO, about 0.001% to about 20% Laurel Leaf EO, about 0.001% to about 20% Litsea Leaf EO, and about 1% to about 90% Emu Oil. The formulation may, e.g., be a liquid formulation, a toothpaste formulation, or a wax formulation. In some of the embodiments, the nutritional supplement may be applied to a non-mechanical toothbrush in place of toothpaste. In some of the embodiments, the nutritional supplement may be applied to a dental floss. The nutritional supplement provides nutritional support for gums and, in certain embodiments, may be used to treat gingivitis, and/or maintains health of gums and jawbone.

In certain embodiments, the nutritional supplement comprising a formulation comprising a composition comprising, by weight or volume, about 15% to about 80% High Oleic Acid Sunflower Seed Oil, about 10% to about 80% High Oleic Olive Oil, about 1% to about 40% Frankincense EO, about 1% to about 40% Macadamia Nut Oil EO, about 0.01% to about 20% Coconut Oil EO, about 0.01% to about 30% Clove EO, about 0.01% to about 30% Cinnamon EO, about 0.01% to about 30% Rosemary EO, about 0.01% to about 30% Eucalyptus EO, about 0.01% to about 30% Lemon EO, about 0.01% to about 30% Blackseed EO, about 0.01% to about 30% Oregano EO, about 0.01% to about 30% Red Thyme EO, about 0.01% to about 30% Palmarosa EO, about 0.01% to about 30% Litsea Leaf EO, about 0.01% to about 30% Tangerine EO, about 0.001% to about 25% Ravintsara EO, about 0.001% to about 25% Myrrh EO, about 0.001% to about 30% Sweet Wormwood EO, about 0.001% to about 30% Fennel EO, about 0.001% to about 30% Rosalina EO, about 0.001% to about 30% Niaouli EO, about 0.001% to about 30% Laurel Leaf EO, about 0.001% to about 30% Xiang Mao EO, and about 0.001% to about 30% Cinnamon Leaf EO. The formulation may, e.g., be an oral formulation, a topical formulation, or a diffusible formulation. In some of these embodiments, the nutritional supplement may be applied to broken skin to help with closing skin wounds, for antimicrobial properties, for treatment of fungal or bacterial skin infections, for treatment of viral based skin eruptions such as herpetic lesions, for decreasing local pain, inflammation and swelling, and for improving dental health. When diffused and inhaled, the nutritional supplement may improve nasal and upper respiratory congestion. In some of the embodiments, the nutritional supplement may be used for improving dental health and reducing global inflammation and cardiovascular risk when used as a dentifrice. When taken internally, the nutritional supplement may, e.g., improve digestion, increasing energy, and decrease inflammation.

The nutritional supplement comprising a formulation comprising a composition comprising, by weight or volume, about 15% to about 80% High Oleic Acid Sunflower Seed Oil, about 10% to about 80% Emu Oil, about 1% to about 40% Frankincense EO, about 1% to about 40% Macadamia Nut Oil EO, about 0.01% to about 20% Coconut Oil EO, about 0.01% to about 30% Clove EO, about 0.01% to about 30% Cinnamon EO, about 0.01% to about 30% Rosemary EO, about 0.01% to about 30% Eucalyptus EO, about 0.01% to about 30% Lemon EO, about 0.01% to about 30% Blackseed EO, about 0.01% to about 30% Oregano EO, about 0.01% to about 30% Red Thyme EO, about 0.01% to about 30% Palmarosa EO, about 0.01% to about 30% Litsea Leaf EO, about 0.01% to about 30% Tangerine EO, about 0.001% to about 25% Ravintsara EO, about 0.001% to about 25% Myrrh EO, about 0.001% to about 30% Sweet Wormwood EO, about 0.001% to about 30% Fennel EO, about 0.001% to about 30% Rosalina EO, about 0.001% to about 30% Niaouli EO, about 0.001% to about 30% Laurel Leaf EO, about 0.001% to about 30% Xiang Mao EO, and about 0.001% to about 30% Cinnamon Leaf EO. The formulation may, e.g., be an oral formulation, a topical formulation, or a diffusible formulation. In certain embodiments, the nutritional supplement may be applied to broken skin to help with closing skin wounds, healing skin lesions, for antimicrobial properties, for treatment of fungal or bacterial skin infections, for treatment of viral based skin eruptions such as herpetic lesions, for decreasing local pain, inflammation and swelling. In some of the embodiments, the nutritional supplement may be used for improving dental health and reducing global inflammation and cardiovascular risk when used as a dentifrice. When taken internally, the nutritional supplement may, e.g., improve digestion, increasing energy, and decrease inflammation.

### Formulations with Bioactive Substances Found in Aqueous Fractions of Plants

In certain embodiments, the nutritional supplement is a formulation comprising a composition comprising, by weight or volume, about 20% to about 70% chrysanthemum tea, taro leaf tea, or a mixture of chrysanthemum tea and taro leaf tea; about 5% to about 70% aloe vera; about 5% to about 70% papaya seeds (e.g., from ripe Maradol papayas); and about 5% to about 50% honey. The formulation may be a topical formulation (e.g., a poultice) or a formulation for oral administration (e.g., a lyophilized powder or a liquid). The poultices could be, e.g., applied topically soaked into sterile cotton gauze to broken, infected, or lesioned skin to improve recovery. In some of the embodiments, these poultices may be kept on the skin for at minimum 30 minutes or for as long as tolerated (for example, as a poultice worn for 1-12 hours). In these embodiments, when taking internally, the nutritional supplement may, e.g., improve digestion, relieving constipation, and alleviating fatigue.

In certain embodiments, the nutritional supplement is a formulation comprising a composition comprising, by weight or volume, about 10% to about 70% chrysanthemum tea, taro leaf tea, or a mixture of chrysanthemum tea and taro leaf tea; about 5% to about 70% aloe vera, about 5% to about 70% papaya seeds (e.g., from ripe Maradol papayas); about 5% to about 50% honey; about 5% to about 70% rambutans, about 5% to 70% mangosteen peels and seeds, and about 5% to about 70% bitter melons. The formulation may, e.g., be a topical formulation (e.g., a poultice) or a formulation for oral administration (e.g., a lyophilized powder or a liquid). The topical formulation may be applied to open wounds or rashes, e.g., by soaking sterile gauze in the fluid and applying the gauze directly to open skin wounds; and by heaping the pulp onto the gauze and leaving in place for >30 minutes or as tolerated. The formulation may also be in the form of a lyophilized formulation. In some of these embodiments, the lyophilized formulation may be reconstituted with water to form a paste. When taking internally, the nutritional supplement may, e.g., improve digestion, relieving constipation, and alleviating fatigue.

In certain embodiments, the nutritional supplement is a formulation comprising a composition comprising, by weight or volume, about 10% to about 70% about 10% to about 70% chrysanthemum tea, taro leaf tea, or a mixture of chrysanthemum tea and taro leaf tea; about 5% to about 70% aloe vera; about 5% to about 70% papaya seeds (e.g., ripe Maradol papayas); about 1% to about 60% honey; about 5% to about 70% rambutans; about 5% to about 70% mangosteen peels and seeds, about 5% to about 70% chrysanthemum greens, about 5% to about 70% bitter melons, about 5% to about 70 red or yellow dragon fruit, about 5% to about 70 longan, and about 5% to about 70% taro leaves. The formulation may, e.g., be a topical formulation (e.g., a poultice) or a formulation for oral administration (e.g., a powder, a lyophilized powder, or a liquid). The nutritional supplement may, e.g., be used to provide nutritional support in humans and animals with skin conditions (e.g., eczema, skin lesions, skin irritation, etc.), inflammation, swelling, anxiety, and sleep disturbances.

In certain embodiments, the nutritional supplement is a formulation comprising a composition comprising, by weight or volume, about 10% to about 70% chrysanthemum tea, taro leaf tea, or a mixture of chrysanthemum tea and taro leaf tea; about 5% to about 70% aloe vera; about 5% to about 70% papaya seeds (e.g., from ripe Maradol papayas); about 1% to about 60% honey; about 5% to about 70% rambutans; about 5% to about 70% mangosteen peels and seeds, about 5% to about 70% chrysanthemum greens, about 5% to about 70% bitter melons, about 5% to about 70% dragon fruit, about 5% to about 70% longan, about 5% to about 70% taro leaves, and about 25% to 90% of pomegranate peels. The formulation may, e.g., be a topical formulation (e.g., a poultice) or a formulation for oral administration (e.g., a powder, a lyophilized powder, or a liquid). The nutritional supplement may, e.g., be used to provide nutritional support in humans and animals with inflammation, skin conditions and metabolic disorders. In certain embodiments, administration of the nutritional supplement to a human or animal in need thereof results in a symptomatic relieve of eczema, a skin condition, an improvement in lipid metabolism, an improvement in sugar metabolism, weight loss, hormone regulation, improved estrogen dominance, relieve of fatigue, relieve of insomnia, relieve of anxiety, relieve of depression, relieve of a symptom of early adrenarche and polycystic ovarian syndrome.

In certain embodiments, the nutritional supplement is a formulation comprising a composition comprising, by weight or volume, about 10% to about 70% chrysanthemum tea, taro leaf tea, or a mixture of chrysanthemum tea and taro leaf tea; about 5% to about 70% freshly harvested aloe; about 5% to about 70% papaya seeds (e.g., from ripe Maradol papayas); about 1% to about 60% honey; about 5% to about 70% rambutans, about 5% to about 70% mangosteen peels and seeds, about 5% to about 70% chrysanthemum greens, about 5% to about 70% bitter melons, about 5% to about 70 dragon fruit, about 5% to about 70 longan, about 5% to about 70% taro leaves, about 25% to 90% of pomegranate peels, about 1% to about 50% lemon peels and seeds, about 1% to about 50% orange peels and seeds, and about 1% to about 50% grapefruit peels and seeds. The formulation may, e.g., be a topical formulation (e.g., a poultice) or a formulation for oral administration (e.g., a powder, a lyophilized powder, or a liquid). In certain embodiments, administration of the nutritional supplement to a human or animal in need thereof may decrease inflammation, decrease risk for eczema and other skin eruptions, improve skin healing, improve lipid, and sugar metabolism, improve weight loss, improve estrogen dominance, improve fatigue, insomnia, anxiety and depression, improve symptoms of early adrenarche and polycystic ovarian syndrome, improve thyroid function, or improve appearance of skin tags.

In certain embodiments, the nutritional supplement is a formulation comprising a composition comprising, by weight or volume, about 10% to about 90% lotus leaf, about 10% to about 90% notoginseng flower buds, from 10% to 90% kuding leaves, about 1% to about 10% tamarind seed, about 0.01% to about 10% magnolia leaves, about 10% to about 90% pomegranate peels, about 10% to about 90% tangerine peels, pith and seed, about 10% to about 90% orange peels, pith and seed, about 10% to about 90% grapefruit peels, pith and seeds), about 10% to about 90% mangosteen peels, about 0.01% to about 20% ginger, and about 0.01% to about 20% licorice. The formulation may, e.g., be a formulation for oral administration (e.g., a powder, a lyophilized powder, or a liquid). The nutritional supplement may, e.g., be used to improve metabolism of lipids and carbohydrates, improve global metabolism, improve thyroid function, support weight loss efforts, improve lipid profile, improving fatigue, reduce symptoms of estrogen dominance.

In certain embodiments, the nutritional supplement comprises a formulation comprising, by weight or volume, about 10% to about 90% fenbendazole, about 10% to about 70% chrysanthemum and taro leaf tea, about 5% to about 70% aloe vera, about 5% to about 70% papaya seeds (e.g., from ripe Maradol papayas), about 1% to about 60% honey, about 5% to about 70% rambutans, about 5% to about 70% mangosteen peels and seeds, about 5% to about 70% chrysanthemum greens, about 5% to about 70% bitter melons, about 5% to about 70% dragon fruit, about 5% to about 70% longan, about 5% to about 70% taro leaves, about 25% to 90% pomegranate peels, about 1% to about 20% licorice, about 1% to about 20% ginger, about 5×10⁻⁸% to about 5×10⁻⁴% Vitamin A, about 0.001% to about 5% Vitamin C, about 1×10⁻⁸% to about 1×10⁻⁴% Vitamin D3, about 0.001% to about 5% Vitamin E, about 6×10⁻⁶% to about 6×10⁻²% 3 Vitamin K, about 6×10⁻⁵% to about 6×10⁻¹% Vitamin B1, about 7×10⁻⁵% to about 7×10⁻³% Vitamin B2, about 0.001% to about 5% Vitamin B3, about 0.003% to about 5% Vitamin B5, about 0.005% to about 5%, Vitamin B6, about 4×10⁻⁸% to about 4×10⁻⁴% Vitamin B9, about 3×10⁻⁵% to about 3×10⁻⁵% Vitamin B12, about 2×10⁻⁶ 00 to about 2×10⁻²% Biotin, about 0.003% to about 5% mg Iron, about 0.005% to about 5% Zinc, about 2×10⁻⁴% to about 2×10⁻⁴% Selenium, about 0.005% to about 5% Manganese, about 2×10⁻⁶% to about 2×10⁻²% Chromium, and about 2×10⁻⁶% to about 2×10⁻²% Molybdenum. The formulation may, e.g., be a formulation for oral administration (e.g., a powder, a lyophilized powder, or a liquid). The nutritional supplement may, e.g., be used to treat parasites. In some of the embodiments, the nutritional supplement may be taken with a fatty meal, or with a nutritional supplement comprising Liquid Skin.

### Formulations with Fermented Compositions

In certain embodiments, a nutritional supplement comprises a formulation comprising a fermented composition comprising, by weight or volume, about 1% to about 85% pomegranate arils, about 1% to about 85% pomegranate peels, about 0.001% to about 5% magnolia leaves, about 0.05% to about 40% bee pollen, about 0.05% to about 35% sweet wormwood, about 0.05% to about 60% pineapple guavas, about 0.01% to about 60% apples, about 0.05% to 60% grapefruit peels, pith, and seeds, about 1% to about 60% cabbage, about 0.05% to about 40% cellulase granules, about 0.05% to about 60% Red Dulse flakes, about 0.05% to about 4 quercetin dihydrate, about 0.05% to about 60% Pomegranate, about 0.05% to about 40% beets, about 0.05% to about 60% ellagic acid, about 0.05% to about 60% resveratrol, about 0.05% to about 20% Sugar, about 0.05% to about 20% Pectic Enzymes, and about 0.05% to about 40% honey. These nutritional supplements may be useful for supplementing poor diets, for improving metabolism, decreasing inflammation, improving insomnia, assisting with weight loss, improving metabolism of lipids and carbohydrates, decreasing fatigue, anxiety, and depression.

In certain embodiments, the invention is directed to a nutritional supplement comprising a formulation comprising a fermented composition comprising, by weight or volume, about 1% to about 85% pomegranate arils, about 1% to about 85% pomegranate peels, about 0.001% to about 5% magnolia leaves, about 0.05% to about 40% bee pollen, about 0.05% to about 35% sweet wormwood, from about 0.05% to about 30%, about 0.05% to about 60% pineapple guavas, about 0.01% to about 60% Apples, about 0.05% to 60% grapefruit peels, pith, and seeds, about 1% to about 60% cabbage, about 0.05% to about 40% cellulase, about 0.05% to about 60% Red Dulse flakes, about 0.05% to about 4 quercetin dihydrate, about 0.05% to about 60% Pomegranate, about 0.05% to about 40% beets, about 0.05% to about 60% ellagic acid, about 0.05% to about 60% resveratrol, about 0.05% to about 20% sugar, about 0.05% to about 20% Pectic Enzymes, about 0.05% to about 10% ginger root, about 0.05% to about 10% Glycyrrhiza glabra root, and about 0.05% to about 40% honey. These nutritional supplements may be useful for supplementing poor diets, for improving metabolism, decreasing inflammation, improving insomnia, assisting with weight loss, improving metabolism of lipids and carbohydrates, decreasing fatigue, anxiety, and depression.

In certain embodiments, the nutritional supplement comprises a formulation comprising a fermented composition comprising, by weight or volume, about 1% to about 85% pomegranate arils, about 1% to about 85% pomegranate peels, about 0.001% to about 5% magnolia leaves, about 0.05% to about 40% bee pollen, about 0.05% to about 35% sweet wormwood, from about 0.05% to about 30% sweet wormwood, about 0.05% to about 60% pineapple guavas, about 0.01% to about 60% apples, about 0.05% to 60% grapefruit peels, pith, and seeds, about 1% to about 60% cabbage, about 0.05% to about 40% cellulase, about 0.05% to about 60% Red Dulse flakes, about 0.05% to about 4 quercetin dihydrate, about 0.05% to about 60% Pomegranate, about 0.05% to about 40% beets, about 1% to 80% Artemisia annua, about 0.05% to about 60% ellagic acid, about 0.05% to about 60% resveratrol, about 0.05% to about 20% Sugar, about 0.05% to about 20% Pectic Enzymes, about 0.05% to about 10% ginger root, about 0.05% to about 10% Glycyrrhiza glabra root, and about 0.05% to about 40% honey. These nutritional supplements may be useful for supplementing poor diets, for improving cellular function and metabolism, decreasing inflammation, improving insomnia, improving recovery from infection or other illness, assisting with weight loss, improving metabolism of lipids and carbohydrates, decreasing fatigue, anxiety, and depression.

In certain embodiments, the invention is directed to a nutritional supplement comprising a formulation comprising a fermented composition comprising, by weight or volume, about 1% to about 85% pomegranate arils, about 1% to about 85% pomegranate peels, about 0.001% to about 5% magnolia leaves, about 0.05% to about 40% bee pollen, about 0.05% to about 35% wormwood, from about 0.05% to about 30% sweet wormwood, about 0.05% to about 60% pineapple guavas, about 0.01% to about 60% apples, about 0.05% to 60% grapefruit peels, pith, and seeds, about 1% to about 60% cabbage, about 0.05% to about 40% cellulase, about 0.05% to about 60% Red Dulse flakes, about 0.05% to about 4 quercetin dihydrate, about 0.05% to about 60% Pomegranate, about 0.05% to about 40% beets, about 1% to 80% Artemisia annua, about 20% to about 80% prunella vulgaris, about 0.05% to about 60% ellagic acid, about 0.05% to about 60% resveratrol, about 0.05% to about 20% Sugar, about 0.05% to about 20% pectic enzymes, about 0.05% to about 10% ginger root, about 0.05% to about 10% Glycyrrhiza glabra root, and about 0.05% to about 40% honey. These nutritional supplements may be useful for supplementing poor diets, for improving metabolism, decreasing inflammation, improving insomnia, assisting with weight loss, improving metabolism of lipids and carbohydrates, decreasing fatigue, anxiety, and depression.

In certain embodiments, the invention is directed to a nutritional supplement comprising a formulation comprising a fermented composition comprising, by weight or volume, about 1% to about 85% pomegranate arils, about 1% to about 85% pomegranate peels, about 0.001% to about 5% magnolia leaves, about 0.05% to about 40% bee pollen, about 0.05% to about 35% wormwood, about 0.05% to about 60% pineapple guavas, about 0.01% to about 60% apples, about 0.05% to 60% grapefruit peels, pith, and seeds, about 1% to about 60% cabbage, about 0.05% to about 40% cellulase, about 0.05% to about 60% Red Dulse flakes, about 0.05% to about 4 quercetin dihydrate, about 0.05% to about 60% Pomegranate, about 0.05% to about 40% beets, about 1% to 80% Artemisia annua, about 20% to about 80% prunella vulgaris, about 0.05% to about 60% ellagic acid, about 0.05% to about 60% resveratrol, about 0.05% to about 20% Sugar, about 0.05% to about 20% Pectic Enzymes, about 0.05% to about 10% ginger root, about 0.05% to about 10% Glycyrrhiza glabra root, about 0.05% to about 40% honey, about 0.01% to about 90% soy milk, and about 0.01% to about 90% broccoli sprouts. These nutritional supplements may be useful for supplementing poor diets, for improving metabolism, decreasing inflammation, improving insomnia, assisting with weight loss, improving metabolism of lipids and carbohydrates, decreasing fatigue, anxiety, depression, and hormone driven cancers.

In certain embodiments, the nutritional supplement comprises a formulation comprising a composition comprising, by weight, about 1% to about 85% pomegranate arils, pomegranate peels, about 0.001% to about 5% magnolia leaves, about 0.05% to about 40% bee pollen, about 0.05% to about 35% sweet wormwood, about 0.05% to about 60% pineapple guavas, about 0.01% to about 60% apples, about 0.05% to 60% grapefruit peels, pith, and seeds, about 1% to about 60% red cabbage, about 0.05% to about 40% cellulase granules, about 0.05% to about 60% Red Dulse flakes, about 0.05% to about 4 quercetin dihydrate, about 0.05% to about 60% Pomegranate, about 0.05% to about 40% beets, about 1% to 80% Artemisia annua, about 20% to about 80% prunella vulgaris, about 0.01% to about 90% soy milk, about 0.01% to about 90% broccoli sprouts, about 0.05% to about 60% ellagic acid, about 0.05% to about 60% trans-resveratrol, about 0.05% to about 20% sugar, about 0.05% to about 20% pectic enzymes, about 0.05% to about 10% ginger root, about 0.05% to about 10% Glycyrrhiza glabra root, and about 0.05% to about 40% honey. These nutritional supplements may be useful for supplementing poor diets, for improving metabolism, decreasing inflammation, improving insomnia, assisting with weight loss, improving metabolism of lipids and carbohydrates, decreasing fatigue, anxiety, depression, and hormone driven cancers.

### Formulations for Skin Brightening/Age Spot Fading

In certain embodiments, the nutritional supplement is directed to a topical formulation comprising a composition comprising, by weight, about 1% to about 40% Vitamin C, about 1% to about 60% Emu Oil, about 1% to about 40% Hyaluronic Acid, about 1% to about 20% Niacinamide, about 1% to about 60% Licorice Root Extract, about 1% to about 30% Aloe vera, about 1% to about 40% Kaempferia galangal EO, about 1% to about 60% Jojoba Oil, about 3% Macadamia Nut Oil, about 1% to about 10% Food Grade Diatomaceous Earth, about 1% to about 40% Niaouli (Melaleuca quinquenervia) EO, about 1% to about 5% Alpha Arbutin, about 1% to about 20% Almond Oil, about 1% to about 20% Allantoin, about 1% to about 20% Azelaic Acid, about 1% to about 30% Ubiquinol, about 1% to about 40% Citric Acid, about 1% to about 15% Glycolic Acid, about 1% to about 15% Kojic Acid, about 1% to about 30% Glutathione, about 1% to about 40% Vegetable Glycerin, about 1% to about 5% Coconut Oil, about 1% to about 20% Clove EO, about 1% to about 20% Lemongrass EO, and about 1% to about 10% White Mulberry Extract. In some of these embodiments, the nutritional supplement may be used to reduce excessive skin pigmentation.

In certain embodiments, the invention is directed to a nutritional supplement comprising a topical formulation comprising a composition comprising, by weight, about 1% to about 40% Vitamin C, about 1% to about 60% Emu Oil, about 1% to about 40% Hyaluronic Acid, about 1% to about 20% Niacinamide, about 1% to about 60% Licorice Root, about 1% to about 30% Aloe vera, about 1% to about 40% Kaempferia galangal EO, about 1% to about 60% Jojoba Oil, about 3% Macadamia Nut Oil, about 1% to about 10% Food Grade Diatomaceous Earth, about 1% to about 40% Niaouli (Melaleuca quinquenervia) EO, about 1% to about 5% Alpha Arbutin, about 1% to about 20% Almond Oil, about 1% to about 20% Allantoin, about 1% to about 20% Azelaic Acid, about 1% to about 30% Ubiquinol, about 1% to about 40% Citric Acid, about 1% to about 15% Glycolic Acid, about 1% to about 15% Kojic Acid, about 1% to about 30% Glutathione, about 1% to about 40% Vegetable Glycerin, about 1% to about 5% Coconut Oil, about 1% to about 20% Clove EO, about 1% to about 20% Lemongrass EO, and about 1% to about 10% White Mulberry Extract. In some of these embodiments, the nutritional supplement may be used to reduce excessive skin pigmentation.

### Utility

Administration of the nutritional supplements and formulations described herein may result in a modulation of the cell membrane composition and/or function, and a correction of a nutritional deficiency or a nutritional imbalance. In some of the embodiments, an administration of the formulations described herein may result in an alleviation of pain. In some of the embodiments, an administration of the formulations described herein may result in improved wound healing. In some of the embodiments, an administration of the formulations described herein may result in improvement or resolution of eczema. In some of the embodiments, an administration of the formulations described herein may result in an improvement or resolution of psoriasis. In some of the embodiments, an administration of the formulations described herein may result in an improvement in the appearance of scars. In some of the embodiments, an administration of the formulations described herein may result in an improved recovery from burns. In some of the embodiments, an administration of the formulations described herein may result in an improvement in endocrine function. In some of the embodiments, an administration of the formulations described herein may result in an improvement of a serum lipid profile (e.g., an increase in HDL and/or a decrease in LDL and/or a decrease in triglycerides). In some of the embodiments, an administration of the formulations described herein may result in improved circulation and improvement in symptoms of Raynaud's phenomenon. In some of the embodiments, an administration of the formulations described herein may result in improvement in function of the nervous system. In some of the embodiments, an administration of the formulations described herein may result in improved concentration. In some of the embodiments, an administration of the formulations described herein may result in improved appearance and quantity of hair. In some of the embodiments, an administration of the formulations described herein may result in appearance of skin health. In some of the embodiments, an administration of the formulations described herein may result in alleviation of or improvement in headaches. In some of the embodiments, an administration of the formulations described herein may result in improvement of abdominal pain and diarrhea associated with Inflammatory Bowel Disease (e.g., Crohn's Disease, Ulcerative Colitis), and with Irritable Bowel Disease. In some of the embodiments, an administration of the formulation described herein may result in an improvement or alleviation of anxiety and/or depression. In some of the embodiments, an administration of the formulations described herein may result in improvement in the experience of wearing a mask. In some of the embodiments, an administration of the formulations described herein may result in reduction in nausea. In some of the embodiments, an administration of the formulations described herein may result in improved mood. In some of the embodiments, an administration of the formulations described herein may result in decreased appetite. In some of the embodiments, an administration of the formulation described herein may result in improvement in insomnia. In some of the embodiments, an administration of the formulations described herein may result in improvement or alleviation of social anxiety in subjects with social anxiety. In some of the embodiments, an administration of the formulations described herein may result in improvement of an infection of the skin, nail, or body part caused by fungus, bacteria, virus, or parasite.

The nutritional supplements and formulations encompass: internal administration of a fermented concentrate of a plant with Liquid Skin, designed to induce apoptosis of cancer cells; a topical preparation formulated to prime the immune system to recognize and destroy cancer cells, while restoring function and missing components to damaged/diseased cell membranes of the skin surface; Liquid Skin customized to address the specific deficient components of the subject's membranes, which may be administered topically, internally, or via intranasal, intravenous, intramuscular, or other known routes, based on an analysis of subject's diseased cell membranes to determine deficient components and allow a custom restoration. In some of the embodiments, the nutritional supplement or formulation may be incorporated into stem cells exosomes and the stem cell exosomes may be administered intravenously.

In certain embodiments, the present invention may utilize the formulation and methods of U.S. patent application Ser. No. 17/186,548 filed on Feb. 26, 2021, herein incorporated by reference in its entirety and for all purposes, formulated to further include a biofermentation product and/or lyophilized and/or frozen and/or modified to include one or more of components disclosed in the application.

### Cancer

Humans receive genetic information from parents, which are copied into most cells (the exception being red blood cells, for example). Genes are discrete segments of the DNA which contain instructions for specific biophysical processes—for example, a gene may encode information on how much to grow, or how to make more blood vessels, or how to make heart cells. During the copying process, sometimes mistakes are made, and depending on when the mistake occurred, the erroneous gene (also called a mutation) can be distributed into every cell, or only a subset of cells.

When stem cells and tissue-specific progenitors sustain damage to their genetic material, specifically in genes which control the rate of cellular division and proliferation then the stem cell can divide and proliferate in a dysregulated manner. One manifestation of abnormal cellular division and proliferation is cancer.

Cancer may also be precipitated by exposures to carcinogens, or chemicals which damage our DNA, leading to damaged genes. The greater the damage to the DNA, the greater the chance for mutations that affect cellular proliferation and differentiation. Consequently, the risk for cancer increases as we age, since our cells and bodies are exposed to more carcinogens, mutagens, or damaging radiation (such as ultraviolet radiation). Subjects who received mutated genes from their parents which predispose them to cancer must be even more careful about lifestyle choices to limit exposure to substances which increase the risk of cancer.

Damaging the genes within a terminally differentiated cell (a cell that is not a stem cell, but a specialized cell which performs a specific function, say a muscle cell in the heart) is not as dangerous as damaging the genes within a stem or progenitor cell, because the latter two possess the ability to make more copies of themselves, while the terminally differentiated cell has lost the ability to generate additional cells.

In the past two decades, it has become clear that cancer is a disease of tissue stem cells which have acquired mutations in its genome (the collection of DNA) housed within the nucleus, altering the signals released from the cancer stem cell (CSCs) via exosomes to further drive physiologic and cellular changes in the surrounding tissues which are favorable for cancer progression. For example, cancer happens when genes important in cell cycle regulation are mutated. When genes controlling blood vessel proliferation occur, cancer has the chance to further develop, since it may now recruit and generate new blood vessels required to feed the rapidly growing tumor(s).

Recent studies have shown that cancer stem cells (CSCs) carry on an intense “conversation” by exchanging exosomes with their neighboring cells, including tumor cells, to further drive cancer progression (PMID 30344611, PMID 27358879, PMID 29799161, PMID 32571337, PMID 26369565, PMID 31871869).

In advanced cancer, exosomes secreted from CSCs enter the systemic circulation or travel via the lymphatic system to direct other tissue stem cells to turn into cancer cells, a process called “transformation” (PMID 30344611, PMID 27358879, PMID 29799161, PMID 32571337, PMID 26369565, PMID 31871869).

Standard chemotherapy, radiation, and surgery when pursued early and widely enough may result in removing or destroying the original cancer stem cell and thus is deemed successful. However, in advanced cancer with multiple cancer stem cell clones, the chemokine signaling factors released by chemotherapy, radiation, and surgery serve to create chemical highways (cytokine gradients) along which a tumor may spread (personal communication, multiple discussions during Cold Spring Harbor Laboratory Course, “Cancer Stem Cells 2006” and “Mechanisms of Neural Differentiation and Brain Tumors 2006”). Tumor stem cells, which originally were stem cells were equipped to survive—possessing multi-drug resistance transporters which can pump out chemotherapy drugs out of the CSC and thus “detox” or otherwise protect the CSC. CSCs possess an array of proteins and cellular machinery designed to help them overcome multiple types of chemical and physical stressors, resulting in chemotherapy resistance over time (personal communication, multiple discussions during Cold Spring Harbor Laboratory Course, “Cancer Stem Cells 2006” and “Mechanisms of Neural Differentiation and Brain Tumors 2006”).

Removal of a tumor without addressing the tumor micro-environment, including the cancer stem cells and cancer progenitor cells is futile. Leaving even one such cell is enough to allow for tumor recurrence.

Cells are the smallest discrete subunit of a living organism, a sac defined by a double phospholipid bilayer surrounding many similarly encased smaller organelles within it. Within the cell is an organelle called the nucleus, which houses the cell's deoxyribonucleic acid, or DNA. The DNA serves as the “brains” of the cell and houses the entire code that makes up the human to which it belongs.

The nutritional supplements and formulations of the invention may correct a nutritional deficiency or imbalance and thereby provide for an environment capable of inducing of sternness markers Sox-2, Nanog, Oct4, Klf4, and c-Myc. Induction of sternness markers Sox-2, Nanog, Oct4, Klf4, and c-Myc may reprogram cancer cells back to a cancer stem cell like state (PMID 27856246); which makes the cell more flexible into returning to a stem cell like state, but most importantly renders the cell more susceptible to apoptosis, or organized cell death (PMID 32057163), especially in the presence of antioxidants that facilitate apoptosis (PMID 32065323, PMID 32063361, PMID 32059369).

COX2 protein, a marker of invasion, cancer recurrence and poor survival in multiple cancers (PMID 30341914) is elevated in subjects with esophageal adenocarcinoma and associated with a significantly reduced survival rate (PMID 12055587), and when overexpressed is associated with poor survival in multiple cancers such as: in urothelial bladder cancer (PMID 29661728), oral cancer (PMID 29359615), colorectal cancer (PMID 31948467), among many other types of cancers. There is a move to consider COX2 as a biomarker for estimating survival of subjects with Clinical Stage 1 gastric cancer (PMID 31892585). Interestingly, COX2 is classically the inflammatory pathway targeted by NSAIDs such as aspirin, ibuprofen, naproxen, etc. This is the same pathway that is targeted by multiple ingredients as listed in the above tables, however NSAIDS act by inhibiting COX2 enzyme while chamomile extracts exert influence over COX2 gene expression by also reducing COX-2 mRNA and protein expression (PMID 19788894), thus downregulating this very important marker of cancer progression.

The nutritional supplements and formulations of the invention may correct a nutritional deficiency or imbalance and thereby provide for an environment for modulating inflammatory cascades and reducing inflammation.

Cancer stem cell niches are the source of cancer. Healthy stem cell niches which have sustained multiple genetic insults are converted into cancer stem cell niches. One avenue of treatment of cancer must be able to identify and reprogram the cancer stem cell niches back to a state of health to prevent tumor recurrence. One source of signals required to reprogram a cancer stem cell niche are to be found in stem cell exosomes, which are factors harvested from stem cell cultures of carefully screened placentas from healthy cesarean sections. Note that no humans are harmed in any way to generate these stem cell cultures. Harvesting the supernatant from these cultures and injecting them intravenously in doses high enough to ensure that every stem cell niche in the body is exposed and reprogrammed. The effects of this infusion may be restoration and rejuvenation of all bodily organs and structures from the molecular level.

However, humans were not meant to have regular infusions of placental exosomes. Those studies simply verify the significance of the “conversation” carried between damaged cancer stem cell niches and their surrounding environment. It is well accepted that eating nutritiously (mostly plant foods, healthy portions of lean proteins and fatty fish) directly alter health. The modern understanding is that our foods are poisoned from pesticides, under-nutritious because of poor farming techniques or over farming, and that we must take daily vitamins to replenish this. Hence the boom in nutritional health supplementation. However, evaluation of most supplements available for purchase show that they far exceed the RDA by hundreds, if not thousands and tens of thousand-folds. Proper nutrition and thoughtful medicine involve the right amount of the appropriate medicine or supplement for the appropriate duration and no more.

Continuous overnutrition overwhelms and injures the villi of the digestive tract which secretes mucus to protect itself when irritated, thus further impairing absorption.

Overnutrition intensifies the “conversations” between pre-cancerous stem cell niches since overnutrition is a direct permissive signal for cellular proliferation. For example, pre-cancerous stem cell niches in the absence of excess nutrition would not proliferate due to lack of nutritional substrates.

The answer then is not more nutrition, but rather the proper amount to reduce creating a cancer-permissive environment. The answer also involves modulating the molecular “conversation” to persuade the precancerous or even cancerous stem cell niche back to a state of proper function.

This is achievable without the use of placental exosomes. Rather, introduction of healthful plant-derived signaling molecules presented in a format and delivery system which all cells understand and to which all will respond redirects the conversation, persuading the stem cell niche to recall its original function of restoring life.

The key involves timing, thoughtfulness in selection of starting materials, understanding of the pathophysiology to reverse the root causes, proper dose, observation for response, and knowing when to stop administration. The key is also patient cooperation, to stop excess supplementation and make lifestyle changes to maintain good health.

Most diseases involve a few conserved signaling cascades (such as those for inflammation, cell division, stem-ness, etc.) which are directly modulated by plant bioactive compounds. It is therefore possible to design a nutritional supplement in accordance with the present invention which may convey information to or modulates functioning of stem cell niches, cells, tissues and organs and thereby affects changes in many diseases.

Use of the health supplement is temporary and may be coupled with counseling and education so the subject is empowered to make the lifestyle changes necessary to maintain good health and nutrition on their own.

### Example 1

A nutritional supplement comprising components listed in Table 3 was made.

TABLE 3

| Component | Amount | |
|---|---|---|
| Fermented Garlic Cloves | 500 | g |
| Food Grade Diatomaceous Earth | 40 | ml |
| Blackseed oil | 960 | ml |
| Grapeseed Extract | 22.5 | g |
| Glycine | 100 | g |
| Vitamin B12 | 0.295 | mg |
| Vitamin D | 7.5 | mg |
| Vitamin K1 (as phytonadione) | 0.06 | mg |
| Vitamin K2 (as menaquinone-4) | 0.06 | mg |
| Organic Turmeric | 51 | g |
| German Chamomile EO | 10 | ml |
| Roman Chamomile EO | 10 | ml |
| Moroccan Chamomile EO | 10 | ml |
| Rosemary EO | 30 | ml |
| Cinnamon EO | 30 | ml |
| Lemon EO | 30 | ml |
| Clove EO | 30 | ml |
| Eucalyptus EO | 30 | ml |
| Ginger EO | 30 | ml |
| Lemongrass EO | 30 | ml |
| Grapefruit EO | 30 | ml |
| Lime EO | 30 | ml |
| Myrrh EO | 36 | ml |
| Frankincense EO | 36 | ml |
| Orange EO | 30 | ml |
| Cinnamon Leaf EO | 7 | ml |
| Spearmint EO | 15 | ml |
| Coconut Oil | 19.5 | ml |
| Macadamia Nut Oil | 130.5 | ml |
| Emu Oil | 946 | ml |
| High Oleic Sunflower Seed Oil | 2300 | ml |

Garlic cloves were fermented, soaked in water, and blended in a blender until homogeneous. The rest of the components was then added and mixed until homogeneous. The total volume of the mixture was about 5500 ml. The mixture was aliquoted into 6037 “00” gelatin capsules (about 91 ml/gelatin capsule) and frozen.

Nutritional supplement of Example 1 was designed to support nutritional needs of a subject with Diabetes Mellitus Type 1. Subjects supplementing with the nutritional supplement of Example 1 reported an increased feeling of wellbeing, increased energy, decreased inflammation, weight loss, decrease in blood sugar (HgA1c), improved lipid metabolism, improved sleep, anxiety, and depression.

Multiple patients with hyperlipemia, hypertriglyceridemia reported normalization of their lipid profiles after 1-3 months of supplementation with the formula in Example 1.

One postmenopausal subject with osteoporosis took the nutritional supplement of Example 1 for a year and followed the prescribed lifestyle changes including weightlifting. Years prior to starting the supplement she had declined osteoporosis medications, including vitamin D and calcium opting instead to increase calcium-rich foods rather than take supplements and medications, and was given permission by her primary care provider to pursue lifestyle modifications. Her DEXA exam 1-year after starting the supplement showed an improved T score of −3.3 with a +3.1% change from 4 years prior for her lumbar spine, and overall stability in her osteoporosis assessed at multiple sites as listed below. For reference, a T-score is a comparison of the bone mineral density of the subject to that of women in their 30's (the peak bone density years). Scores of +1 to −1 indicates a normal bone mineral density. Scores from −1 to −2.5 indicates osteopenia. A T-score below −2.5% indicates osteoporosis. In contrast, the Z-score is the comparison between the bone mineral density of the subject to her peers. Relative to her peers, the subject has a higher and healthier bone mineral density than most. Her physician asked for her regimen, told her that her osteoporosis is stable and to continue her current regimen.

| | Bone | SD above | SD above | Percent |
|---|---|---|---|---|
| | Mineral | (+)/below, | (+)/below, | change from |
| Anatomic | Density | (−) T | (−) Z | 4 years |
| Location | (gm/cm²) | score: | score: | prior: |
| AP Lumbar spine | 0.7 | −3.2 | −1.2 | −1.4% |
| Lateral Lumbar | 0.546 | −3.3 | 0 | 3.1% |
| spine | | | | |
| Left Femoral | 0.683 | −1.5 | 0 | −2.7% |
| Neck | | | | |
| Left Total Hip | 0.782 | −1.3 | 0 | −7.4% |

### Example 2

A nutritional supplement comprising components listed in Table 3 was made.

TABLE 3

| Component | Amount | |
|---|---|---|
| Fermented Garlic Cloves | 1000 | g |
| Food Grade Diatomaceous Earth | 40 | ml |
| Blackseed oil | 1440 | ml |
| Grapeseed Extract | 23 | g |
| Glycine | 100 | g |
| Vitamin D | 15 | mg |
| Vitamin K1 (as phytonadione) | 0.12 | mg |
| Vitamin K2 (as menaquinone-4) | 0.12 | mg |
| Vitamin K2 (as trans menaquinone-7) | 12 | mg |
| Organic Turmeric | 67 | g |
| Trans-resveratrol powder | 60 | g |
| Pomegranate Extract (40% ellagic acid) | 240 | g |
| Vegetable Glycerin | 237 | ml |
| German Chamomile EO | 20 | ml |
| Roman Chamomile EO | 20 | ml |
| Moroccan Chamomile EO | 20 | ml |
| Rosemary EO | 30 | ml |
| Cinnamon EO | 30 | ml |
| Lemon EO | 30 | ml |
| Clove EO | 30 | ml |
| Eucalyptus EO | 30 | ml |
| Ginger EO | 30 | ml |
| Lemongrass EO | 30 | ml |
| Grapefruit EO | 30 | ml |
| Lime EO | 30 | ml |
| Galangal EO | 30 | ml |
| Tangerine EO | 30 | ml |
| White Thyme EO | 60 | ml |
| Xiang Mao EO | 30 | ml |
| Yuzu EO | 30 | ml |
| Coriander Seed EO | 30 | ml |
| Turmeric EO | 30 | ml |
| Palmarosa EO | 30 | ml |
| Niaouli EO | 96 | ml |
| Myrrh EO | 96 | ml |
| Frankincense EO | 96 | ml |
| Orange EO | 30 | ml |
| Cinnamon Leaf EO | 90 | ml |
| Spearmint EO | 30 | ml |
| Macadamia Nut Oil | 260 | ml |
| Coconut Oil | 40 | ml |
| Emu Oil | 1000 | ml |
| High Oleic Sunflower Seed Oil | 2600 | ml |

Garlic cloves were fermented, soaked in water, and blended in a blender until homogeneous. The rest of the components was then added and mixed until homogeneous. The total volume of the mixture was about 8107 ml. The mixture was aliquoted into 16,214 “00” gelatin capsules (about 91 ml/gelatin capsule) and frozen.

Nutritional supplement of Example 2 was used to provide nutritional support in subjects with cancer, Diabetes Mellitus (Types 1 and 2), diabetic neuropathy, inflammation, metabolic syndrome, sleep debt, insomnia, bone regeneration, hyperlipidemia, obesity, insulin insensitivity, osteoporosis, and viral diseases, including COVID. After administration of nutritional supplement of Example 2, subjects reported an improvement in symptoms of the underlying condition and an increased feeling of wellbeing, increased energy, decreased inflammation, weight loss, and improved sleep. They also reported improved control of blood sugars, lipid metabolism as reflected in serum lipid profiles, weight loss.

Prior to taking the nutritional supplement, one subject had elevated liver function tests (ten times normal), ferritin levels 255-fold higher than normal, positive antimitochondrial antibodies, and required oxygen supplementation. After taking the nutritional supplement of Example 2, her pulmonary function significantly improved such that she was able to rapidly wean off of 5 L oxygen. She noted that the 3+ pitting edema to her knees resolved. With continued supplementation with nutritional supplement of Example 2, her repeat labs and monitoring showed steady normalization of multiple parameters, including iron panel, HgA1c, transferrin level, and lipids.

### Example 3

A nutritional supplement comprising components listed in Table 4 was made.

TABLE 4

| Component | Amount | |
|---|---|---|
| Fermented Garlic Cloves | 1000 | g |
| Food Grade Diatomaceous Earth | 40 | ml |
| Blackseed oil | 1440 | ml |
| Vitamin B12 | 0.3 | g |
| Grapeseed Extract | 23 | g |
| Glycine | 100 | g |
| Vitamin D | 15 | mg |
| Vitamin K1 (as phytonadione) | 0.12 | mg |
| Vitamin K2 (as menaquinone-4) | 0.12 | mg |
| Vitamin K2 (as trans menaquinone-7) | 12 | mg |
| Organic Turmeric | 67 | g |
| Trans-resveratrol powder | 60 | g |
| Pomegranate Extract (40% ellagic acid) | 240 | g |
| Vegetable Glycerin | 237 | ml |
| German Chamomile EO | 20 | ml |
| Roman Chamomile EO | 20 | ml |
| Moroccan Chamomile EO | 20 | ml |
| Artemisia Annua EO | 20 | ml |
| Oregano EO | 20 | ml |
| Rosemary EO | 30 | ml |
| Cinnamon EO | 30 | ml |
| Lemon EO | 30 | ml |
| Clove EO | 30 | ml |
| Eucalyptus EO | 30 | ml |
| Ginger EO | 30 | ml |
| Lemongrass EO | 30 | ml |
| Grapefruit EO | 30 | ml |
| Lime EO | 30 | ml |
| Galangal EO | 30 | ml |
| Tangerine EO | 30 | ml |
| White Thyme EO | 60 | ml |
| Xiang Mao EO | 30 | ml |
| Yuzu EO | 30 | ml |
| Coriander Seed EO | 30 | ml |
| Turmeric EO | 30 | ml |
| Palmarosa EO | 30 | ml |
| Niaouli EO | 96 | ml |
| Myrrh EO | 96 | ml |
| Frankincense EO | 96 | ml |
| Orange EO | 30 | ml |
| Cinnamon Leaf EO | 90 | ml |
| Spearmint EO | 30 | ml |
| Macadamia Nut Oil | 260 | ml |
| Coconut Oil | 40 | ml |
| Emu Oil | 1000 | ml |
| High Oleic Sunflower Seed Oil | 2600 | ml |

Garlic cloves were fermented, soaked in water, and blended in a blender until homogeneous. The rest of the components was then added and mixed until homogeneous. The total volume of the mixture was about 8119 ml. The mixture was aliquoted into 8922 “00” gelatin capsules (about 91 ml/gelatin capsule) and frozen.

Nutritional supplement of Example 2 was used to provide nutritional support in subjects with Cancer, Diabetes Mellitus (Types 1 and 2), diabetic neuropathy, inflammation, metabolic syndrome, sleep debt, insomnia, bone regeneration, hyperlipidemia, obesity, insulin insensitivity, osteoporosis, recovery from COVID and other viral diseases. After administration of nutritional supplement of Example 3, subjects reported an improvement in symptoms of the underlying disease and an increased feeling of wellbeing, increased energy, decreased inflammation, weight loss, and improved sleep.

### Example 4A

The gut lining is the repository for the immune system, which when intact and functioning in concert with the microbiome detects and eliminates pathogens, parasites, and aberrant precancerous cells, as well as cancer.

A nutritional supplement comprising components listed in Table 5 was made.

TABLE 5

| Ingredient: | 60 ml of stock FGDE |
|---|---|
| FGDE | 3%% |
| Dead Sea Salt water | 1%% |
| 1500 mg L-Histidine | 7 × 10⁻⁴% |
| 1500 mg L- Isoleucine | 7 × 10⁻⁴% |
| 1500 mg L- Leucine | 7 × 10⁻⁴% |
| 1500 mg L- Lysine HCL | 7 × 10⁻⁴% |
| 1500 mg L- Methionine | 7 × 10⁻⁴% |
| 1500 mg L- Phenylalanine | 7 × 10⁻⁴% |
| 1500 mg L- Threonine | 7 × 10⁻⁴% |
| 1500 mg L- Valine | 7 × 10⁻⁴% |
| 9000 mcg Vitamin A as beta carotene | 3 × 10⁻⁶% |
| 900 mg Vitamin C | 3 × 10⁻⁴% |
| 250 mcg Vitamin D | 1 × 10⁻⁹% |
| 150 mg Vitamin E as d-alpha tocopherol | 7 × 10⁻⁶% |
| 1200 mcg Vitamin K as K1 | 5 × 10⁻⁹% |
| 13 mg Vitamin B2 (Riboflavin) | 5 × 10⁻⁶% |
| 160 mg Vitamin B3 (Niacin) | 7 × 10⁻⁶% |
| 50 mg Vitamin B5 (Pantothenic Acid) | 2 × 10⁻⁵% |
| 17 mg Vitamin B6 | 7 × 10⁻⁶% |
| 800 mcg Vitamin B9 (Folate) | 3 × 10⁻⁹% |
| 48 mcg Vitamin B12 as methyl cobalamin | 2 × 10⁻¹⁰% |
| 300 mcg Biotin | 1 × 10⁻⁹% |
| 54 mg Iron | 2 × 10⁻⁵% |
| 55 mg Zinc | 2 × 10⁻⁵% |
| 275 mcg Selenium | 1 × 10⁻⁹% |
| 23 mg Manganese | 2 × 10⁻⁵% |
| 350 mcg Chromium | 2 × 10⁻⁹% |
| 450 mcg Molybdenum | 2 × 10⁻⁹% |
| Macadamia Nut Oil | 4% |
| Coconut Oil | 0.5% |
| Emu Oil | 85% |

The nutritional supplement of Example 4A provides support for improving gut lining integrity, digestion, allergies, and immune function. It also supports proper production of hormones by gut associated cells, notably serotonin which controls mood with multiple subjects reporting improved mood and ability to focus, decreased anxiety, depression, and insomnia. For example, one subject previously would develop swelling and tingling of the lips and oropharynx if she ate food which had touched walnuts. A few weeks after a 10-day course of taking the supplement of Example 4A she unknowingly ate a cookie made with walnuts, however did not experience any of the usual swelling and tingling.

### Example 4B

A nutritional supplement comprising components listed in Table 6 was made.

TABLE 6

| Ingredient | Amount | |
|---|---|---|
| Peppermint EO | 1.0 | ml |
| Ginger EO | 1.0 | ml |
| Clove EO | 2.4 | ml |
| Coconut Oil | 0.3 | ml |
| Myrrh EO | 0.3 | ml |
| Xiang Mao EO | 0.6 | ml |
| Cinnamon EO | 2.4 | ml |
| Rosemary EO | 2.4 | ml |
| Eucalyptus EO | 2.4 | ml |
| Lemon EO | 2.4 | ml |
| Ravintsara EO | 0.8 | ml |
| Cinnamon Leaf EO | 0.4 | ml |
| Frankincense EO | 0.6 | ml |
| Red Thyme EO | 0.6 | ml |
| Rosalina EO | 0.6 | ml |
| Palmarosa EO | 0.6 | ml |
| Niaouli EO | 0.6 | ml |
| Laurel Leaf EO | 0.6 | ml |
| Litsea Leaf EO | 0.6 | ml |
| Emu Oil | 80 | ml |
| Macadamia Nut Oil | 1.8 | ml |
| High Oleic Olive Oil | 20 | ml |
| High Oleic Sunflower Seed Oil | 38 | ml |

This composition was designed with anti-microbial properties (antibacterial, antiviral, anti-fungal, anti-parasitic) to be used as a dentifrice to prevent seeding which occurs with each flossing or brushing of the teeth.

Flossing or brushing causes microtrauma to the gums, with tiny scrapes and nicks through which the oral flora (mostly bacteria) will seed into the bloodstream where they land on cholesterol plaques and colonize, driving systemic inflammation which hardens the cholesterol plaques. They may also seed onto the valves of the heart, causing bacterial endocarditis. The main pathology is global inflammation in the body, which is visible to the naked eye as bright red gums, rather than healthy pink gums.

Use of the composition of Example 4B to brush the teeth has resulted in resolution of gingivitis, slowed gum recession, improved jawbone strength in subjects with osteoporosis when subjects are also taking the lipophilic formula internally in the form of capsules. Multiple subjects reported resolution of longstanding chronic dental infections.

Formulation of Example 4B augmented with Food Grade Diatomaceous Earth as a polishing agent was found to be helpful in removal of plaque/biofilm and food stains, particularly those from coffee, tea, or pigmented fruit like blueberries. The FGDE also serves to prolong the benefits of the nutritional supplement itself, since ingredients will be released slowly into the gums and oral mucosa.

### Example 5

A nutritional supplement was made as follows:
1. 1500 ml of a mixture of chrysanthemum and taro leaf teas was prepared;
2. 1000 ml of freshly harvested aloe vera gel (from large aloe leaves), was blended in a blender and added to the mixture of chrysanthemum and taro leaf teas to provide a mixture of chrysanthemum and taro leaf teas and aloe vera gel;
3. 1000 ml of freshly harvested and blended papaya seeds from ripe Maradol papayas were added to the mixture of chrysanthemum and taro leaf teas and aloe vera gel;
4. 500 ml raw honey was added to the mixture of chrysanthemum and taro leaf teas, aloe vera gel, and papaya seeds, and the resulting mixture was blended.

### Example 6

A nutritional supplement was made as follows:
1. 1500 ml of a mixture of chrysanthemum and taro leaf tea was prepared;
2. 1000 ml of freshly harvested aloe vera gel (from large aloe leaves) was blended in a blender;
3. 1000 ml of freshly harvested and blended papaya seeds from ripe Maradol papayas with the above mixture;
4. 1000 ml fresh rambutans, whole, were washed and blended;
5. 1000 ml fresh mangosteen peels and seeds, were washed and blended;
6. 1000 ml fresh whole bitter melons, were blended;
7. The components produced by the preceding steps were combined with 500 ml of honey and blended.

### Example 7

A nutritional supplement comprising components listed in Table 7 was made.

TABLE 7

| Ingredient | Amount | |
|---|---|---|
| Chrysanthemum & Taro Leaf Tea | 1500 | ml |
| Freshly harvested aloe vera gel | 1000 | ml |
| Freshly harvested papaya seeds from | 1000 | ml |
| ripe Maradol Papayas | | |
| Raw honey | 500 | ml |
| Fresh rambutans | 2000 | ml |
| Fresh peels and seeds of mangosteens | 4000 | ml |
| Fresh chrysanthemum greens | 2000 | ml |
| Fresh whole bitter melon | 2000 | ml |
| Fresh whole red or yellow dragon fruit | 2000 | ml |
| Fresh whole longan fruit | 1000 | ml |
| Fresh taro leaves | 1000 | ml |

Subjects supplementing with nutritional supplement of Example 7 reported restful sleep, decrease irritability, anxiety and depression, while decreasing inflammation, and improvement in eczema. Subjects supplementing with nutritional supplement of Example 7 also reported closing skin wounds when applied topically or taken internally. Improved results were observed when a small amount of the nutritional supplement was taken internally, combined with topical application to open skin wounds.

### Example 8

A nutritional supplement comprising components listed in Table 8 was made.

TABLE 8

| Ingredient | Amount | |
|---|---|---|
| Chrysanthemum & Taro Leaf Tea | 1500 | ml |
| Freshly harvested aloe vera gel | 1000 | ml |
| Freshly harvested papaya seeds from | 1000 | ml |
| ripe Maradol Papayas | | |
| Raw honey | 500 | ml |
| Fresh rambutans | 2000 | ml |
| Fresh peels and seeds of mangosteens | 4000 | ml |
| Fresh chrysanthemum greens | 2000 | ml |
| Fresh whole bitter melon | 2000 | ml |
| Fresh whole red or yellow dragon fruit | 2000 | ml |
| Fresh whole longan fruit | 1000 | ml |
| Fresh taro leaves | 1000 | ml |
| Pomegranate Peels and Pith | 4000 | ml |

It was observed that nutritional supplement of Example 8 works better than nutritional supplement of Example 7 for closing open skin wounds, when taken internally or applied topically.

Multiple subjects, including pre-, peri-, and postmenopausal women, hypothyroid subjects, and healthy subjects of both genders reported weight loss attributed to the supplementation with nutritional supplement of Example 8.

One Type 2 diabetic subject reported a decrease in blood sugar after supplementation with the nutritional supplement of Example 8

Subjects receiving supplementation with nutritional supplement of Example 8 reported improved mood and an improvement in the symptoms of the following: insomnia, fatigue, irritability, irregular cycles, and abnormal body odor.

### Example 9

A nutritional supplement comprising components listed in Table 9 was made.

TABLE 9

| Ingredient | Amount | |
|---|---|---|
| Chrysanthemum & Taro Leaf Tea | 1500 | ml |
| Freshly harvested aloe vera gel | 1000 | ml |
| Freshly harvested papaya seeds from | 1000 | ml |
| ripe Maradol Papayas | | |
| Raw honey | 500 | ml |
| Fresh rambutans | 2000 | ml |
| Fresh peels and seeds of mangosteens | 4000 | ml |
| Fresh chrysanthemum greens | 2000 | ml |
| Fresh whole bitter melon | 2000 | ml |
| Fresh whole red or yellow dragon fruit | 2000 | ml |
| Fresh whole longan fruit | 1000 | ml |
| Fresh taro leaves | 1000 | ml |
| Pomegranate Peels and Pith | 4000 | ml |
| Fresh organic lemon peels and seeds | 1000 | ml |
| Fresh organic orange peels and seeds | 1000 | ml |
| Fresh organic grapefruit peels and seeds | 1000 | ml |
| Fresh organic tangerine peels and seeds | 1000 | ml |

Similar benefits as the nutritional supplement of Example 8 above but was observed to have an improved ability to create an environment to improve digestion, sleep, metabolism of both lipids and carbohydrates, e.g., resulting in improved weight loss.

### Example 10

A nutritional supplement comprising components listed in Table 10 was made.

TABLE 10

| Ingredient | | |
|---|---|---|
| (all ingredients lyophilized powder) | Amount | |
| Fenbendazole | 200 | g |
| Chrysanthemum & Taro Leaf Tea | 16 | g |
| Freshly harvested aloe vera gel | 12 | g |
| Freshly harvested papaya seeds from | 12 | g |
| ripe Maradol Papayas | | |
| Raw honey | 6 | g |
| Fresh rambutans | 24 | g |
| Fresh peels and seeds of mangosteens | 48 | g |
| Fresh chrysanthemum greens | 12 | g |
| Fresh whole bitter melon | 12 | g |
| Fresh whole red or yellow dragon fruit | 24 | g |
| Fresh whole longan fruit | 12 | g |
| Fresh taro leaves | 12 | g |
| Pomegranate Peels and Pith | 48 | g |
| Licorice (glycyrrhiza glabra) powder | 30 | g |
| Ginger root powder | 30 | g |
| Vitamin A (as beta carotene) | 22,500 | mcg |
| Vitamin C | 2,250 | mg |
| Vitamin D3 | 625 | mcg |
| Vitamin E (as d-alpha tocopherol) | 375 | mg |
| Vitamin K (as K1) | 3000 | mcg |
| Vitamin B1 (Thiamin) | 30 | mg |
| Vitamin B2 (Riboflavin) | 32.5 | mg |
| Vitamin B3 (Niacin) | 400 | mg |
| Vitamin B5 (Pantothenic Acid) | 125 | mg |
| Vitamin B6 | 42.5 | mg |
| Vitamin B9 (Folate) | 20,000 | mcg DFE |
| Vitamin B12 | 120 | mcg |
| Vitamin H (Biotin) | 750 | mcg |
| Iron | 135 | mg |
| Zinc | 137.5 | mg |
| Selenium | 687.5 | mcg |
| Manganese | 57.5 | mg |
| Chromium | 875 | mcg |
| Molybdenum | 1,125 | mcg |

### Example 11

A nutritional supplement comprising components listed in Table 11 was made.

TABLE 11

| Ingredient | Amount | |
|---|---|---|
| High Oleic Sunflower Seed Oil | 1000 | ml |
| Macadamia Nut Oil | 131 | ml |
| Coconut Oil | 20 | ml |

The nutritional supplement of Example 11 may be used to improve absorption of other nutritional supplements described herein.

### Example 12

A nutritional supplement comprising components listed in Table 12 was made.

TABLE 12

| Ingredient | Amount | |
|---|---|---|
| Freshly peeled pomegranate arils | 5000 | g |
| Freshly peeled pomegranate peels + 40 | 5000 | g |
| mature magnolia leaves | | |
| Local bee pollen | 500 | g |
| Sweet wormwood powder | 250 | g |
| Pineapple guavas | 800 | g |
| Pink Lady apple peels, seeds and cores | 500 | g |
| Grapefruit peels, pith and seeds | 400 | g |
| Organic red cabbage | 2600 | g |
| Cellulase granules | 680 | g |
| Red Dulse flakes | 85 | g |
| Quercetin dihydrate | 100 | g |
| Pomegranate extract (40% ellagic acid) | 370 | g |
| Organic beet powder | 652 | g |
| Ellagic acid (100%) | 100 | g |
| Trans-resveratrol powder | 60 | g |
| Brown Cane Sugar | 907 | g |
| Pectic Enzymes | 454 | g |

| | |
|---|---|
| Raw Unfiltered Honey | 2436 |

Nutritional supplement of Example 12 was observed to improve metabolism of both lipids and carbohydrates, to decrease inflammation, and to improve insomnia, anxiety, and depression.

### Example 13

A nutritional supplement comprising components listed in Table 13 was made.

TABLE 13

| Ingredient | Amount | |
|---|---|---|
| Vitamin C Serum | 200 | ml |
| Emu Oil | 150 | ml |
| Hyaluronic Acid | 100 | ml |
| Niacinamide | 100 | ml |
| Licorice Root Extract | 50 | ml |
| Aloe vera gel | 50 | ml |
| Kaempferia galangal EO | 40 | ml |
| Jojoba Oil | 40 | ml |
| Macadamia Nut Oil | 30 | ml |
| Food Grade Diatomaceous Earth | 20 | ml |
| Niaouli (Melaleuca Quinquenervia) EO | 20 | ml |
| Alpha Arbutin | 20 | ml |
| Almond Oil | 20 | ml |
| Allantoin | 20 | ml |
| Azelaic Acid | 20 | ml |
| Ubiquinol | 20 | ml |
| Citric Acid | 20 | ml |
| Glycolic Acid | 20 | ml |
| Kojic Acid | 20 | ml |
| Glutathione | 10 | ml |
| Vegetable glycerin | 10 | ml |
| Coconut Oil | 5 | ml |
| Clove EO | 1 | ml |
| Lemongrass EO | 4 | ml |
| White Mulberry Extract | 10 | ml |

### Example 14

A nutritional supplement comprising a powder composition comprising components listed in Table 14 was made.

TABLE 14

| Ingredient | Amount | |
|---|---|---|
| Tranexamic Acid powder | 3000 | g |
| Ginger root powder | 300 | g |
| Licorice (glycyrrhiza glabra) extract powder | 300 | g |

The nutritional supplement of Example 14 can be administered together the nutritional supplement of Example 11, e.g., to increase absorption of nutritional supplement of Example 14.

### Example 15

A nutritional supplement comprising components listed in Table 15 was made.

TABLE 15

| Ingredient | Amount | |
|---|---|---|
| Fenugreek Powder | 500 | g |
| White Peony Root Powder | 250 | g |
| Matcha Green Tea Powder | 250 | g |
| Licorice root (glycyrrhiza glabra) powder | 60 | g |
| Ginger Root Powder | 60 | g |

Subjects receiving nutritional supplement of Example 15 reported improved libido, energy, digestion, and reduced malodorous body odor for both male and females, and in some instances increased breast size in non-lactating females.

### Example 16

A nutritional supplement comprising components listed in Table 16 was made.

TABLE 16

| Ingredient | Amount | |
|---|---|---|
| High Oleic Acid Sunflower Seed Oil | 3785 | ml |
| Emu Oil | 2059 | ml |
| Frankincense EO | 360 | ml |
| Macadamia Nut Oil | 300 | ml |
| Coconut Oil | 200 | ml |
| Clove EO | 240 | ml |
| Cinnamon EO | 240 | ml |
| Rosemary EO | 240 | ml |
| Eucalyptus EO | 240 | ml |
| Lemon EO | 240 | ml |
| Blackseed EO | 240 | ml |
| Oregano EO | 240 | ml |
| Red Thyme EO | 240 | ml |
| Palmarosa EO | 240 | ml |
| Litsea Leaf EO | 240 | ml |
| Tangerine EO | 240 | ml |
| Ravintsara EO | 120 | ml |
| Myrrh EO | 120 | ml |
| Sweet Wormwood EO | 100 | ml |
| Fennel EO | 90 | ml |
| Rosalina EO | 60 | ml |
| Niaouli EO | 60 | ml |
| Laurel Leaf EO | 60 | ml |
| Xiang Mao EO | 60 | ml |
| Cinnamon Leaf EO | 40 | ml |

### Example 17

A nutritional supplement comprising Liquid Skin customized under sterile conditions to address deficiencies identified on membrane analysis of subject's diseased cell membranes is prepared.

The nutritional supplement may be administered internally, most commonly intravenously, but depending on disease and target organs may be administered by other routes.

### Example 18

Stem cell exosomes are loaded onto FDGE and with Liquid Skin for increased penetrability and infused based on body weight and number of affected organ systems.

The formulations disclosed herein may be prepared on a commercial scale by the methods known in the art.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A nutritional supplement comprising a composition comprising:
a high oleic sunflower seed oil or a mixture of the high oleic sunflower oil and an oil selected from a group consisting of coconut oil, macadamia nut oil, emu oil, and mixtures of two or more of the foregoing,
wherein the composition comprises from about 30% to about 100% of the nutritional supplement by weight and is a frozen composition, a lyophilized composition, or a powder composition.

2. The nutritional supplement of claim 1, wherein the nutritional supplement further comprises a mixture of essential oils dispersed in the composition.

3. The nutritional supplement of claim 2, wherein the mixture of essential oils comprises myrrh essential oil, frankincense essential oil or a mixture of myrrh essential oil and frankincense essential oil.

4. The nutritional supplement of claim 2, wherein the mixture of essential oils is an effective amount to modulate a signaling cascade of an inflammatory response.

5. The nutritional supplement of claim 4, further comprising a plant material.

6. The nutritional supplement of claim 5, wherein the plant material is in an effective amount to modulate a signaling cascade of an inflammatory response.

7. The nutritional supplement of claim 5, wherein the plant material is a garlic clove.

8. The nutritional supplement of claim 7, wherein the garlic clove is fermented.

9. The formulation of claim 1, wherein the composition comprises fatty acids of a type and in an amount that is substantially identical to a fatty acid composition of a cell membrane.

10. A nutritional supplement comprising a liquid composition comprising:
(a) a base composition comprising a high oleic sunflower seed oil or a mixture of the high oleic sunflower oil and an oil selected from a group consisting of coconut oil, macadamia nut oil, emu oil, and mixtures of two or more of the foregoing;
(b) a plant material; and
(c) a mixture of essential oils comprising myrrh essential oil, frankincense essential oil or a mixture of myrrh essential oil and frankincense essential oil;
wherein the plant material and the mixture of essential oils are dispersed in the base composition; and the base composition comprises from about 30% to about 99% of the liquid composition by volume.

11. The formulation of claim 10, wherein the base composition comprises fatty acids of a type and in an amount that is substantially identical to a fatty acid composition of a cell membrane of a human cell; or formulated to improve cell membrane composition.

12. The nutritional supplement of claim 10, wherein the liquid composition is in an effective amount to modulate a signaling cascade of an inflammatory response.

13. The nutritional supplement of claim 10, wherein the composition comprises bioactive substances found in a plant selected from a group consisting of mangosteens, pomegranates, rambutans, aloe, papaya, blackberries, cherries, blueberries, raspberries, marioberries, citrus fruits, bitter melons, dragonfruits, seaweed, soy beans, broccoli sprouts, cabbage and beets.

14. A nutritional supplement comprising a composition comprising a seed, a peel, a bark, a leave, or a fruit of a plant,
wherein the plant is selected from a group consisting of are selected from a group consisting of papaya, mangosteen, rambutans, longans, lychees, lemon, grapefruit, oranges, tangerines, pomegranates, tamarind, apple, bitter melon, and mixtures of two or more of the foregoing, and
the nutritional supplement comprises an effective amount of the composition to modulate a signaling cascade of an inflammatory response; and
the composition is a frozen composition, a lyophilized composition, a powder composition, or a liquid composition.

15. The nutritional supplement of claim 14, wherein the composition comprises the seed and the peel of the plant.

16. The nutritional supplement of claim 14, wherein the fruit is an aril of the plant.

17. The nutritional supplement of claim 16, wherein the aril of the plant is an aril of a pomegranate.

18. The nutritional supplement of claim 14, wherein the composition is fermented.

19. The nutritional supplement of claim 18, wherein the composition is lyophilized.

20. The nutritional supplement of claim 14, wherein the composition further comprises one or more of additional component(s) selected from a group consisting of molds, fungi, bacteria, yeasts; flowers; flower buds; leafs; aloe vera; rambutans; bitter melons; chrysanthemum greens; dragon fruit; longan; ginger powder; licorice powder; glabra powder; vitamins; minerals; and amino acids.
